(19) United States
(12) Patent Application Publication
(10) Pub. No.: US 2009/0103902 A1
(43) Pub. Date: Apr. 23, 2009

(54) REPRODUCTION DEVICE, DEBUG DEVICE, SYSTEM LSI, AND PROGRAM

(75) Inventors: Yasuyuki Matsuura, Hiroshima (JP); Taisaku Suzuki, Hiroshima (JP); Masahiro Oashi, Kyoto (JP); Shinji Takeyama, Hiroshima (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 12/294,083

(22) PCT Filed: Mar. 22, 2007
(86) PCT No.: PCT/JP2007/055803

§ 371 Date: Sep. 23, 2008

(30) Foreign Application Priority Data
Mar. 24, 2006 (JP) 2006-083727
Sep. 8, 2006 (JP) 2006-244254

(51) Int. Cl. H04N 7/26

(52) U.S. Cl. 386/124; 386/126; 386/E05.001

(57) ABSTRACT

A playback device according to the present invention has a function of supporting application development. The playback device acquires, via a network, file system information of a recording medium storing an application and mounts the acquired file system information to file system information of a recording medium equipped in the playback device. A playback control engine executes playback of an AV content that is accessible in the file system resulting from the mounting. A platform unit executes the application that is accessible the file system resulting from the mounting. When executing the application, the platform unit transmits an execution log to a debugging device that is for debugging the application to support the application development.

### TECHNICAL FIELD

The present invention relates to a technical field of application development and in particular to an improvement to implement debugging of an application that controls playback of an AV content.

### BACKGROUND ART

Normally, applications for executing playback control are recorded on a DVD-Video or BD-ROM and execute playback control by instructing a playback device to, for example, select a playlist and a digital stream to be played. Under the playback control, various GUIs are presented to users. Such applications for playback control have become indispensable for distributing BD-ROMs storing pre-recorded movies.

Regarding DVD-Video, an AV content is superposed with commands, and the commands implement playback control of the AV content. That is, commands for executing playback control is stored with a stream to be controlled. In addition, an AV content and an application for controlling playback of the AV content are created serially. It is therefore important for development of DVD-Video applications that an adequate environment for creating an AV content is available. Unfortunately, however, creation of an AV content requires an expensive authoring device just like those employed by movie studios, and such an expensive authoring device is hardly affordable for general software houses. Because of the equipment spending, it appears to be a reality that only a limited number of software houses have entered the field of manufacturing DVD-Video applications.

Regarding BD-ROMs, on the other hand, Java is adopted as a program description language, which provides a cross-development environment for creating an AV content and Java™ application. This paves the way for many software houses to enter the field of manufacturing BD-ROM applications.

Regarding DVD-Video disc creation, some attempts have been made to provide a device and method for facilitating the error analysis of AV playback control and the operation check after error correction. Such attempts include the patent document 1 listed below.

[Patent Document 1]

JP Patent Application Publication No. 11-203841

### DISCLOSURE OF THE INVENTION

### Problems the Invention is Attempting to Solve

It should be noted, however, that playback control of an AV content supported by the BD-ROM player model is complex and diverse. Because of the complexity and diversity, it is usually impractical to determine that a Java™ application is ready for shipment immediately upon completion of the Java™ application in a cross-developing environment. That is to say, it is necessary to conduct a final operation check after the Java™ application and the AV content are stored onto a single disc.

In addition, if a bug is found through the operation check, the Java™ application needs to be corrected to remove the bug and then the corrected Java™ application and the AV content need to be again stored onto a single disc. The process of operation check and the process of bug correction may need to be repeated over and over. In view of this risk, it is desirable to employ a dedicated authoring device for creating a BD-ROM application.

However, since the BD-ROM player model has a high-end hardware specification to be able to handle high-vision images, an authoring device employed for creating a BD-ROM application is far more expensive and larger than those employed for DVD-Video. It is therefore difficult for software houses with limited capital to introduce such an authoring device into manufacturing. This difficulty may lead to a problem that the number of software houses entering the development of Java™ applications for BD-ROM increases only at a sluggish pace.

The problem the present invention aims to solve is described above in relation to BD-ROMs. It should be appreciated, however, that the problem is not specific to BD-ROM applications and found also with any application to be distributed to end users in the form of a recording medium storing the application in a specific logical format, along with an AV content to be controlled by the application. The development of such an application cannot be regarded to be completed unless the application is verified to correctly operate in synchronism with playback of the AV content. This is why the development is said to be difficult. The lack of sufficient means to verify operation is a major cause that makes the application development significantly difficult.

The present invention aims to provide a playback device that enables analysis and correction of a BD-J application, without the need to employ a dedicated authoring device.

### Means for Solving the Problems

In order to achieve the above aim, the present invention provides a playback device having a function of supporting development of an application stored on a recording medium. The playback device comprises: amount unit operable to combine network file system information of the recording medium with file system information of another recording medium equipped in the playback device to obtain a virtual file system; a platform unit operable to execute the application that is set to an enable status of being recognizable in the virtual file system; and a playback control engine operable to execute, in accordance with an instruction given by the application, playback of an AV content that is set to an enable status of being recognizable in the virtual file system. The development supporting function is a function of the platform unit to receive and transmit, via the network, execution information related to the execution of the application.

### EFFECTS OF THE INVENTION

With the above configuration, as long as an AV content is stored on a disc medium equipped in the playback device and an application is stored on a recording medium acting as a network drive, the playback device according to the present invention exchanges execution information of the application with a debugging device, so that synchronous playback of the AV content with operation of the application is ensured.

As long as the application is stored on the recording medium acting as the network drive rather than the disc medium loaded to the playback device, an operation check of the application is enabled based on playback of the AV content by the playback device. That is, with the playback device according to the present invention, verification, analysis, and correction of an application for executing AV playback control is efficiently carried out.

According to the present invention, analysis and correction of an application is efficiently performed without the need to store both the application and an AV content to be controlled by the application onto the same disc. Rather, it is sufficient that the application is stored on a network drive in the development environment. Thus, as long as a network connection is available, the present invention enables debugging of the application that is designed to be executed synchronously with playback of the AV content, without the need to employ an expensive authoring device.

As above, the present invention lowers the barrier to entry into the manufacturing of Java™ applications for BD-ROM and thus encourages more and more software houses to make the entry. In addition, the present invention facilitates the development of applications to be recorded together with an AV content in a specific logical format onto any recording medium, which is not limited to a BD-ROM. As a consequence, enrichment of applications is accelerated.

### BRIEF DESCRIPTION OF THE DRAWINGS

FIG. 1 is a flowchart of the processing steps of BD-J application production;

FIG. 2 is a view showing IDE and ADK environments according to Embodiment 1 of the present invention;

FIG. 3 is a view showing the layer model of a Java Platform Debugger Architecture (JPDA);

FIG. 4A is a view showing an example of debugging with a standard output function, and FIG. 4B is a view showing an example of debugging with ECLIPSE;

FIG. 5 is a view showing an example of GUI presented during debugging with ECLIPSE in the ADK environment;

FIG. 6 is a flowchart of the processing steps of debugging in the ADK environment;

FIG. 7 is a view showing the internal structure of a BD-ROM playback device 200 according to Embodiment 1;

FIG. 8A is a view showing, for each item of network management information, an information identifier and comments about the information item;

FIG. 8B is a specific example of the description of network management information;

FIG. 9 is a view showing the file system of a virtual file package created by combining the file system of the BD-ROM with the file system of a network drive;

FIG. 10 is a view showing the internal structure of an ADK processing unit 208;

FIG. 11 is a schematic view of the BD-J application execution and the AV content playback in the ADK environment;

FIG. 12 is a flowchart of the processing steps performed in the ADK environment;

FIG. 13 is a view showing the class structure of “DebugLog”, which is a LOG output API;

FIGS. 14A-C are flowcharts of the processing steps of a setLevel method, printLog method, and printException method, respectively;

FIG. 15 is a view showing an example of Java™ program source code that uses the Log output API;

FIG. 16 is a flowchart of the processing steps of a try method;

FIG. 17 is a view showing the hardware configuration of a debugging device;

FIG. 18 is a view showing the software configuration of the debugging device;

FIG. 19 is a view showing the internal structure of a BD-J simulator 118;

FIG. 20 is a view showing one example of a playlist configuration menu 501;

FIG. 21A is a view showing one example of an audio stream configuration menu 601a, and FIG. 21B is a view showing one example of a subtitle stream menu 601b;

FIG. 22 is a view showing one example of a display screen image presented by an AV playback screen display unit 128;

FIGS. 23A and 23B are views showing a current point setup menu 701b and an operation state setup menu 701c, respectively;

FIGS. 24A, 24B, and 24C are views showing a screen layout setup menu 801a, an audio output setup menu 801b, and a subtitle display setup menu 801c, respectively;

FIG. 25 is a flowchart of the processing steps of a main routine performed by a playback control engine stub 126;

FIG. 26 is a flowchart of the processing steps for a current point update process;

FIG. 27A is a flowchart of the detailed processing steps of a simulation information update process, and FIG. 27B is a flowchart of the processing steps of a state change notifying process;

FIG. 28 is a flowchart of the processing steps of a simulation information update process;

FIG. 29 is a view showing the internal structure of a BD-ROM;

FIG. 30 is a schematic view showing how the file with extension “.m2ts” is structured;

FIG. 31 shows the processes through which TS packets constituting an AV Clip are written to the BD-ROM;

FIG. 32 is a view showing the relationship between the physical unit of the BD-ROM and the source packets constituting one file extent;

FIG. 33 is a view showing elementary streams that are multiplexed into a MainClip;

FIG. 34 is a view showing elementary streams multiplexed into a SubClip;

FIG. 35 is a view showing the internal structure of Clip information;

FIG. 36 is a view showing the EP_map settings for a video stream of a motion picture;

FIGS. 37A and 37B are views showing the data structure of PlayList information and the internal structure of Multi_Clip_entries;

FIG. 38 is a view showing the internal structure of PlayListMark information contained in the PlayList information;

FIG. 39 is a view showing the relationship between the AV Clip and the PlayList information;

FIG. 40 is a view showing a close-up of the internal structure of SubPath information;

FIG. 41 is a view showing the relationship among the SubClip and the PlayList information stored on a local storage 202 and the MainClip stored on the BD-ROM;

FIG. 42 is a view showing the internal structure of PiP_metadata;

FIG. 43 is a view showing the internal structure of a playback engine 205;

FIG. 44 is a view showing the internal structure of a composition unit 15;

FIG. 45 is a flowchart of the processing steps of a playback control engine 206;

FIG. 46 is a flowchart of the processing steps for executing playback in accordance with the SubPlayItem information in the PlayList information;

FIG. 47 is a view showing the internal structure of an authoring system according to Embodiment 7 of the present invention and also the position of the debugging device in the authoring system;

FIG. 48 is a flowchart of the processing steps of a formatting process;

FIGS. 49A and 49B are views showing the file directory structure of the network drive and the internal structure of the JAR archive file, respectively;

FIGS. 50A and 50B are views showing an example data structure of Credential and a specific example of the Credential;

FIG. 51 is a schematic view showing how a root certificate is assigned to the BD-ROM;

FIG. 52 is a view showing the relationship among SIG-BD.RSA, SIG-BD.SF, BD.ROOT.CERTIFICATE, and MANIFEST.MF files, in the case where no authorization is provided;

FIG. 53 is a view showing the relationship among the SIG-BD.RSA, SIG-BD.SF, BD.ROOT.CERTIFICATE, MANIFEST.MF, and bd.XXXX.perm files, in the case where authorization is provided;

FIG. 54 is a view showing the internal structure of a platform unit;

FIG. 55 is a block diagram showing the structure of a PC 100 having a BD-ROM drive, the hardware and software configurations for decoding AV contents, and the platform unit;

FIG. 56 is a schematic view of a system LSI into which major components of the playback device is packaged; and

FIG. 57 is a view showing the system LSI manufactured in the above manner and disposed on the playback device.

### REFERENCE NUMERALS

100 Debugging Device
101 Network Drive
102 Boot ROM
103 RAM
104 Input-Output I/F
105 MPU
106 Network I/F
200 Playback Device
201 BD-ROM Drive
202 Local Storage
203 Network I/F 106
204 Virtual File System Unit
205 Playback Engine
206 Playback Control Engine
207 BD-J Platform Unit
208 ADK Processing Unit
209 Initialization Processing Unit
210 Mount Setting Unit

### BEST MODE FOR CARRYING OUT THE INVENTION

The following describes embodiments according to the present invention, with reference to the accompanying drawings.

### Embodiment 1

First of all, the Processes of Production and industrial manufacturing of a BD-ROM are described.

First, a planning process is carried out. In this process, the scenario of BD-ROM playback is determined.

Next, a material creation process is carried out. In this process, materials are created by recording video and audio, for example.

Then, a formatting process is carried out. In this process, an overview of data to be recorded in the volume area of the BD-ROM (such data is generally referred to as “volume data”) is acquired based on the scenario created in the planning process and the materials.

Lastly, a press process is carried out. In this press process, volume images are converted into a physical data string, and master disc cutting is conducted-based on the physical data string to create a master disc.

Once the master disc is created by a press device, copies of the BD-ROM are commercially mass-produced. The production is composed of various processes, mainly including substrate molding, reflective film coating, protective film coating, laminating, and label printing.

By completing the above processes, the recording medium (BD-ROM) described in the embodiments below is created.

### <Production of Java™ Application>

Software produced in the formatting process described above is composed of a Java™ application, which is called a BD-J application, and a BD-J object. First, an explanation of the BD-J application is made.

The BD-J application is a Java application executable on a platform unit that fully implements Java 2 Micro_Edition (J2ME) Personal Basis Profile (PBP 1.0) and Globally Executable MHP specification (GEM 1.0.2) for package media targets.

The BD-J application is controlled by an Application Manager via an Xlet interface. The Xlet interface has the following four statuses: “loaded”, “paused”, “active”, and “destroyed”.

The Java platform unit includes a standard Java library used to display image data in JFIF (JPEG), PNG, and other formats. For this reason, the Java application includes a HAVi framework designed according to GEM 1.0.2 and implements a GUI framework containing the functionality of remote control navigation by GEM 1.0.2.

Owing to this configuration, the Java application is enabled to present button display, text display, on-line display (contents of BBS) based on the HAVi framework, in combination with video display. In addition, the display presented by the Java application can be controlled on a remote controller.

The BD-J application is composed of a series of files and those files are converted into Java™ archive files supported by the specifications found at the following URL:

http://java.sun.com/j2se/1.4.2/docs/guide/jar/jar.html

The format of Java™ archive file is based, on the ZIP file format and modified specially for Java™. A Java™ archive file is viewed by using commercially available ZIP extraction software.

Next, an explanation of the BD-J object is made. The BD-J object is a set of data that contains an application management table (ApplicationManagementTable( )) and causes the platform unit to perform application signaling when a title switching takes place during the BD-ROM playback. To be more specific, the ApplicationManagementTable( ) contains an application_id that identifies a BD-J application to be executed and an application_control_code that indicates control to be executed at the time of activating the BD-J application. The application_control_code defines the initial execution state after the title selection. With the application_control_code, in addition, it is defined whether the BD-J application is to be loaded to a virtual machine and automatically started (AUTOSTART) or the BD-J application is to be loaded to a virtual machine but not automatically started (PRESENT).

This concludes the description of the BD-J application and the BD-J object. The following describes the details of the process of BD-J application production.

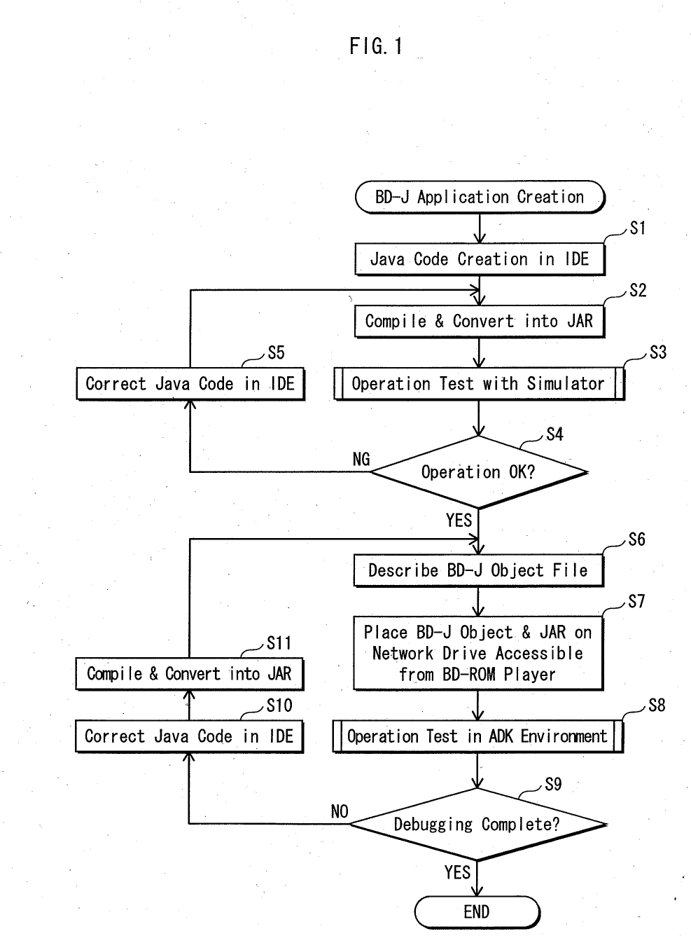

FIG. 1 is a flowchart of the processing steps of BD-J application production. First, a Java code is created in an IDE (Integrated Development Environment) (Step S1) and the thus created Java program source code is compiled and converted into a JAR archive file (Step S2). As a result of the conversion, a BD-J application is acquired. Then, the BD-J application is subjected to a unit test using a simulator in the IDE environment (Step S3) to verify if the BD-J application correctly operates (Step S4). If any error is found (Step S4: No), the Java™ program source code is corrected in the IDE environment (Step S5) and then the processing goes back to Step S2 to retry the operation test.

The above processing steps take place in the cross-development environment with the production of an AV content. That is, the AV content production is underway separately from the BD-J application production.

The AV content referred to in the present embodiment is so-called a BD-ROM content and has a hierarchical structure composed sequentially of: Stream Entity; Clip Information; PlayList; and Title. That is, the AV content is a set of data entities that is selectable in a unit called a title.

Upon completion, the AV content is converted into a BD-RE Version 3.0 format and recorded onto a BD-RE. The BD-RE Version 3.0 format is a logical format for a rewritable disc and yet fully convertible with a BD-ROM, which is a read-only disc. Upon conversion of the AV content into that format, an integration test on the AV content is possible in a manner simulating playback by an actual device, without waiting for completion of the BD-ROM. For the sake of simplicity, the present specification refers to a BD-RE having the BD-RE Version 3.0 format as a “BD-ROM”.

If the operation of the BD-J application is verified (Step S4: Yes), the BD-J object is described (Step S6) and the BD-J object and the JAR archive file are stored at locations accessible from the BD-ROM playback device (Step S7).

Next, an operation test is conducted in the ADK (Application Development Kit) environment (Step S8) and it is judged whether debugging is completed (Step S9). The ADK environment is a development environment that is similar to the operation of an actual device. The ADK environment will be described later in details. If the debussing is incomplete, the Java™ program source code is corrected in the IDE environment (Step S10) and the corrected Java program source code is complied and converted into a JAR archive file (Step S11). Then the processing goes back to Step S6 to redo the operation test.

### <IDE Environment & ADK Environment>

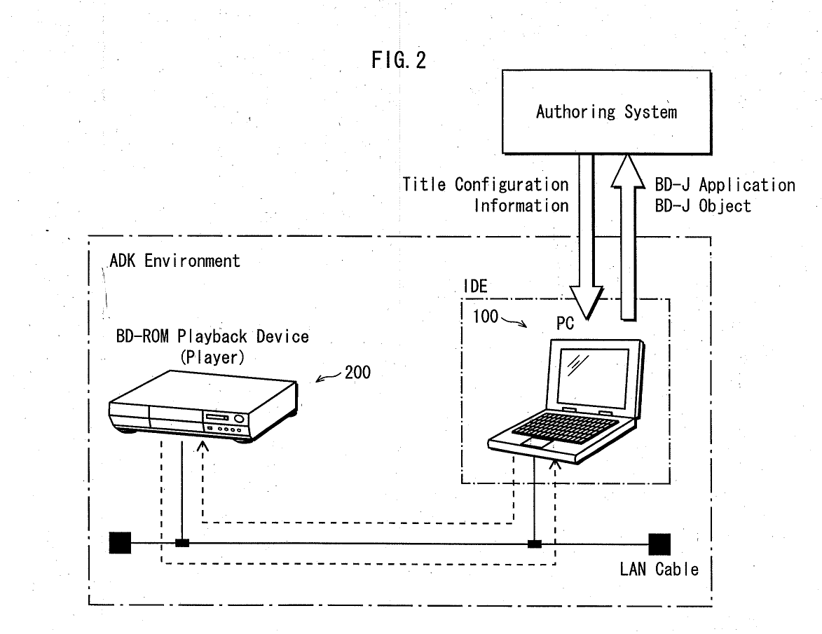

The following describes the IDE and ADK environments used for producing a BD-J application. FIG. 2 is a view showing the IDE and ADK environments according to Embodiment 1 of the present invention. In the present embodiment, the IDE environment is composed of a PC 100 shown in FIG. 1, and the ADK environment is composed of the PC 100 and a BD-ROM playback device 200 shown in FIG. 2. The debugging device is composed of a general personal computer (hereinafter, simply “PC 100”) having installed thereon software for implementing the IDE environment.

Now, the ADK environment is described. The ADK environment is an operating environment in which the JAR archive file and the BD-J object constituting a BD-J application are placed on a network drive (i.e., HDD of the PC and is accessible via a network) and the network file system information is mounted to the file system information of the BD-ROM. As a result, the BD-ROM playback device is enabled to execute the BD-J application residing on the network drive.

In the ADK environment, an operation of the AV content is verified by conducting an operation test on the AV content residing on the BD-ROM drive equipped in the BD-ROM playback device. Similarly, an operation of the BD-J object is verified by conducting an operation test on the BD-J object residing on the network drive equipped in the PC. By running the BD-J application residing on the PC in the same manner as the one residing on the BD-ROM loaded to the BD-ROM playback device the operation test is conducted to simulate the state where the BD-J application is actually stored on the BD-ROM.

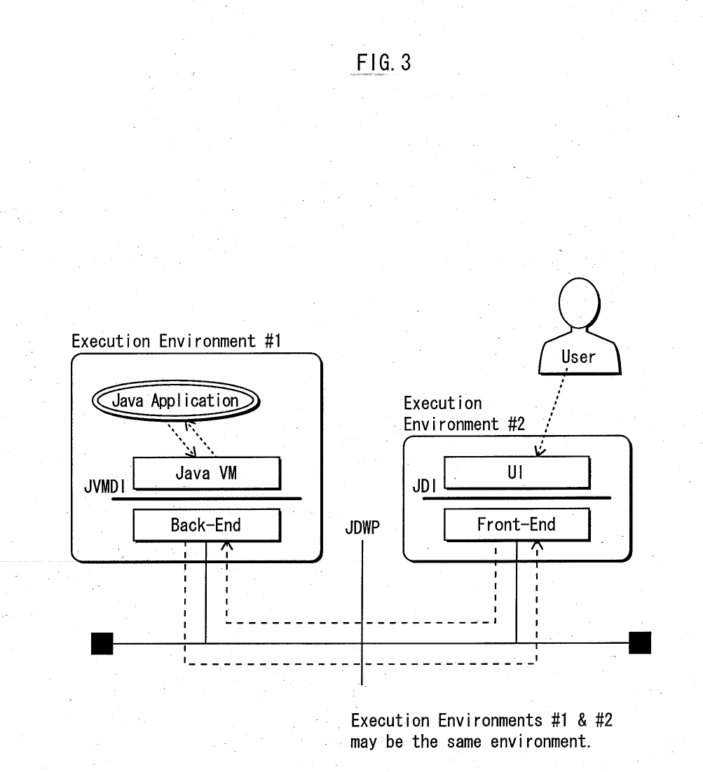

In the ADK environment, debugging of a Java application is carried out with the use of the JPDA (Java Platform Debugger Architecture). The JPDA is an interface defined by the Java 2 platform unit and designed specially for a debugger for use in the application development environment. The layer model of the JPDA is shown in FIG. 3.

FIG. 3 is a view showing the layer model of the Java Platform Debugger Architecture (JPDA). The JPDA is composed of an execution environment #1, an execution environment #2, and JDWP.

The execution environment #1 is composed of “back-end”, “JVMDI” and “Java VM”.

The “back-end” communicates with the front-end to transmit and receives a request, a response to a request, and an event to/from the Java™ application.

The “JVMDI (Java VM Debug Interface)” defines a debugging service that the Java virtual machine provides. This concludes the description of the execution environment #1.

The “Java VM” refers to a Java™ virtual machine that is an execution entity of the Java™ application.

The execution environment #2 is composed of “UI”, “JDI”, and “front-end”.

The “UI (User Interface)” receives, from a user, debug requests such as settings of the back-end, an operation of referencing/modifying a variable, and step execution.

The “JDI (Java Debug Interface)” defines a high-level Java language interface.

The “front-end” communicates with the back-end to transmit and receives a request, a response to a request, and an event to/from the user.

The “JDWP (Java Debug Wire Protocol)” defines communications conducted between a target process to be debugged and a process of the debugging device. The JDWP conducts communications between the front-end and the back-end.

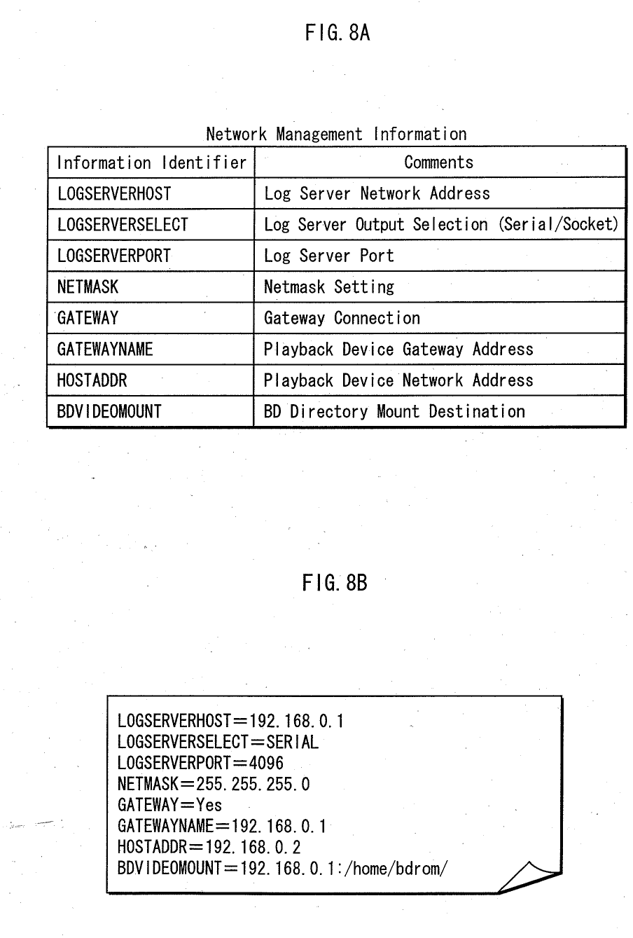

In the JPDA described above, the transmission of the execution log, the values of variables, the values of program counters, and the addresses of breakpoints is performed via a serial port or a socket connecting the playback device and the PC. For purposes of description, however, the transmission in the JPDA is described to be performed via the serial port. The Socket is a communication channel provided in a session layer located on the IEEE 802.3 (Ethernet™), IP, and TCP/UDP. The BD-J application adopts IEEE802.3 (Ethernet), IP, and TCP/UDP as its network model. Accordingly, it goes without saying that the Socket is usable as a transmission channel at the time of debugging. In this specification, the execution information broadly refers to various information related to the execution of an application, such as the execution log, the variable values, the program counter values, and the breakpoint addresses shown in FIGS. 8A and 8B.

This concludes the description of the JPDA. In the example shown in FIG. 2, the BD-ROM playback device 200 is assigned as the execution environment #1 and the debugging device 100 is assigned as the execution environment #2.

The following describes a debugging example (1) in the ADK environment.

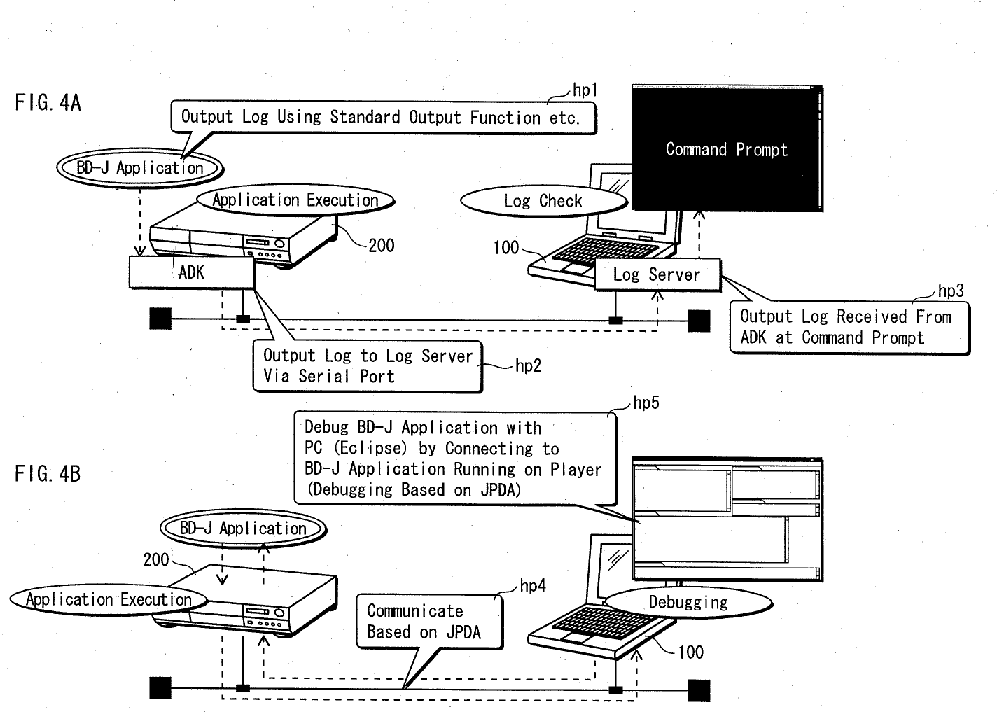

FIG. 4A shows an example of debugging carried out in the ADK environment with the use of a standard output function. In the figure, the balloons (hp1, hp2, hp3, and hp4) provide the explanation of the respective processes executed on the PC 100 and the BD-ROM playback device 200. When the BD-J application outputs an execution log with the use of the standard output function (hp1), the BD-ROM playback device 200 transmits the execution log via the serial port to the log server terminal of the PC 100 (hp2). As a result, the log server terminal is allowed to receive the execution log and display the received execution log on the command prompt (hp3). As a result of the transmission of the execution log, an operation test is performed under the conditions similar to an actual operating environment (i.e., similar to BD-ROM playback by a production-version BD-ROM playback device), including the AV content playback, occurrence of events, the information held by the BD-ROM playback device. Note that there may be some exception, such as an operation that depends on the data layout of the BD-ROM (a data access, for example) which may not be exactly equivalent to the actual condition.

In addition, levels (degrees of importance) may be set in advance for different details of execution log. In this way, the execution log may be controlled according to the debugging levels.

Debugging with use of the standard output function allows the user to check the operation state of the application easily. Thus, such debugging is effective for an operation test and a reproducibility test of the application. Yet, this type of debugging is only a simplified debugging process.

The following describes debugging performed with use of ECLIPSE. FIG. 4B shows an example of debugging performed with ECLIPSE. ECLIPSE is a type of Java IDE environment and has a GUI designed for debugging with the JPDA. With ECLIPSE, operations of the application are associated with specific lines of the source code, so that an operation check can be made on a step-by-step basis through detailed debugging processes such as breakpoint setting, one step execution, and tracking of variables during execution. In order to use ECLIPSE, the PC 100 communicates with the BD-ROM playback device 200 according to the mechanism of JPDA (hp4), and ECLIPSE residing on the PC 100 is connected to the BD-J application running on the BD-ROM playback device to perform the debugging (hp5). This debugging is a full-scale debugging that involves analysis and correction of errors detected.

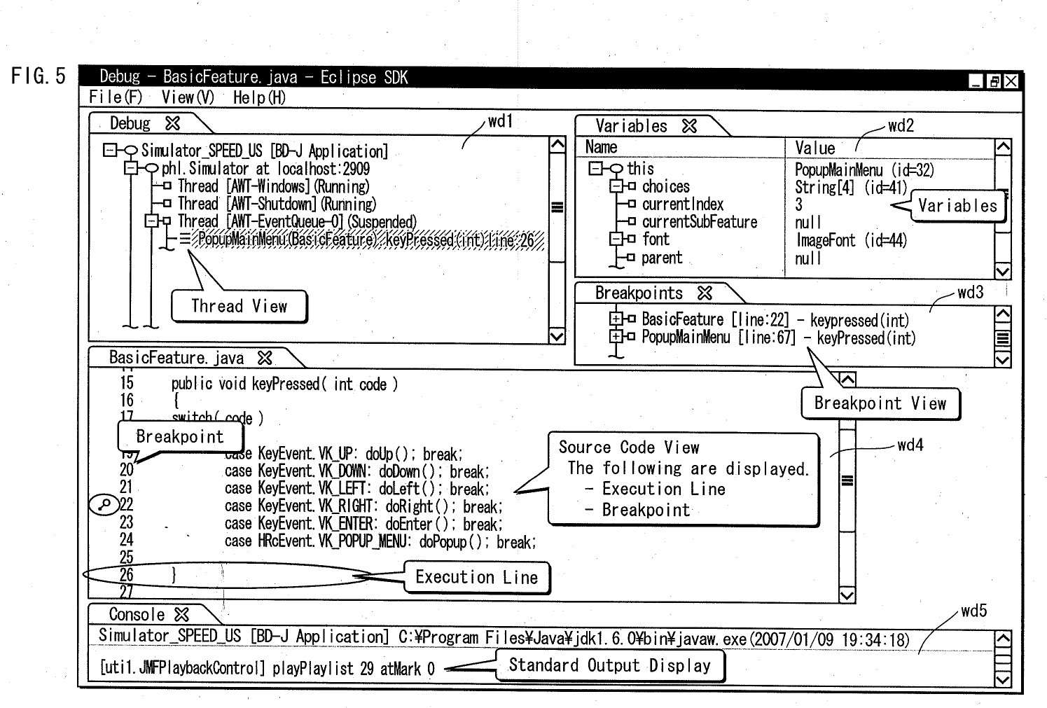

With the GUI of the execution environment #2, the threads, variables, breakpoints, and immediate values used by the platform unit of the execution environment #1 are displayed. FIG. 5 shows an example of the GUI presented during the debugging conducted with ECLIPSE in the ADK environment. This GUI includes a thread view window wd1, a variable view window wd2, a breakpoint view window wd3, a source-code view window wd4, and a standard output function display window wd5. The following describes the respective windows.

—Thread View Window wd1

The thread view window wd1 displays the list of threads processed on the virtual machine. In the example shown in the figure, Thread [AWT-Windows™], Thread [AWT-Shutdown], and Thread [AWT-EventQueue-0] are displayed in the thread view window wd1. In addition, the display indicates that Thread [AWT-Windows] and Thread [AWT-Shutdown] are currently in the execution state (Running) and Thread [AWT-EventQueue-0] is currently in the suspended state.

In addition, “PopupMainMenu (Basic Feature).keyPressed (int) line 26” shown in the figure indicates that the line 26 constituting “PopupMainMenu (BasicFeature).keyPressed (int)” of the Thread [AWT-EventQueue-0] is the current execution line.

—Variable View Window wd2

The variable view window wd2 displays the variable names along with the values held by the respective variables. In the example shown in the figure, the following five variables are displayed along with their values: “choices”, “currentIndex”, “currentSubFeature”, “font”, and “parent”.

—Breakpoint View Window wd3

The breakpoint view window wd3 displays breakpoints. In the example shown in the figure, breakpoints are set one on the line 22 constituting “BasicFeature” and another on the line 67 constituting “PopupMainMenu”.

—Source-Code View Window wd4

The source-code display window wd4 displays the source code. BasicFeature.java is the source code file of “PopupMainMenu(BasicFeature).keyPressed(int)” and the lines 13-26 of the source code are displayed in the example shown in the figure. Each line on which a breakpoint is set is displayed with a specific mark and the execution line is highlighted.

—Standard Output Function Display Window wd5

The standard output function display window wd5 displays the execution log transmitted from the BD-ROM playback device 200. In the figure, “[util.JMFPlaybackControl] playPlayList 29 at Mark 0” is the execution log transmitted from the BD-ROM playback device 200. The execution log relates to “JMFPlaybackControl” that is being executed in the method “util”. In other words, the execution log relates to the playback control implemented by a JMF player instance. The JMF player instance is generated on the platform unit in response to an API call from the method “util”. In particular, the execution log shown in the figure indicates the playlist currently being executed by the playback control engine and the current execution point. In this specific example, the playlist currently being played (playPlayList) is the one identified by the PlayListId=29 and the current execution point is the chapter identified by the markId=0.

The details of the GUI are found at the site located at the following URL:

http://sdc.sun.co.jp/java/docs/j2se/1.4/ja/docs/j

a/guide/jpda/index.html

The details of the debugging with ECLIPSE are found at the sites located at the following URLs:

http://www-06.ibm.com/jp/developerworks/opensourc

e/030711/j_os-ecbug.html; and

http://www.okisoft.co.jp/esc/eclipse3/eclipse-deb

ug.html

This concludes the description of the GUI of ECLIPSE. The following describes the processing steps performed in the ADK environment.

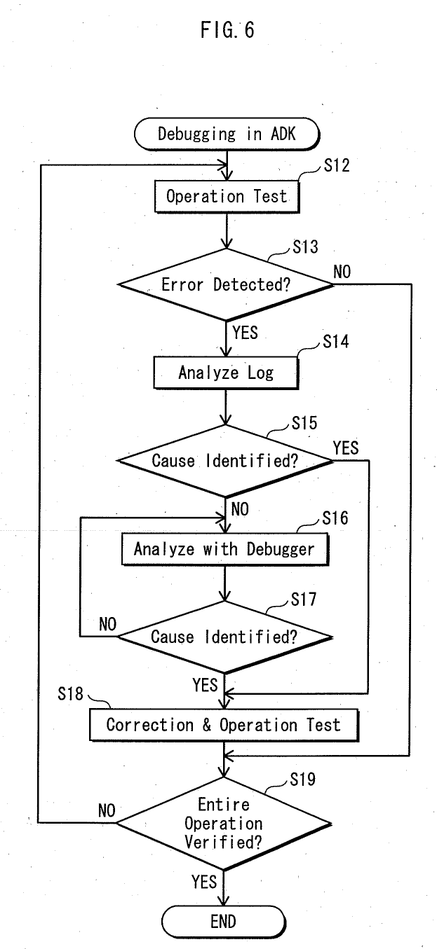

FIG. 6 is a flowchart of the processing steps of debugging in the ADK environment.

In the debugging in the ADK environment, a verification team conducts an operation test on the BD-J application (Step S12) and makes visual and audio inspections to detect errors in the operation of the BD-J application (Step S13). If no error is found, Steps S14-S18 are skipped and the processing directly goes to Step S19.

If any error is detected, the developer analyzes the execution log taken on and/or about occurrence of the error to identify the cause of the error (Step S14) and judges whether the cause is identified (Step S15). If the cause is identified (Step S15: Yes), Steps S16 and S17 are skipped. If the cause is not identified (Step S15: No), the analysis with+the debugging device (Step S16) is repeated until the cause is identified (Step S17). Once the cause is identified, the source code is corrected and an operation test is conducted (Step S18). Then, the developer judges whether the entire operation of the BD-J application is verified (Step S19). If any portion of the BD-J application has not yet been verified, the processing moves to Step S12 to conduct the operation test again. If there is no more portion to be verified, the debugging completes.

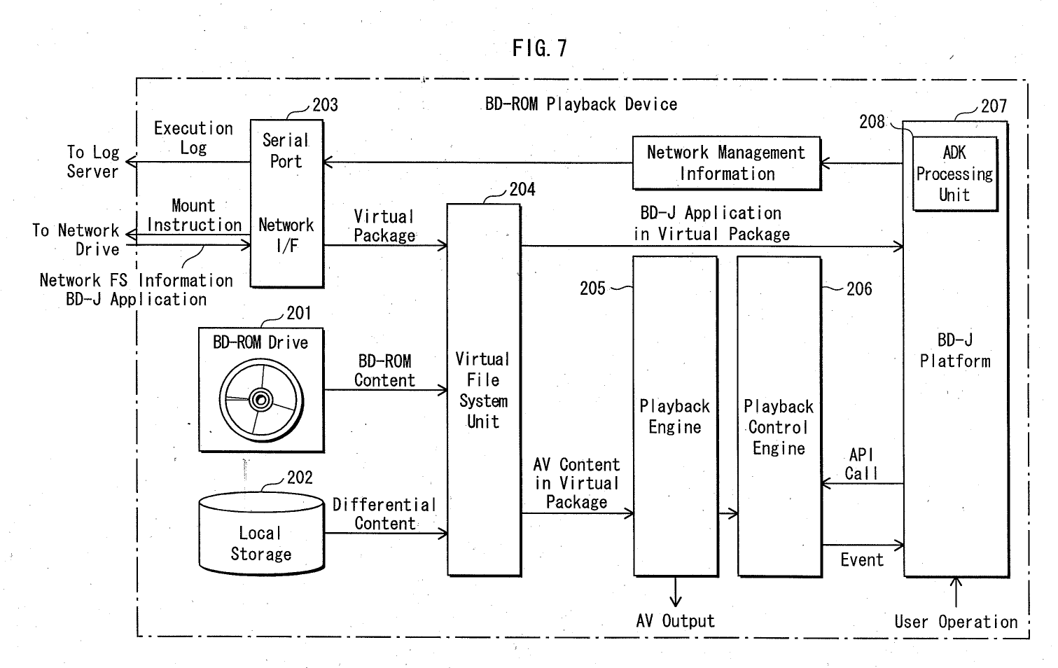

The following describes the internal structure of the playback device according to the present embodiment. FIG. 7 is a view showing the internal structure of the BD-ROM playback device 200 according to Embodiment 1. The BD-ROM playback device 200 includes a BD-ROM drive 201, a local storage 202, a network I/F 203, a virtual file system unit 204, a playback engine 205, a playback control engine 206, a BD-J platform unit 207, and an ADK processing unit 208.

### 1. BD-ROM Drive 201

The BD-ROM drive 201 loads/ejects a BD-ROM, and executes access to the BD-ROM.

### 2. Local Storage 202

The local storage 202 stores a differential content. The differential content collectively refers to a content to be played in combination with a BD-ROM content but is supplied from a WWW server separately from the BD-ROM.

### 3. Network I/F 203

The network I/F 203 enables communications with the debugging device on a LAN, according to the network management information. Information transmitted from the debugging device to the playback device includes network file system (NFS) information, a BD-J application, and a BD-J object. Information transmitted from the playback device to the debugging device includes a mount command. The network management information is necessary for accessing the network and indicates the serial port setting, netmask setting, gateway setting, and host setting. FIG. 8A is a view showing, for each item of the network management information, an information identifier and comments about the information item. FIG. 8B is a specific example of the description of network management information.

Among the information identifiers shown in the figure, “LOGSERVERHOST”, “LOGSERVERSELECT”, and “LOGSERVERPORT” indicate the settings for transmitting and receiving such an execution log as described above. The “LOGSERVERHOST” indicates a network address designated as the transmission destination of an execution log. In the specific example shown in the figure, the “LOGSERVERHOST” indicates the network address “192.168.0.1” of the debugging device on which the log server terminal operates.

The “LOGSERVERSELECT” indicates the setting as to whether the execution log is to be output to the serial port of the log server terminal or to the server. In the specific example, the LOGSERVERSELECT indicates “SERIAL”. With the “LOGSERVERSELECT” indicating “SERIAL”, the “LOGSERVERHOST” and the “LOGSERVERPORT” are ignored and the execution log is output to the serial port. With the “LOGSERVERSELECT” indicating “SOCKET”, the execution log is output to the network address and the port number indicated by the “LOGSERVERHOST” and the “LOGSERVERPORT”, respectively.

The “LOGSERVERPORT” indicates the port number identifying the Socket designated as the transmission destination of the execution log. In the example shown in the figure, the execution log is input to the Socket identified by the port number “4096”.

The “NETMASK” indicates the netmask setting. The “GATEWAY” and “GATEWAYNAME” indicate the gateway setting.

The “NETMASK” indicates the mask used to connect the playback device to the PC.

The “GATEWAY” indicates whether the connection between the playback device and the PC is to be made via a gateway. In the specific example shown in FIG. 8B, the “GATEWAY” indicates “Yes”. Thus, it is shown that the playback device is connected to the PC via the gateway.

The “GATEWAYNAME” indicates the address of the gateway of the network on which the playback device 200 resides.

The “HOSTADDR” and “BDVIDEOMOUNT” each indicate the host setting.

The “HOSTADDR” indicates the network address of the playback device 200. In the specific example, the “HOSTADDR” indicates “192.168.0.2”, which means that the playback device physically resides at the network address “192.168.0.2”.

The “BDVIDEOMOUNT” indicates the network path to the BD-J application. In the specific example, the “BDVIDEOMOUNT” indicates “192.168.0.1:/home/bdrom/”, which means that /home/bdrom/ located at the network address “192.168.0.1” is set. In addition, the file system information of /home/bdrom/ is supplied to the BD-ROM playback device 200 as the file system information of the network file system.

This concludes the description of the network management information and the network I/F 203.

### 4. Virtual File System Unit 204

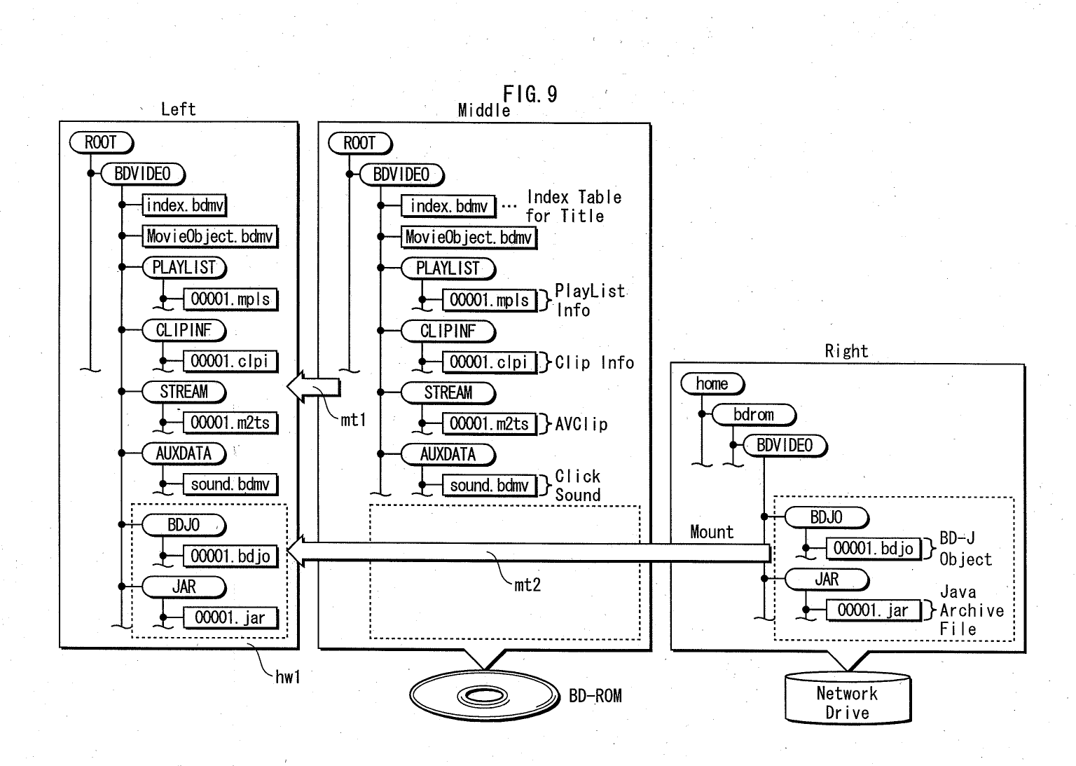

The virtual file system unit 204 creates a virtual file system by combining the file system information of the BD-ROM with the file system information of another recording medium. In general, a BD-ROM playback device creates a virtual package by reading the file system information of the local storage as the file system information of “another recording medium”. One characterizing feature of the present embodiment is that the BD-ROM playback device creates a virtual package by reading the file system, information of the network drive as the file system information of “another recording medium”. With such a virtual package, the platform unit is allowed to recognize and access a Java™ application actually residing on the network drive as if it resided on the BD-ROM. FIG. 9 is a schematic view of how the virtual file system unit 204 combines the file system information. The block on the right-hand side of the figure shows the file directory structure of the network drive. The middle block shows the file directory structure of the BD-ROM. The block on the left-hand side shows the virtual package.

The block on the right-hand side represents the hard disk network in terms of the file system information. The hard disk has a home directory, and a sub-directory called a bd-rom directory below the home directory, and another sub-directory called a BD-VIDEO directory below the bd-rom directory. In addition, the bd-rom directory has two sub-directories called a BDJO directory and a JAR directory.

The BDJO directory contains a file with the extension “bdjo” (00001.bdjo).

The JAR directory contains a JAR archive file (00001.jar).

The block in the middle represents the file system of the BD-ROM in terms of the file system information. The file system of the BD-ROM has a Root directory and a BDVIDEO directory below the Root directory.

The BDVIDEO directory contains files with the extension “bdmv” (index.bdmv and MovieObject.bdmv). The BDVIDEO directory has sub-directories called a PLAYLIST directory, a CLIPINF directory, and a STREAM directory.

The PLAYLIST directory contains a file with the extension “mpls” (00001.mpls).

The CLIPINF directory contains a file with the extension “clip” (00001.clpi).

The STREAM directory contains a file with the extension “m2ts” (00001.m2ts).

Arrows mt1 and mt2 in the figure schematically show the combining of the two pieces of file system information by the virtual file system unit 204. As a result of the combining, the BDJO directory and the JAR archive file directory contained in the network file system is made available in the BD-ROM file system as a sub-directly below the BDVIDEO directory (a dotted box hw1). That is, the BDJO directory and the JAR archive file directory contained in the network file system is made available also in the BD-ROM file system as if the files resided below the BDVIDEO directory.

### 5. Playback Engine 205

The playback engine 205 executes playback of an AV content that is set to an enable status of being recognizable in the virtual package created by the virtual file system unit 204.

### 6. Playback Control Engine 206

The playback control engine 206 causes the playback engine 205 to execute the playback as requested by an API call from the BD-J application.

### 7. BD-J Platform Unit 207

The BD-J platform unit 207 executes a BD-J application that is set to an enable status of being recognizable in the virtual package created by the virtual file system unit 204.

### 8. ADK Processing Unit 208

The ADK processing unit 208 is a component of the BD-J platform unit 207 and executes debugging in the ADK environment.

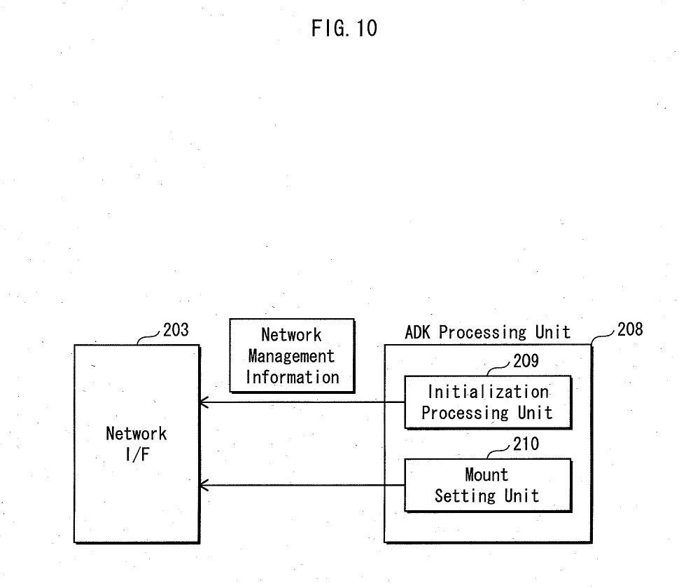

This concludes the description of the internal structure of the BD-ROM playback device 200. Of the components of the ADK processing unit 208, characterizing components are shown in FIG. 10.

FIG. 10 is a view showing the internal structure of the ADK processing unit 208. As shown in the figure, the ADK processing unit 208 includes an initialization processing unit 209 and a mount setting unit 210.

### 9. Initialization Processing Unit 209

The initialization processing unit 209 initializes the internal information and hardware of the device. In addition, the initialization processing unit 209 causes the network I/F to read the network management information to make the network setting. The network setting refers to operations performed in response to such a command. as a route command in UNIX™. In the case of the network management information shown in FIG. 8B, the network setting is made by generating the route command shown below, based on each piece of information identified by the information identifiers “NETMASK”, “GATEWAY”, “GATEWAYNAME”, and “HOSTADDR” shown in FIG. 8A:

/sbin/route add -net 192.168.0.2 netmask 255.255.255.0 eth1

### 10. Mount Setting Unit 210

The mount setting unit 210 makes the mount setting to mount the file system (NFS) of the network drive connected to the network. The mount setting is made based on the information identified by the information identifier “BDVIDEOMOUNT” contained in the network management information. The mount setting refers to operations performed in response to such a command as a mount command in UNIX.

The process of mounting a directory refers to the mounting operations performed on the file system according to UNIX. More specifically, for example, thorough the mounting process, a directory U managed under the file system of a computer A (server) is attached to a directory X managed under the file system of a computer B (client). As a result of the mounting, an access request from an application residing on the computer B to the directory U residing on the computer A is made by specifying the directory X rather than the directory U in the computer A. As described above, the process of allocating the directory U to the directory X is referred to as the process of mounting the directory U to the directory X. In the mouthing process, the directory X is called a “mount destination directory”, whereas the directory U is called a “mount source directory”. Here, the platform unit operates on a real-time OS such as Linux for home appliances. Thus, the mount setting unit 210 issues a mount command via the network to cause the mouthing process as described above. In the case of the network management information shown in FIG. 8B, the mount setting unit 210 issues the following mount commands:

mount -t nfs -o nolock -o ro 192.168.0.1:/home/bdrom/BDVIDEO/BDJO/BDVIDEO/BDJO; and

mount -t nfs -o nolock -o ro 192.168.0.1:/home/bdrom/BDVIDEO/JAR/BDVIDEO/JAR

Of the above mount commands, the first command is to mount the “/home/bdrom/BDVIDEO/BDJO” directory residing on the PC to the /BDVIDEO/BDJO directory residing on the BD-ROM. That is to say, the mount destination directory is the “/BDVIDEO/BDJO directory” on the BD-ROM, whereas the mount source directory is the “/home/bdrom/BDVIDEO/BDJO” directory on the PC. The second command is to mount the “/home/bdrom/BDVIDEO/JAR” archive file directory on the PC to the “/BDVIDEO/JAR” archive file directory on the BD-ROM. That is to say, the mount destination directory is the “/BDVIDEO/JAR” archive file directory on the BD-ROM, whereas the mount source directory is the “/home/bdrom/BDVIDEO/JAR” archive file directory on the PC.

As a result of the mounting, the file system that is set to an enable status of being recognizable by the platform unit and the playback control engine is the combination of the file system of the network drive and the file system of the BD-ROM. In other words, the file system in the virtual package as shown in FIG. 9 is made available for access by the platform unit and the playback control engine. As a result, the platform unit is enabled to access the BD-J application residing on the network drive in the same manner as the AV content residing on the BD-ROM to be executed in synchronization with execution of the BD-J application residing on the BD-ROM by the platform unit. According to the present embodiment, when the BD-J application issues, to the platform unit, a predetermined API call for mounting, the mount setting unit 210 performs the above-described mouthing process of the network drive on which the application resides.

In addition, the network management information specifies the serial port of the log server terminal as the output destination of the standard output function. Consequently, in response to a call to the standard output function within the BD-J application, the platform unit extracts the value specified as an argument and transmits the extracted value as the execution log to the log server. terminal via the serial port.

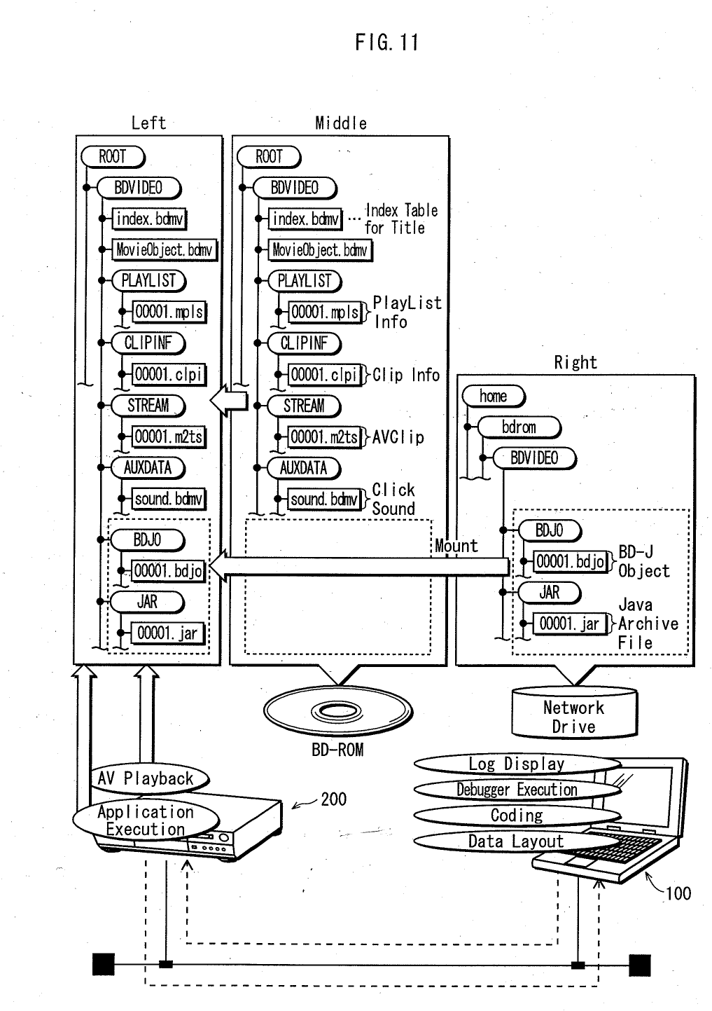

FIG. 11 is a schematic view of the BD-J application execution and the AV content playback in the ADK environment. This figure is drawn by adding balloon helps to the diagram shown in FIG. 9. In the figure, the block on the right-hand side represents the contents of the network drive, the block in the middle represents the contents of the BD-ROM, and the block on the left-hand side represents the contents of the virtual package. The respective contents shown in the figure are identical to those shown in FIG. 9. As a result of the mounting by the mount setting unit 210, the virtual package is created, so that the BD-J application and the BD-J object residing on the hard disk are allowed to be handled as if the BD-J application and the BD-J object were on the BD-ROM. The playback control engine of the BD-ROM playback device 200 executes playback of the AV content available in the virtual package, and the platform unit of the BD-ROM playback device 200 executes the BD-J application available in the virtual package. In this way, the BD-J application is executed in the environment similar to the actual environment in which the BD-J application is executed by a playback device a general household.

### —Procedure in ADK Environment

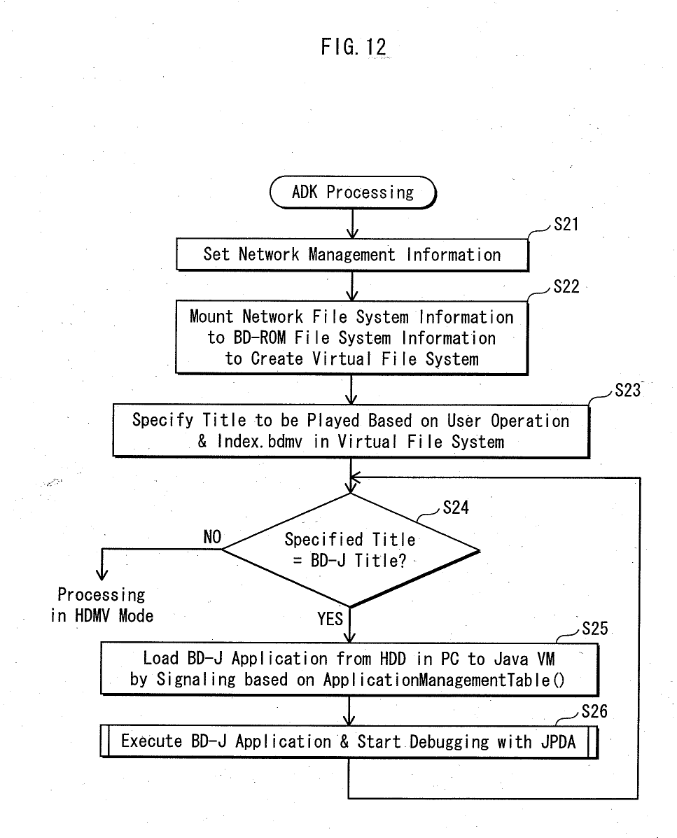

FIG. 12 is a flowchart of the processing steps performed in the ADK environment. First of all, the network management information is set in the network I/F 203 (Step S21). Next, the file system information of the hard disk of the PC 100 is mounted to the file system information of the BD-ROM to create a virtual file system (Step S22). Then, the “Index.bdmv” file available in the virtual file system is read from the BD-ROM. The “Index.bdmv” file contains information indicating the relationship among the tiles, the BD-J object, and the BD-J application to enable application signaling of title boundaries as described above (details of which are described later in Embodiment 6) Once the Index.bdmv file is read, a title to be played is specified based on the Index.bdmv file and a user operation (Step S23).

In Step S24, it is judged whether the specified title is controlled by the BD-J application. If the specified title is controlled by the BD-J application, the signaling is performed based on “ApplicationManagementTable( )” contained in the BD-J object to load the BD-J application to the Java platform unit (Step S25). Subsequently, the BD-J application is executed to start debugging with use of the JPDA (Step S26). When the execution of the BD-J application and the playlist playback of the specified title complete, the processing goes back to Step S24 to repeat the sequence of Steps S24-S26.

During the playback of the BD-J title, upon completion of playback of the playlist, the playback control engine outputs an event indicating the end of the playlist playback. The event handler of the BD-J application moves onto the subsequent title in accordance with the event. The platform unit, on the other hand, transmits the log to the PC 100 upon the title switching performed in response to the event indicating the end of the playlist playback. With the execution log received by the PC 100, it can be confirmed whether or not that the title switching is correctly done.

As described above, the present embodiment ensures that if an error occurs on the platform unit of the playback device, the execution log relating to the error is transmitted to the debugging device. With reference to the execution log, the process of identifying the cause of the error is effectively performed on the debugging device. Thus, an integration test is suitably performed with the use of the playback device.

According to the present embodiment, in addition, an AV content is acquired from the BD-ROM drive and an application is acquired from the network drive device in order to execute the application synchronously with playback of the AV content. If the application for controlling the AV content playback does not operate as intended by the application creator, the application creator is allowed to analyze and correct errors on the debugging device. That is, the present embodiment enables an analysis and correction of an application to be effectively carried out without requiring the application to be stored on the BD-ROM.

### Embodiment 2

Embodiment 2 of the present invention relates to output of an execution log in the ADK environment. The cases where an execution log is to be output through calling the standard output function include the following.

1) When an API (such as an API for AV playback control or an API for acquiring and setting various information items about the BD-ROM playback device) is called, the API type and argument are output. The API that may be called include APIs for causing the playback control engine to execute PlayList playback, PlayList switching, Title switching, Subtitle/Audio/Angle switching, alteration of the playback rate/direction, and acquisition/modification of a register value.

The specific description of the Java™ program source code in this case is as follows. A call to the standard output function is added to a portion of the source code relevant to PlayList playback, PlayList switching, Title switching, Subtitle/Audio/Angle switching, alteration of playback rate/direction, or acquisition/modification of a register value. In such a function call, the event name and the detailed parameter are used as arguments.

2) When the platform unit receives an event of a various type, the name and detailed parameters of the received event are output. For example, upon receipt of a key event or a playback state change event, the name and the detailed parameters of the event received by the platform unit are output. To be more specific, a call to the standard output function is added to a portion of the source code corresponding to the EventListener that is for receiving such an event as a key event and a playback state change event. In such a function call, the event name and the detailed parameter are used as arguments.

3) When an error occurs, an error message or Stack Trace is output. The error mentioned herein refers to any of the following: an occurrence of Exception; a failure of AV playback control; and a failure of API call. To be more specific, when an error occurs during an API call, the type of API called and the argument used to make the API call are transmitted as an execution log. When the playback control fails, the execution log transmitted indicates the playlist number of the current playlist and time information indicating the current playback point, and the menu number called by the user.

The specific description of the Java™ program source code in this case is as follows. That is, an IF statement that contains, as a condition, occurrence of Exception, a failure of AV playback control, or a failure of API call is described. If the condition is true, the standard output function is called with an error message or Stack Trace used as an argument.

4) When a specific process serving as an operation point of the application is executed, a message indicating the execution of the specific process is output. For example, during signaling by the BD-J application at a title boundary, a point at which the operation of the application changes is an operation point of the application. In other words, operation points of the application includes a point at which a title is selected by the user and thus execution of the application starts, and a point at which playback of a title ends and thus execution of the application is terminated. Especially, at the time when playback of a title ends, the application displays a root menu or a title menu. Thus, by transmitting an execution log indicating the playback end of a title as an operation point of the application, the execution log is helpful to verify the application operation.

The specific description of the Java™ program source code in this case is as follows. That is, the execution start portion of the BD-J application as described above corresponds to the beginning of a class file containing a main routine. Similarly, the execution end portion of the BD-J application corresponds to the end of the class file containing the main routine. Thus, a call to the standard output function is inserted at the beginning and end of a portion of the program source code corresponding to the main routine of the BD-ROM and the identifier for a menu to be displayed is used as an argument. The execution log output as a result of the above source code is helpful to check whether or not the root or title menu mentioned above are correctly designated to be displayed.

Now, the following describes how the execution log is output in the above-described cases (1) and (3).

The execution log is output through an actual device test simply by causing the BD-ROM playback device 200 to execute the BD-J application containing a debug routine embedded therein.

The debug routine embedded in the BD-J application instructs, via an API, the platform unit to execute playback of a playlist and also to output a message or memory dump upon an occurrence of exception handling (Exception) on the platform unit. The Java virtual machine uses a stack memory, so that information regarding function calls and variables are stored on a first-in last-out basis. According to the present embodiment, a dump of function calls (Stack Trace) is produced and output as the execution log.

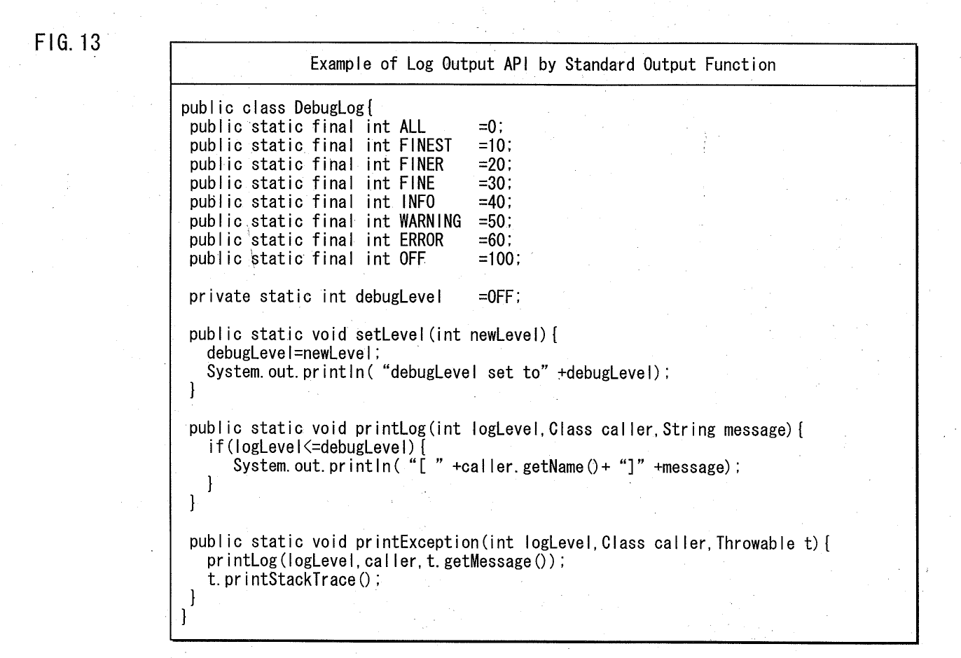

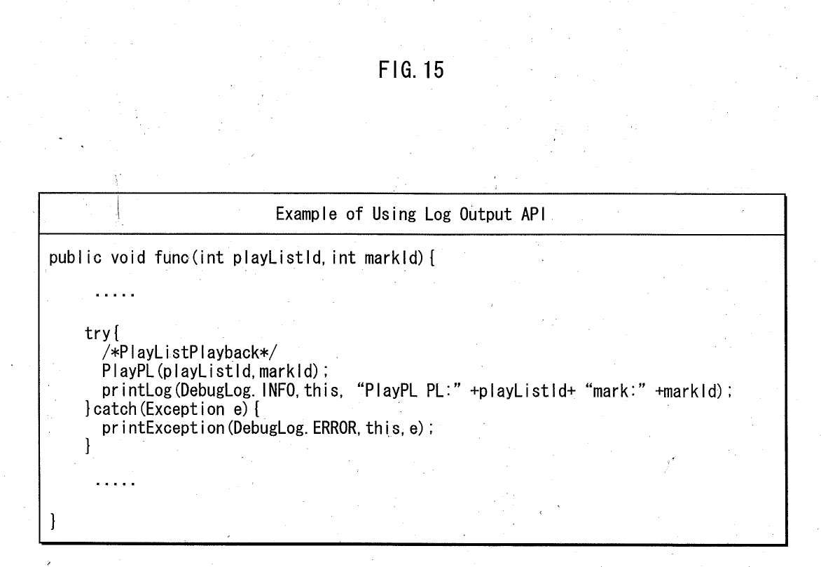

Exception handling by the platform unit occurs when an unexpected event is issued or a system call is made using an irregular parameter. The debug routine described in the present embodiment is based on a LOG output API as shown in FIG. 13 and embedded in the BD-J application in a manner shown in FIG. 15. Thus, the debug routine is activated upon occurrence of Exception on the platform unit and causes an error message or memory dump to be output to the standard output function at the occurrence of Exception. According to the present embodiment, the memory dump output to the standard output function serves as an execution log.

The following describes the LOG output API that uses the standard output function. FIG. 13 is a view showing the class structure of “DebugLog”, which is a LOG output API.

The class structure shown in the figure has as members the following integer type public variables: “ALL”, “FINEST”, “FINER”, “FINE”, “INFO”, “WARNING”, “ERROR”, “OFF” and “debugLevel”. Methods available for external call include a “setLevel” method, “printLog” method, and “printException” method.

The setLevel method receives “newLevel” as an argument and assign the “newLevel” to the “debugLevel” (debugLevel=newLevel) and calls a “System.out.println” method, which is the standard output function. Since the argument used to make the call is “debugLevel set to+debugLevel”, the debugLevel presented on the display is preceded by the character string “debugLevel set to”.

The printLog method receives “logLevel”, “Class caller”, and “String message” as arguments and judges whether the logLevel is equal to the debugLevel or lower (logLevel<=debugLevel). If an affirmative judgment is made, the printLog method calls the System.out.println method which is a standard output function. The argument used to make the call is “[”+caller.getName( )+“]”+message. The “caller.getName( )” is to acquire the name of the caller function. Thus, the function name acquired by the caller.getName presented on the display is enclosed within the brackets [ ] and followed by the message.

The printException method receives “logLevel”, “Class caller”, and “Throwablet” as arguments and calls “printLog” using the “logLevel”, “caller”, and “t.getMessage( )” as arguments and also calls “t.printStackTrace( )”.

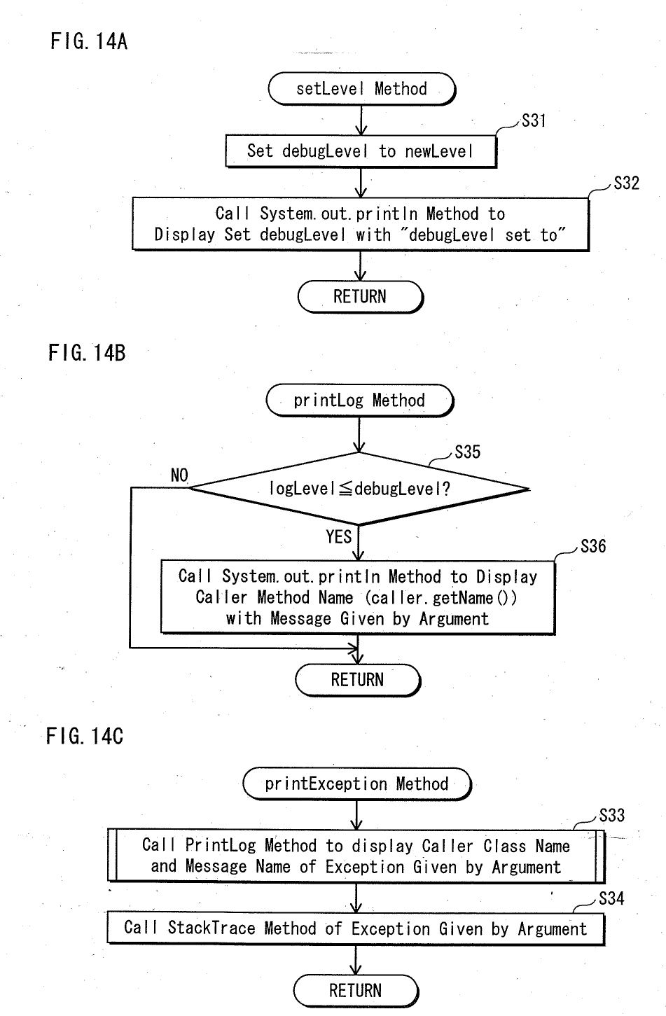

FIGS. 14A-C are flowcharts of the processing steps of the setLevel method, printLog method, and printException method, respectively.

—setLevel Method

The setLevel method shown in FIG. 14A is composed of the following steps: setting “debugLevel” to “newLevel” (Step S31); and calling the System.out.println method in order to display the debugLevel preceded by the character string “debugLevel set to” (Step S32).

—printLog Method

The printLog method shown in FIG. 14B is composed of the following steps: judging whether the argument “logLevel” is smaller than the “debugLevel” (Step S35); and calling, if the “logLevel” is smaller, the System.out.println method, which is a standard output function, in order to display the caller method name (Caller.getName( )) with the message given by an argument (Step S36). If the “logLevel” is larger than the “debugLevel”, the call is skipped.

—printException Method

The printException method shown in FIG. 14C is composed of the following steps: calling the printLog method (Step S33) in order to display the caller class name and the message name of the “Exception” given by an argument; and calling the StackTrace method for the Exception given by the argument (Step S34).

FIG. 15 is a view showing an example of the Java™ program source code that uses the Log output API. In the figure, “func” receives “playListId” and “markId” as arguments and calls a try method with the arguments.

The try method instructs execution of PlayList playback and outputs the result to the standard output function. To be more specific, the try method calls a PlayPL method with the arguments “playListId” and “markId” in order to cause the platform unit to execute JMFPlaybackControl, which is playback control by a JMF player instance (PlayPL(playListId, markId)). The try method then calls a printLog function (printLog(DebugLog.INFO, this, “PlayPL PL:”+playListId+“mark:”+markId)). The arguments for calling the PlayPL method are the playListId and tmarkId. Thus, playback of the playlist is started from the point indicated by the markId.

The arguments for calling the printLog function include “DebugLog.INFO” and “this”. Thus, in response to the call to the printLog function, the GUI displays the caller function name “try”.

On the other hand, the arguments for calling the printLog function include “PlayPL PL:”+playListId+“mark:”+markId. Thus, the playListId on the display is preceded by the character string “PlayPL PL:”, whereas the markId on the display is preceded by the character string “mark:”. These arguments and character strings are output as an execution log to the debugging device via the serial port.

The method “catch (Exception e)” is executed upon an occurrence of exception handling. To be more specific, the catch (Exception e) calls “printException” with “DebugLog.ERROR” as an argument.

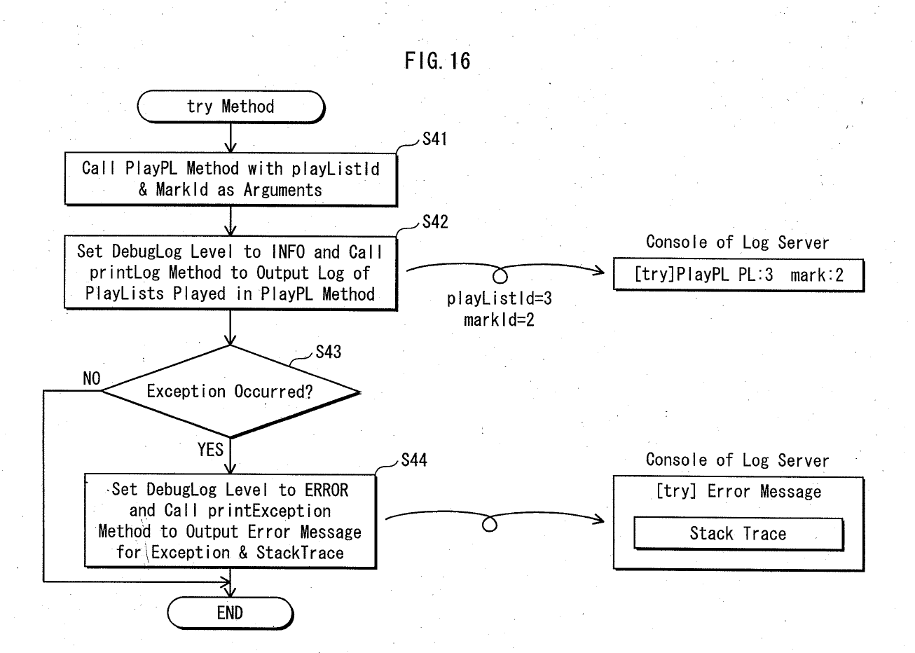

FIG. 16 is a flowchart of the processing steps of the try method. First of all, the PlayPL method is called with the arguments “playListId” and “MarkId” (Step S41). Next, the debuglevel is set to “INFO” and the PrintLog method is called to output the log of the playlist played by the printLog method (Step S42). In the case where the playListID=3 and MarkId=2, the character string that reads “[try]playPL PL: 3 mark: 2” appears on the console of the log server terminal, as shown on the right of Step S42 in the figure.

In Step S43, it is judged whether Exception has occurred. If no Exception occurs, the processing shown in this flowchart ends. If an Exception occurs, the debugLevel is set to “ERROR” and the PrintException method is called to output the error message of the Exception occurred during execution of the try method and also to output StackTrack (Step S44). As a result of the PrintException method, “[try] error message” and the stack trace appear on the console of the log server terminal in a two-row format as shown on the right of Step S44 in the figure.

As in the debug routine described above, by adding the standard output function at appropriate locations in the program source code, the execution state at arbitrary points in the program can be monitored. It should be noted, however, that execution of the output function takes a certain length of time, so that addition of the standard output function affects the execution timing.

### Embodiment 3

Embodiment 3 of the present invention implements reading and writing of variables indicating the internal states of the BD-ROM playback device.

The BD-J application contains an interrupt instruction and a monitoring program embedded therein. In response to a command input to the serial port, the interrupt instruction causes a branch from the BD-J application to the monitoring program.

The monitoring program is placed in the stand-by state until a command is input from the serial port. Upon receipt of a command via the serial port, the monitoring program executes a process as instructed by the command.

Examples of commands that may be input include a read command and a write command. The read command contains a 1^{st} operand that designates the PSR number targeted for reading. The write command contains a 1^{st} operand that designates the PSR number targeted for writing and a 2^{nd} operand that is an immediate value.

Upon receipt of a read command, the monitoring program makes a call to the playback control engine in order to cause the playback control engine to read the value stored in the PSR having the register number designated by the 1^{st} operand. In response to the call, the playback control engine reads the PSR value. In response, the monitoring program makes another call to the standard output function using the PSR value as an argument. As a result, the PSR value is trans In response, the monitoring program makes another call mitted to the log server terminal, so that the log server terminal acquires the PSR value via the serial port.

Upon receipt of a write command, the monitoring program makes a call to the playback control engine in order to cause the playback control engine to write the immediate value specified in the 2^{nd} operand to the PSR having the register number designated by the 1^{st} operand. In response to the call, the playback control engine issues an event indicating whether the writing is dully performed. In response, the monitoring program makes another call to the standard output function using the result of writing indicted by the event as an argument. As a result, the PSR value is transmitted to the log server terminal, so that the log server terminal acquires the PSR value via the serial port.

As described above, according to the present embodiment, the monitoring program embedded in the BD-J application executes writing and reading to PSRs and the result of the writing and reading is transmitted to the log server terminal via the serial port. That is to say, the log server terminal is allowed to manipulate PSR values through the monitoring program embedded in the BD-J application.

### Embodiment 4

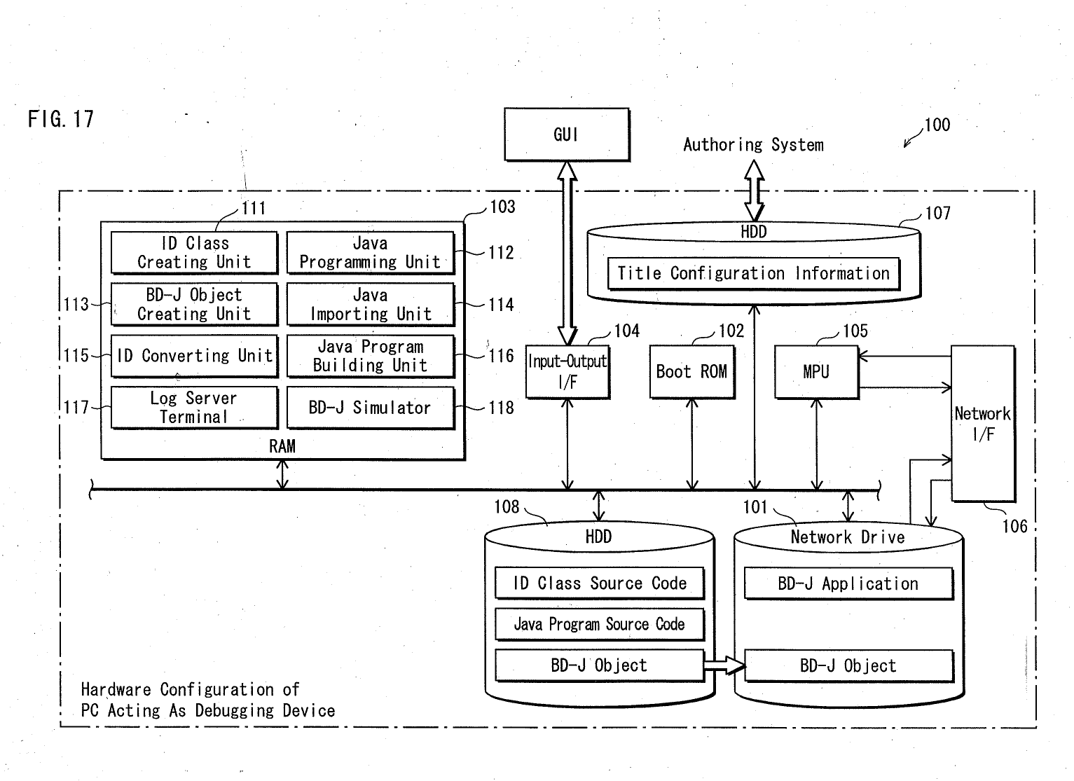

In Embodiment 4 of the present invention, the internal structure of the debugging device, which is the IDE environment, is described. FIG. 17 is a view showing the hardware configuration of the debugging device. In the present embodiment, the PC 100 is composed of a network drive 101, a boot ROM 102, a RAM 103, an input-output I/F 104, an MPU 105, and a network I/F 106.

### —Network Drive 101

The network drive 101 is a hard disk for storing the BD-J application and the BD-J object to be supplied to the ADK environment. The BD-ROM playback device 200 recognizes the hard disk as a network drive.

### —Boot ROM 102

The boot ROM 102 stores software code for bootstrapping an operation system.

### —RAM 103

To the RAM 103, a kernel and a handler of the operating system as well as various programs used for creating a BD-J application in the IDE environment are loaded.

### —Input-Output I/F 104

The input-output I/F 104 constructs a GUI by connecting input devices, such as a keyboard and a mouse, and output devices, such as a display.

### —MPU 105

The MPU 105 executes software loaded to the RAM 103.

### —Network I/F 106

The network I/F 106 permits input and output of data over a network.

### —HDD 107

The HDD 107 is a hard disk drive used for storing title configuration information acquired from an authoring system.

The title configuration information defines the relationship among various playback units, such as titles, Movie objects, BD-J objects and PlayLists, using a tree structure. To be more specific, the title configuration information defines a node corresponding to a “disk name” of the BD-ROM to be produced, a node corresponding to a “title” that is available for playback in Index.bdmv on the BD-ROM, nodes corresponding to “a Movie object and a BD-J object” constituting the title, and nodes of “PlayLists” that is available for playback in the Movie object and BD-J object, and also defines the relationship among the title, Movie object, BD-J object and PlayLists by connecting these nodes with edges. In the title configuration information, the PlayLists are described using abstract names such as MainPlaylist and MenuPlaylist, rather than using the specific file names, such as 0001.mpls and 00002.mpls, which are used to record the PlayLists onto the BD-ROM. When data for BD-ROM is produced in parallel with data for DVD-video, it is desirable that the configuration of the playback units is defined in an abstract form.

### —HDD 108

The HDD 108 is a HDD for stoning the kernel of the operating system, the handler, and various pieces of software for the IDE environment, ID class source code, Java™ program source code, and yet-to-be-completed BD-J objects.

The ID class source code is a source code of a Java™ class library used by the Java™ program to access the Index.bdmv and PlayList information that is to be ultimately created on the disc. The ID class source code contains a constructor that reads a predetermined PlayList file from the disk by specifying a PlayList number. Playback of an AV Clip is executed using instances created by running the constructor. The variable names in the ID class library are defined using the names of the playlist nodes, such as MainPlaylist and MenuPlaylist, defined by the title configuration information. Note that the playlist number used herein is a dummy number. The Java™ class library created by compiling the ID class source code is referred to as an ID class library.

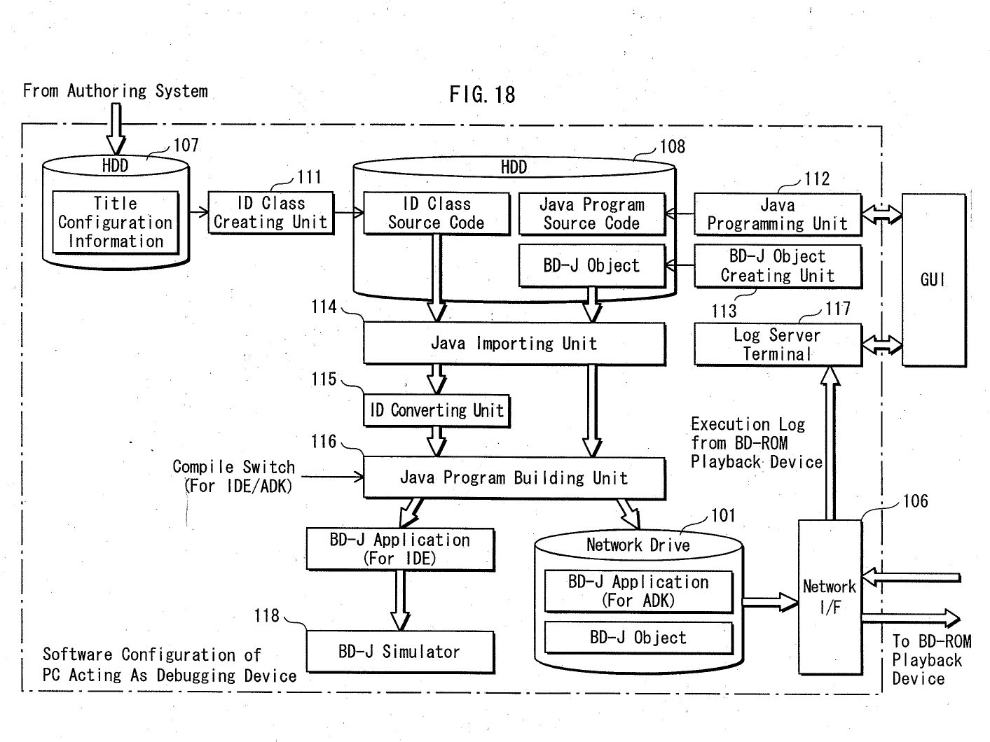

This concludes the description of the hardware components of the PC 100. The following describes the software components of the PC 100. FIG. 18 is a view showing the software configuration of the IDE environment. As shown in the figure, the IDE environment is composed of an ID class creating unit 111, a Java™ programming unit 112, a BD-J object creating unit 113, a Java™ importing unit 114, an ID converting unit 115, a Java™ program building unit 116, the log server terminal 117, and a BD-J simulator 118.

### 1. ID Class Creating Unit 111

The ID class creating unit 111 creates an ID class source code using the title configuration information stored in the HDD 107 and stores the created ID class source code to the HDD 108.

### 2. Java™ Programming Unit 112

The Java™ programming unit 112 creates the source code of a Java™ program in accordance with editing operations made by the user via a user interface such as GUI, and stores the Java™ program source code to the HDD 108. A BD-J application is later created based on the Java™ program source code. In order to create a Java™ program as a BD-J application, it is necessary to make a reference to information specific to the BD-ROM, such as the Index.bdmv and PlayList. In order to make such a reference, an ID class library as described above is used.

### 3. BD-J Object Creating Unit 113

The BD-J object creating unit 113 creates BD-J object creation information based on the Java™ program source codes and the ID class source code created by the Java™ programming unit 112. The BD-J object creation information provides a template of a BD-J object to be ultimately recorded on the BD-ROM and specifies a playlist with the variable names defined by the ID class library, rather than with the specific file names such as 00001.mpls and 00002.mpls.

4. Java Importing unit 114

The Java™ importing unit 114 imports the Java™ program source code, ID class source code, and BD-J object creation information created by the BD-J object creating unit 113. The Java™ importing unit 114 uses the title configuration information to associate the Java™ program source code, ID class source code, and BD-J object creation information with their corresponding BD-J objects. In addition, the Java™ importing unit 114 sets the BD-J object creation information for BD-J object nodes defined by the title configuration information.

### 5. ID Converting Unit 115

The ID converting unit 115 converts the ID class source code imported by the Java™ importing unit 114 into a title number and a playlist number. The ID converting unit 115 also converts the BD-J object creation information to bring the playlist names defined in a BD-J object into agreement with the actual PlayList numbers on the disk.

### 6. Java Program Building Unit 116

The Java™ program building unit 116 compiles the ID class source code and the Java™ program source code converted by the ID converting unit 115 to output a resulting BD-J object and BD-J application. The BD-J application output by the Java™ program building unit 116 is in the JAR archive file format.

The Java™ program building unit 116 is capable of setting a plurality of compile switches. With the use of a compile switch designed for the ADK environment, the LOG output API shown in FIG. 15 or a portion of the LOG output API, which is a usage example, is compiled.

With the use of a compile switch designed for the IDE environment, the ID class source code is compiled in a manner to leave the title number and playlist number remain unconverted. This is because the abstract content used in simulation is defined with the playlist node names, such as MainPlaylist and MenuPlaylist, defined by the title configuration information.

### 7. Log Server Terminal 117

The log server terminal 117 displays a log received from the playback device in a window. The window displaying the log by the log server terminal appears on the same screen as the windows shown in FIG. 5. This allows the user to analyze and correct errors of the source program while looking at the log displayed by the log server terminal.

### 8. BD-J Simulator 118

The BD-J simulator 118 performs a simulation of the BD-J application.

This concludes the description of the software configuration of the IDE environment. The following describes the internal structure of the BD-J simulator 118 in more detail.

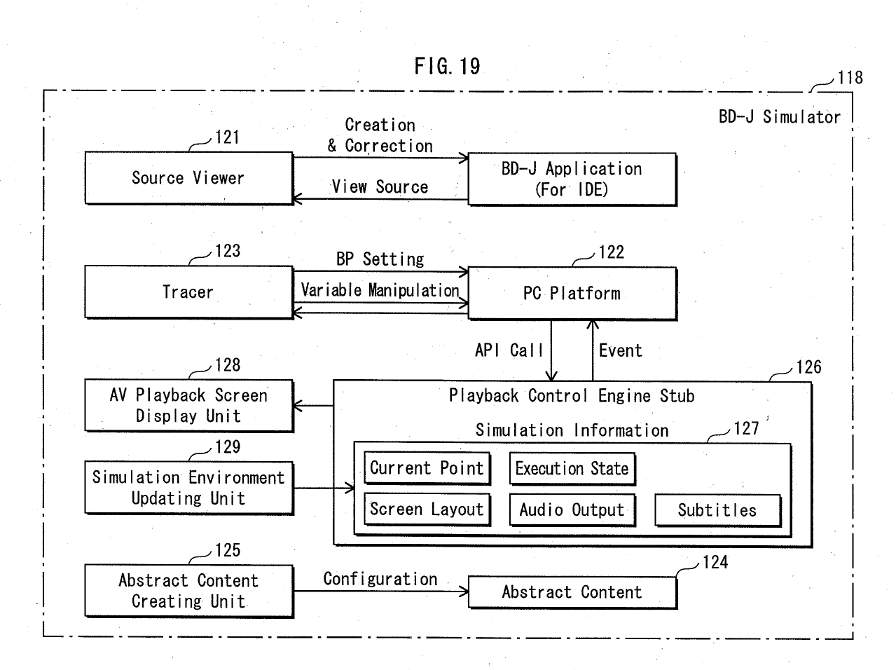

FIG. 19 is a view showing the internal structure of the BD-J simulator 118. As shown in the figure, the BD-J simulator 118 is composed of a source viewer 121, a PC platform unit 122, a tracer 123, an abstract content 124, an abstract content creating unit 125, a playback control engine stub 126, simulation information 127, and an AV playback screen display unit 128. The following now describes each component unit of the BD-J simulator 118.

### 1. Source Viewer 121

The source viewer 121 displays the source list of the BD-J application and creates a source code in accordance with user operations and corrects the created source code also in accordance with user operations.

### 2. PC Platform Unit 122

The PC platform unit 122 is a Java platform unit provided on the PC 100 and executes the BD-J application on the PC 100.

### 2. Tracer 123

The tracer 123 is software for outputting the executed operations, registers, and variables. The tracer has the breakpoint setting function, one-step execution function, and snapshot function. The snapshot function executes upon execution of a specific function or under a specific condition to output register values, variable values or an execution result. The user may combine these processes to carry out various debugging schemas, such as execution of the application after modifying a variable.

### 3. Abstract Content 124

The abstract content 124 is a substitute for an AV content to be used in a simulation. The abstract content 124 differs from an actual AV content to be recorded on the BD-ROM in the following respect. That is, the AV content on the BD-ROM is described using the syntax complaint with the BD-ROM application layer standard. On the other hand, the syntax used in the abstract content 124 is more abstract than the syntax complaint with the BD-ROM application layer standard. To be more specific, the components of the abstract content 124 are specified with the playlist node names defined in the title configuration information, such as MainPlaylist and MenuPlaylist. The abstract content is composed of one or more playlists. Each playlist may be divided into one or more chapters and provided with logical marks called a “playlist mark” set at an arbitral point. Each playlist in the abstract content specifies the resolution, encode type, frame rate, length of the video and also specifies the number of audio streams available for playback in the playlist, and the number of sub-titles available for playback in the playlist. Thus, each playlist implements picture-in-picture playback. The picture-in-picture playback refers to playback of different motion pictures one on a primary screen and another in a secondary screen inserted on the primary screen.

### 4. Abstract Content Creating Unit 125

The abstract content creating unit 125 displays a playlist configuration menu 501 and creates an abstract content in accordance with user operations made on the menu.

### i) Playlist Configuration Menu 501

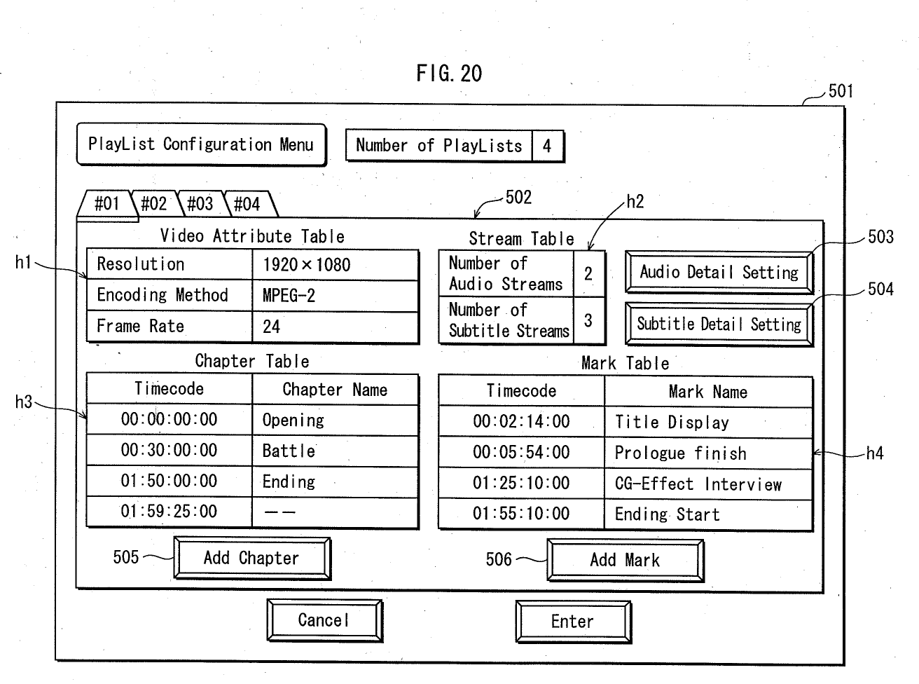

FIG. 20 is a view showing one example of the playlist configuration menu 501. As shown in the figure, the playlist configuration menu 501 is composed of a plurality of playlist panels 502, a cancel button, and an enter button.

### ii) Playlist Panels 502

The playlist panels 502 are GUI components each corresponding to a different one of the playlists to visually present the details of the playlist for user interactions. The playlist panels 502 each with a tab are overlaid on one another on a display. With a click on any of the tabs, a corresponding one of the playlist panels 502 appears on the top of the overlaid playlist panels 502 to be entirely visible and the one of the playlist panels 502 displayed on the top by that time goes to the rear.

Each playlist panel 502 is a GUI component for receiving user input regarding the various items of the abstract content to make the relevant settings for the abstract content and includes the following tables.

—Video Attribute Table h1

A video attribute table h1 is composed of an index column and an input column. The index column receives names of video attributes, such as “resolution”, “encoding method”, and “frame rate” from the user. In order to make an entry of an attribute name, the user points the index column with a cursor and subsequently makes a key input. The input column receives the specific settings of the corresponding video attributes from the user. In order to make an entry of an attribute setting, the user points the input column with the cursor and subsequently makes a key input. With the user input to the video attribute table, the elements of each playlist are set to the specific values. In the example shown in the figure, the “resolution” is set to “1920×1080”, the encoding method is set to “MPEG-2” and the “frame rate” is set to “24”.

—Stream Table h2

A stream table h2 is composed of an index column and an input column. The index. column receives, from the user, the names of streams, such as “number of audio streams” and “number of subtitle streams” to be played synchronously with vide playback. In order to make an entry of a stream name, the user points the index column with the cursor and subsequently makes a key input. The input column receives the specific values of the corresponding stream numbers from the user. In order to set a stream number, the user points the input column with the cursor and subsequently makes a key input. With the user input to the stream table, the elements of each playlist are set to the specific values. In the example shown in the figure, the “number of audio streams” is set to “2” and the “number of subtitle streams” is set to “3”.

—Chapter Table h3

A chapter table h3 is composed of an a timecode column and a chapter name column. The timecode column receives the values of timecode specifying chapters, such as “00:00:00:00”, “00:30:00:00-01:50:00:00”, and “01:59:25:00” from the user. In order to make an entry of a timecode, the user points the timecode column with the cursor and subsequently makes a key input. The chapter name column receives the specific chapter names. from the user. In order to make an entry of a chapter name, the user points the chapter name column with the cursor and subsequently makes a key input. With the user input to the chapter table, specific names are assigned to the respective chapters. In the example shown in the figure, the chapter names, such as “Opening”, “Battle”, and “Ending” are assigned.

—Mark Table h4

A mark table h4 is composed of a timecode column and a mark name column. The timecode column receives values of timecode specifying marks, such as “00:02:14:00”, “00:05:54:00-01:25:10:00”, and “01:55:10:00” from the user. In order to make an entry of a timecode, the user points the timecode column with the cursor and subsequently makes a key input. The mark name column receives specific mark names from the user. In order make an entry of a mark name, the user points the mark name column with the cursor and subsequently makes a key input. With the user input to the mark table, specific names are assigned to the respective marks. In the example shown in the figure, the mark names, such as “Title Display”, “Prologue Finish”, “CG-Effect Interview”, and “Ending Start” are assigned.

The playlist configuration menu 501 also contains an audio detail setting button 503, a subtitle detail setting button 504, an “add chapter” button 505, and a “add mark” button 506.

iii) Audio Detail Setting Button 503

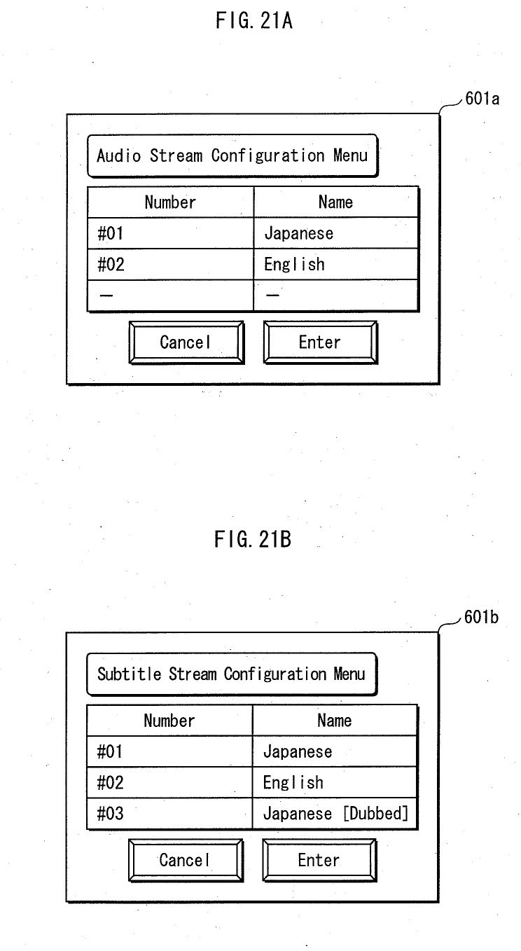

The audio detail setting button 503 is a GUI component for receiving, from the user, a display request for an audio stream configuration menu 601a as shown in FIG. 21A. The audio stream configuration menu 601a is a GUI for receiving the detailed audio settings from the user. The received details of audio settings are displayed in a form of table composed of a number column and a name column. The number column receives, from the user, audio numbers (“#01” and “#02” in the figure) each identifying a piece of audio data available for playback. The name column receives, from the user, abstract names (“Japanese” and “English” in the figure) of the respective pieces of audio data. In order to make an entry of a name, the user points the respective columns with the cursor and subsequently makes a key input, so that the details of audio data are defined.

In addition, this display screen contains a “cancel” button and an “enter” button to allow the user to select whether or not to reflect the settings made on the screen in a future simulation.

### iv) Subtitle Detail Setting Button 504

The subtitle detail setting button 504 is a GUI component for receiving, from the user, a display request for a subtitle stream menu 601b as shown in FIG. 21B. The subtitle stream configuration menu 601b is a GUI for receiving the detailed subtitle settings from the user. The received details of subtitle settings are displayed in a form of table composed of a number column and a name column. The number column receives user input of subtitle numbers (“#01”, “#02”, and “#03” in the figure) each identifying a subtitle available for playback. The name column receives user input of abstract names of subtitles (“Japanese”, “English”, and “Japanese [dubbed]” in the figure). In order to make such input, the user points the respective columns with the cursor and subsequently makes a key input, so that the details of subtitles are defined.

In addition, this display screen contains a “cancel” button and an “enter” button to allow the user to select whether or not to reflect the settings made on the screen in a future simulation.

With the above inputs received via the panels, the details of each playlist are defined to establish synchronization with the application.

Since the abstract content 124 is created according to user operations received via the GUIs, the programmer is enabled to configure an abstract content having any specifications as desired and use the abstract content for debugging of the BD-J application. This concludes the description of the abstract content creating unit 125.

### 5. Playback Control Engine Stub 126

The playback control engine stub 126 carries out debugging of the BD-J application on the PC, before completion of the AV data authoring and thus without AV data. Consequently, the playback control engine stub 126 provides the following to the BD-J application:

AV playback process;

Occurrence of an event due to a payback state change (Stop, Trickplay, and so on); and

Information held by the BD-ROM playback device, such as the PSR values and the stored contents in a persistent area.

The provision allows the major graphics display processing and key event processing to be tested. In addition, the behavior of AV playback is simulated to confirm the algorithm (logic). In general, the standard BD-ROM player model has a layer structure with the BD-J platform residing on a playback control engine. The playback control engine is a high-end component designed for playback of HD images and therefore difficult to implement it on the PC 100. For this reason, the playback control engine stub 126 is provided on the PC 100 as a substitute of such a high-end playback control engine.

When a playback control API is called, the playback control engine stub 126 analyzes the called playback control engine. Based on the result of analysis, the playback control engine stub 126 changes the simulation information or retrieves information from the simulation information. If a change occurs to the playback emulation information, the playback control engine stub 126 issues a notification of the change of the playback state. It is not necessary to issue a notification for every change that occurs, and the types of changes of playback states to be notified are dynamically altered.

### 6. Simulation Information 127

The simulation information 127 supplies the operating conditions for, for example, a simulation to the playback control engine stub 126 and contains “current point information”, “operation state information”, “screen layout information”, “audio output information”, and “subtitle display information”. The above information items are defined as the PSR values of the playback control engine.

The “current point information” includes the playback timecode identifying the point on the playback stream currently being played, the playlist number identifying the playlist currently being played, the chapter number identifying the chapter containing video to be played, and the playlist mark number.

The “operation state information” includes the playback state, playback direction, and playback rate, for example. The playback state indicates one of the playback stop, normal playback, trickplay playback, and playback paused states. The playback direction indicates whether playback is being executed in the forward or backward direction to the timeline. The playback rate indicates the speed at which the video is played.

The “screen layout information” includes, for example, a playback position indicating an on-screen position at which dummy video playback is to be presented and a non-screen display size of video, and scaling information indicating the scaling factor of the video being played.

The “audio output information” includes, for example, the volume level of audio playback and the audio stream number identifying the audio stream currently played. The subtitle display information includes, for example, the display state of subtitles and the subtitle number indicating the subtitles currently presented.

### 7. AV Playback Screen Display Unit 128

The AV playback screen display unit 128 presents display based on the simulation information and the abstract content 124. As described above, the abstract content 124 and the simulation information 127 are substitutes of a BD-ROM content and the settings of the playback control engine. Therefore, what is displayed by the AV playback screen display unit 128 is a simple dummy, such as a rectangular solidly filled in one color.

Note, however, when a change occurs to the simulation information, the display is updated to reflect the change so that the effect is visible on the screen.

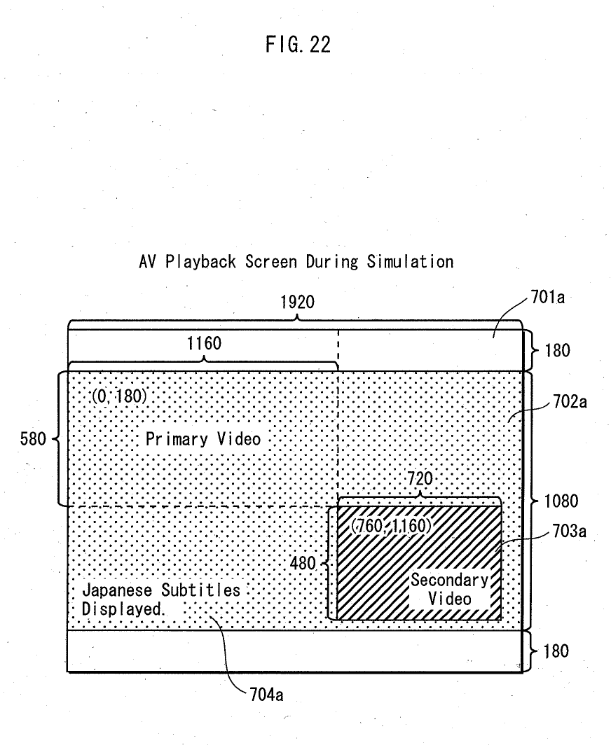

FIG. 22 is a view showing one example of a display screen image presented by the AV playback screen display unit 128. With reference to the figure, a rectangle 701a represents a display area for video playback. Similarly, a rectangle 702a represents a display position and size of a primary video of picture-in-picture display, and a rectangle 703a represents a display position and size of a secondary video of picture-in-picture display. A character string 704a represents subtitle text displayed in synchronism with playback of the primary video.

### 8. Simulation Environment Updating Unit 129

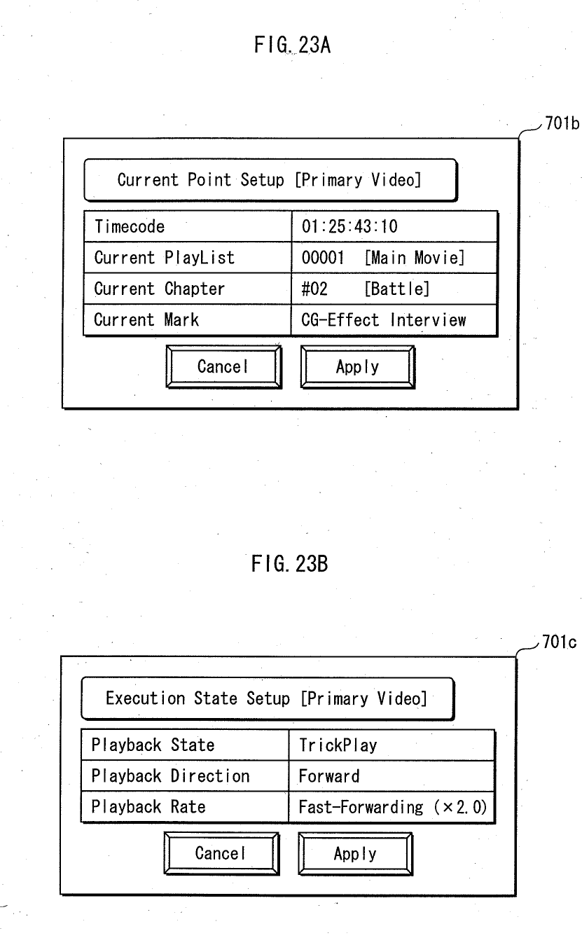

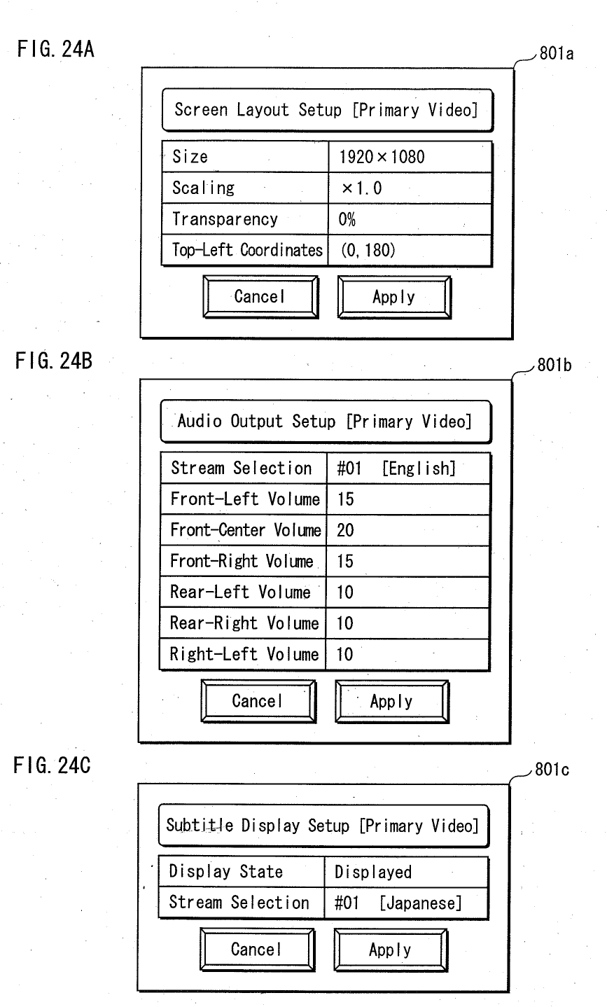

A simulation environment updating unit 129 interactively updates the simulation information based on user instructions. The simulation environment updating unit 129 displays a current point setup menu 701b as shown in FIG. 23A, an operation state setup menu 701c as shown in FIG. 23b, a screen layout setup menu 801a as shown in FIG. 24A, an audio output setup menu 801b as shown in FIG. 24B, and a subtitle display setup menu 801c as shown in FIG. 24C and receives user inputs on the menus to interactively update the simulation information.

The interactive update can be made even during the time playback is presented by the AV playback screen display unit 128. That is to say, the playback state can be changed in real time with playback.

a. Current Point Setup Menu 701b

The current point setup menu 701b shown in FIG. 23A contains a table composed of an index column and an input column that together indicate the current point. The index column stores information items such as “timecode”, “current playlist”, “current chapter”, and “current mark” used to define the current point. The input column receives the specific values of the current playback point. In order to make an entry of a specific value of the current point, the user points the input column with the cursor and subsequently makes a key input. In the example shown in the figure, the “timecode” is set to “01:25:43:10”, the “current playlist” is set to “00001 [Main Movie]” and the “current chapter” is set to “#02 [Battle]”, and the “current mark” is set to “CG-Effect Interview” to define the current point.

In addition, the current point setup menu 701b also contains a “cancel” button and an “apply”. button to allow the user to select whether or not to reflect the changes made on the menu to the simulation.

b. Operation State Setup Menu 701c

The operation state setup menu 701c shown in FIG. 23B contains a table composed of an index column and an input column that together define the playback operation. The index column stores information items, such as “playback state”, “playback direction”, and “playback rate” to define the playback state. The input column receives the specific settings of the respective information items. In order to make an entry of a specific value, the user points the input column with the cursor and subsequently makes a key input. In the example shown in the figure, the “playback state” is set to “trickplay”, the “playback direction” is set to “forward”, and the “playback rate” is set to “fast-forwarding” to define the playback operation.

In addition, the operation state setup menu 701c also contains a “cancel” button and an “apply” button to allow the use to select whether or not to reflect the changes made on the menu to the simulation.

c. Screen Layout Setup Menu 801a

The screen layout setup menu 801a shown in FIG. 24A contains a table composed of an index column and an input column. The index column stores information items, such as “size”, “scaling”, “transparency”, and “top-left coordinates”, to define the display position. The input column receives the specific settings of the respective information items. In order to make an entry of a specific value, the user points the input column with the cursor and subsequently makes a key input. In the example shown in the figure, the “size” is set to “1920×1080”, the “scaling” is set to “1.0×” and the “transparency” is set to 0%, and the “top-left coordinates” at (0, 180).

In addition, the screen layout setup menu 801a also contains a “cancel” button and an “apply” button to allow the user to select whether or not to reflect the changes made on the menu to the simulation.

d. Audio Output Setup Menu 801b

The audio output setup menu 801b shown in FIG. 24B contains a table composed of an index column and an input column that together define the audio settings. The index column stores information items, such as “stream selection”, “front-left volume”, “front-center volume”, “front-right volume”, “rear-left volume”, “rear-right volume”, “right-left volume” to define the volume settings. The input column stores the specific settings of the audio output. In order to make an entry of a specific audio output setting, the user points the input column with the cursor and subsequently makes a key input. In the example shown in the figure, the “stream selection” is set to “#01 [English]”, the “front-left volume” is set to “15”, the “front-center volume” is set to “20”, the “front-right volume” is set to “15”, the “rear-left volume” is set to “10”, the “rear-right volume” is set to “10”, and the “right-left volume” is set to “10”.

In addition, the audio output setup menu 801b also contains a “cancel” button and an “apply” button to allow the user to select whether or not to reflect the changes made on the menu to the simulation.

e. Subtitle Display Setup Menu 801c

The subtitle display setup menu 801c shown in FIG. 24C contains a table composed of an index column and an input column that together define the subtitle settings. The index column stores information items, such as “display state” and “stream selection” to define the subtitle settings. The input column stores the specific settings of the subtitles. In order to make an entry of a specific setting, the user points the input column with the cursor and subsequently makes a key input. In the example shown in the figure, the “display state” is set to “displayed” and the “stream selection” is set to “#01 [Japanese]”. In addition, the subtitle display setup menu 801c also contains a “cancel” button and an “apply” button to allow the user to select whether or not to reflect the changes made on the menu to the simulation.

The above menus allows the user to set or alter the operating conditions for a simulation, which leads to increase the efficiency of a unit test of the BD-J application.

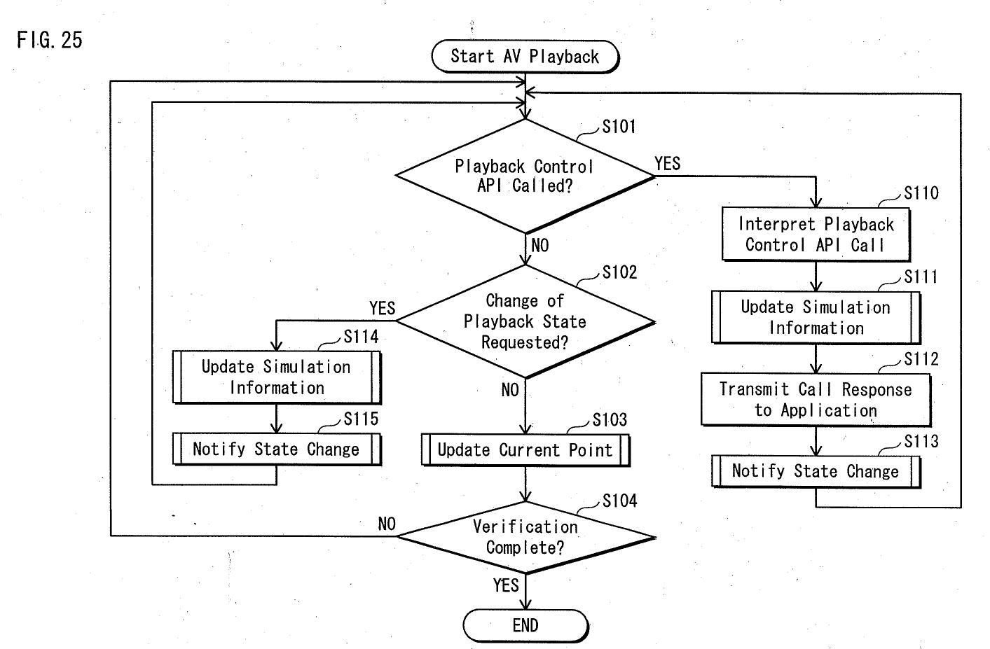

The following describes software implementation of the playback control engine stub 126. The playback control engine stub 126 is implemented on the PC 100 by causing the MPU to execute a computer-readable program that describes in a computer description language the processing steps of the flowcharts shown in FIGS. 25-28.

In the flowchart shown in FIG. 25, Steps S101-S104 creates a loop. In this loop, first, it is judged whether a playback control API is called (Step S101). Next, it is judged whether a request for changing the playback state is received (Step S102). Then, the current point is updated (Step S103). The above steps are repeated until a judgment in Step S104 results in “Yes”.

The judgment made in Step S104 is as to whether or not to end the loop. The above loop is performed repeatedly until the termination judgment results in “Yes”.

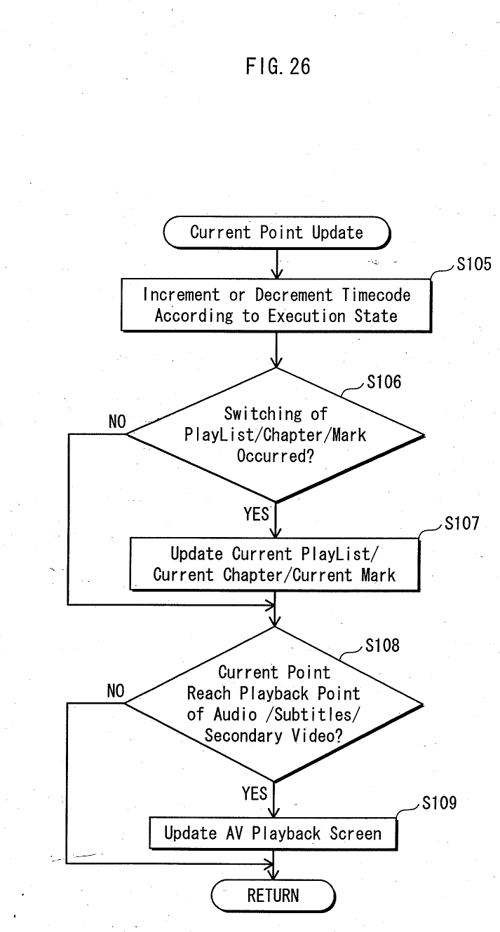

FIG. 26 is a flowchart of the processing steps for the current point update process. First, the timecode specifying the current point is either incremented or decremented (Step S105) and the processing moves onto Step S106. In Step S106, it is judged whether switching of playlist, chapter, or mark takes place at the current point. If no switching takes place, Step S107 is skipped. If switching occurs, Step S107 is performed to update the current playlist, current chapter, and current mark, and then the processing moves onto Step S108.

In Step S108, it is judged whether the current point has reached a playback point of any of audio, subtitles and secondary video. If such a playback point has not yet reached, Step S109 is skipped. If such a playback point is reached, Step S109 is performed to update the AV playback screen and then the processing returns to the flowchart shown in FIG. 25.

If a playback control API is called (Step S101: Yes), the playback control API call is interpreted (Step S110) and the simulation information is changed (Step S111). Then, a reply to the playback control API is transmitted to the application (Step S112). In Step S113, a notification of the state change is issued to the application and then the processing goes back to Step S101.

If no playback control API call is received (Step S101: No) or a user request for changing the playback state is received (Step S102: Yes), the simulation information is updated in Step S114 and a notification of the state change is issued to the application in Step S115. Then, the processing goes back to Step S101.

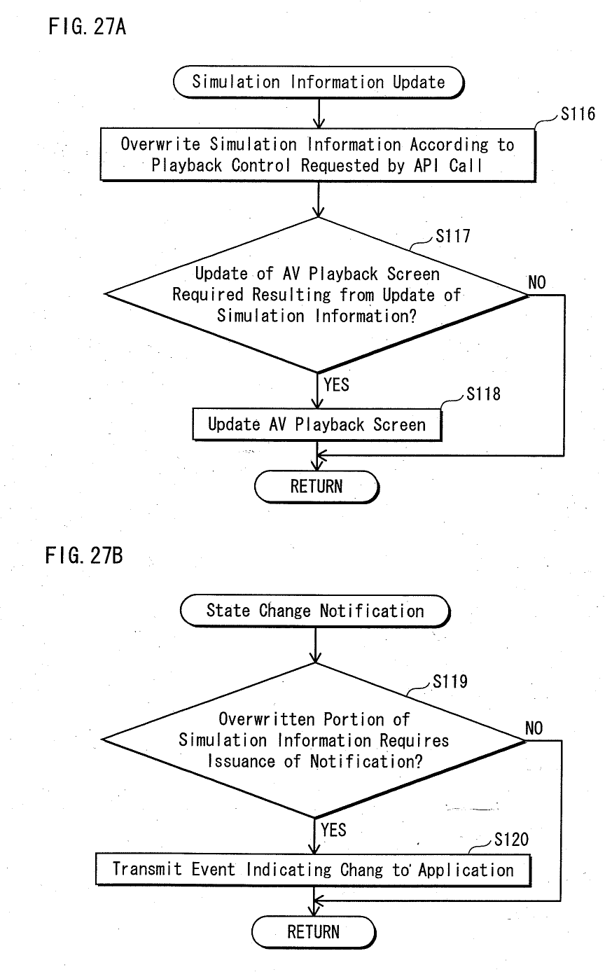

FIG. 27A shows the flowchart of the detailed processing steps of the simulation information update process. In Step S116, items of the simulation information are updated by the playback control API call. In Step S117, it is judged whether the change of the simulation information involves the need to update the AV playback screen.

If the change of the simulation information involves the need to update the AV playback screen (Step S117: Yes), the AV playback screen is updated in Step S118 and then the processing returns to the main routine. On the other hand, if no update is necessary, Step S118 is skipped and the processing returns to the main routine.

FIG. 27B shows the flowchart of the detailed steps of the state change notifying process. In Step S119, it is judged whether the change to the item(s) of the simulation information involves the need to issue a notification to the application. If the judgment in Step S119 results in “Yes”, an event indicating the change is issued to the application and then the processing returns to the main routine. If such a notification is not necessary, Step S120 is skipped and then the processing returns to the main routine.

The following describes the processing described in the above flowcharts in more details by way of specific examples. In the examples described below, it is supposed that the BD-J application requests playback of the playlist “00001” in the following conditions: the playback position is 180 pixels below the top left corner of the screen; the resolution is “1920×1080”; and the scaling is 1×.

When the playback control API call is received from the BD-J application, the playback control engine stub 126 changes the operation state information so that the playback state is set to “normal playback”, the playback direction is set to the “forward”, and the playback rate is set to “normal (×1.0)”, and also changes the current point information so that the playback timecode is set to “00:00:00:00”, the playlist is set to “00001”, and the chapter is set to “#01”.

In response, the AV playback screen display unit 128 updates the screen display to reflect the changes made to the operation state information and the current point information, so that the rectangle having the 1920×1080 pixel size is displayed at the display position that is 180 pixels below the top-left corner of the screen. In addition, the playback control engine stub 126 outputs an event in response to the API call to notify the application that playback of the playlist “00001” is started. Suppose that a user operation is made on the current point setup menu 701b in order to change the current point to the point identified by playback timecode “00:10:00:00”. In response to the user operation, the playback control engine stub 126 changes the playback timecode held in the simulation information to “01:10:00:00”, and the AV playback screen display unit 128 updates the playback timecode presented on the current point setup menu 701b to “01:1.0:00:00”.

In response to an API call to the playback control engine, the playback control engine stub 126 outputs a corresponding event, so that the BD-J application is notified that the timecode is changed to “01:10:00:00”.

Suppose that a user operation is made on the current point setup menu 701b in order to change the current mark to “CG-Effect Interview”. In response to the user operation, the playback control engine stub 126 retrieves, from the abstract content, the timecode “01:25:10:00” indicating the position of the playlist mark “CG-Effect Interview” and changes the playback timecode held in the simulation information 127 to “01:25:10:00”.

In response to the change of the timecode, the AV playback screen display unit 128 updates the playback timecode presented on the current point setup menu 701b to “01:25:10:00”. The playback control engine stub 126 outputs an event to the BD-J application, so that the BD-J application is notified that the playback point has reached the playlist mark “CG-Effect Interview”.

Suppose that, in response to the notification that the playlist mark “CG-Effect Interview” is reached, the BD-J application calls the playback control engine to request playback of the playlist “00002” under the following conditions: the resolution is set to “960×1440”; the playback position is set to 760 pixels below and 1160 pixels to the right from the top-left corner of the screen; the scaling is set to 0.5×. In response to the request, the AV playback screen display unit 128 updates the currently presented display, so that the rectangle of the 480×720 pixel size is displayed at the position 760 pixels below and 1160 pixels to the right from the top-left corner of the screen.

At the time of the update, the playback control engine stub 126 notifies the BD-J application that playback of the playlist “00002” is started.

As described above, the present embodiment enables the BD-J application developer to conduct an operation test of a BD-J application that controls AV playback, even if the AV content to be controlled is being developed in parallel with the BD-J application and thus the application developer does not have the complete version of AV content on hand.

In addition, the present embodiment allows the current playback point to be specified in frames with the timecode, which allows the BD-J application developer to check the state of AV content playback, including the display position and scaling. Thus, without using an actual AV content, the BD-J application developer is allowed to perform an operation test at a sufficient accuracy and to effectively analyze and correct the application behavior.

In addition, even if an error is found as a result of a simulation, the present embodiment allows the exactly same operation to be reproduced, which is convenient for identifying the cause of the error.

### Embodiment 5

Embodiment 5 of the present invention relates to an improvement for effectively testing, analyzing, and correcting operation of an application that depends on playback video of an AV content or on a specific frame of the playback video.

In the previous embodiment, the playback of an AV content is presented using the rectangular boxes as shown in FIG. 22. Such a display, however, is not sufficient to effectively test the application involving a behavior that depends on the video playback or a specific frame image. In view of this, the present embodiment enables to specify a specific image and a point on the AV content at which the image is to be displayed.

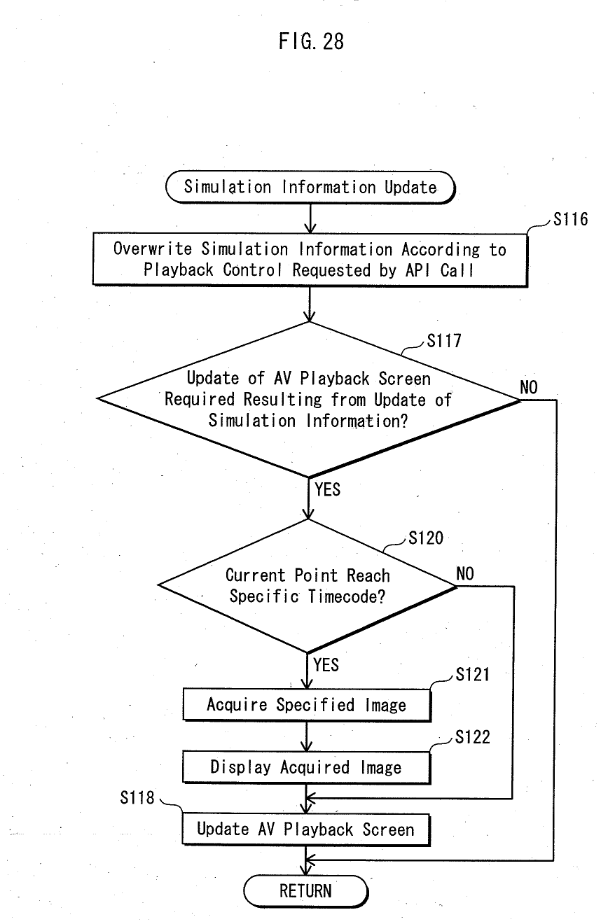

FIG. 28 is a flowchart of the processing steps of another simulation information update process. The flowchart shown in FIG. 28 is created based on the flowchart shown in FIG. 27A and with the additional Steps S120-S122. The additional steps are placed between Steps S117 and S118.

The following description relates to the additional steps. In Step S120, it is judged whether the current point has reached a specified timecode. If the specified timecode is reached, the specified video image is acquired in Step S121 and the playback state is presented on the display screen in Step S122 using the acquired video image. Then, the processing moves onto Step S118. If the specified timecode is not yet reached, Steps S121 and S122 are skipped and the processing moves onto Step S118.

As described above, the present embodiment allows the user to specify a point in the AV content in advance. When the current playback point reaches the specified point, an image specified arbitrarily by the user is presented on the display screen. This feature is advantageous to effectively test, analyze, and correct the behavior of an application that performs a process closely related to display of a specific frame image of an AV content. For example, the application may overlay graphics on a specific portion of the specific frame image of the AV content.

### Embodiment 6

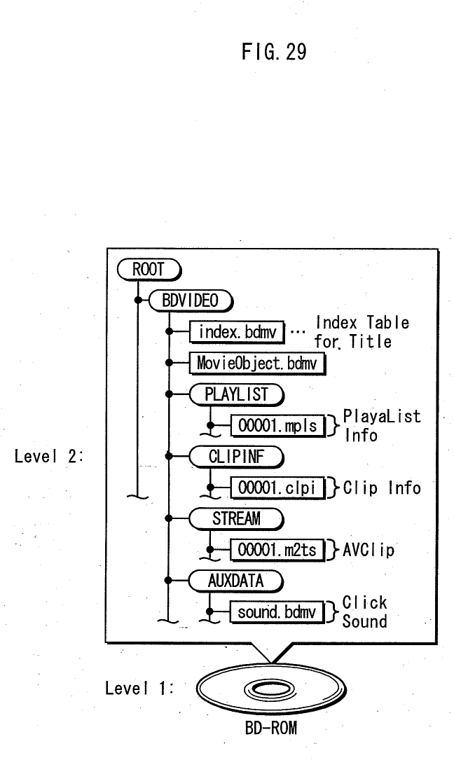

Embodiment 6 of the present invention describes the details of the BD-ROM content (AV content) described in Embodiment 1. As described above, the BD-ROM content is composed of files and directories as shown in FIG. 29.

FIG. 29 is a view showing the internal structure of the BD-ROM. Level 1 in the figure shows the BD-ROM, and Level 2 shows a format of the application layer of the BD-ROM by using a directory structure. In Level 2, BD-ROM has a Root directory and a BDMV directory below the Root directory.

Furthermore, the BDVIDEO directory has the following three sub-directories: a PLAYLIST directory; a CLIPINF directory; and a STREAM directory.

The PLAYLIST directory contains a file with the extension mpls (00001.mpls).

The CLIPINF directory contains a file with the extension clpi (00001.clpi).

The STREAM directory contains a file with the extension m2ts (00001.m2ts).

The above directory structure shows that multiple files of different types are stored on the BD-ROM.

The following provides descriptions of the individual files. The file “xxxxx.m2ts” shown in the figure contains a MainClip and a SubClip.

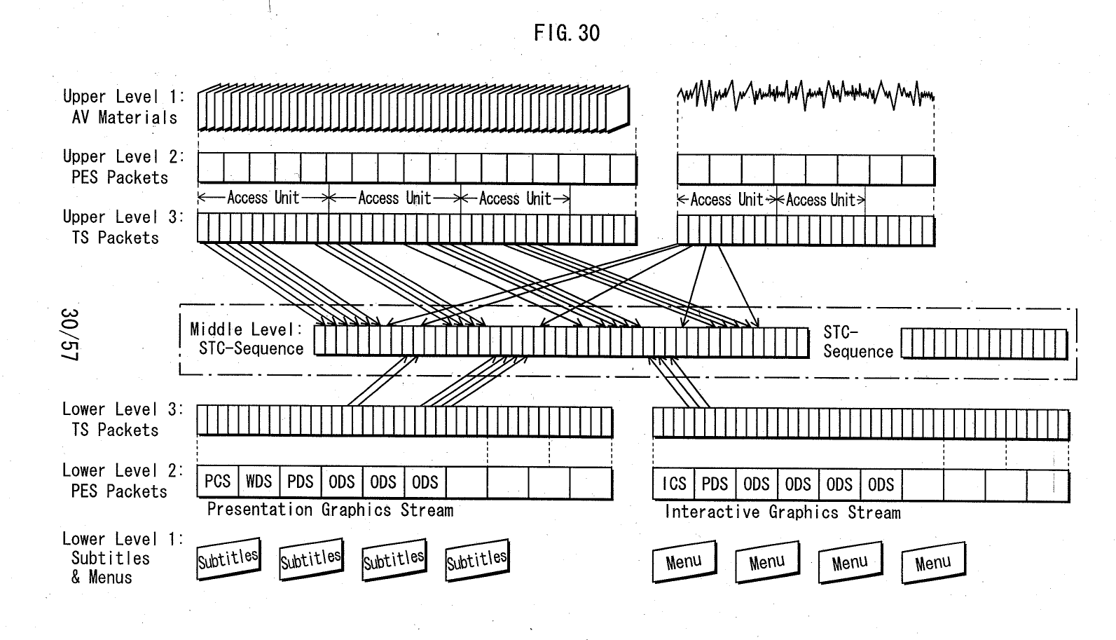

First, the internal structure of the MainClip is described. FIG. 30 is a schematic view showing how the file with extension “.m2ts” is structured. The file having the extension “.m2ts” (00001.m2ts) stores an AV Clip. The AV Clip is a digital stream in the MPEG2-Transport Stream format. The digital stream is generated by converting the digitized video and audio (upper Level 1) into an elementary stream composed of PES packets (upper Level 2), and converting the elementary stream into TS packets (upper Level 3), and similarly, converting the presentation graphics (PG) stream carrying the subtitles or the like and the Interactive Graphics (IG) stream (lower Level 1 and lower Level 2) into the TS packets (lower Level 3), and then finally multiplexing these TS packets into the digital stream.

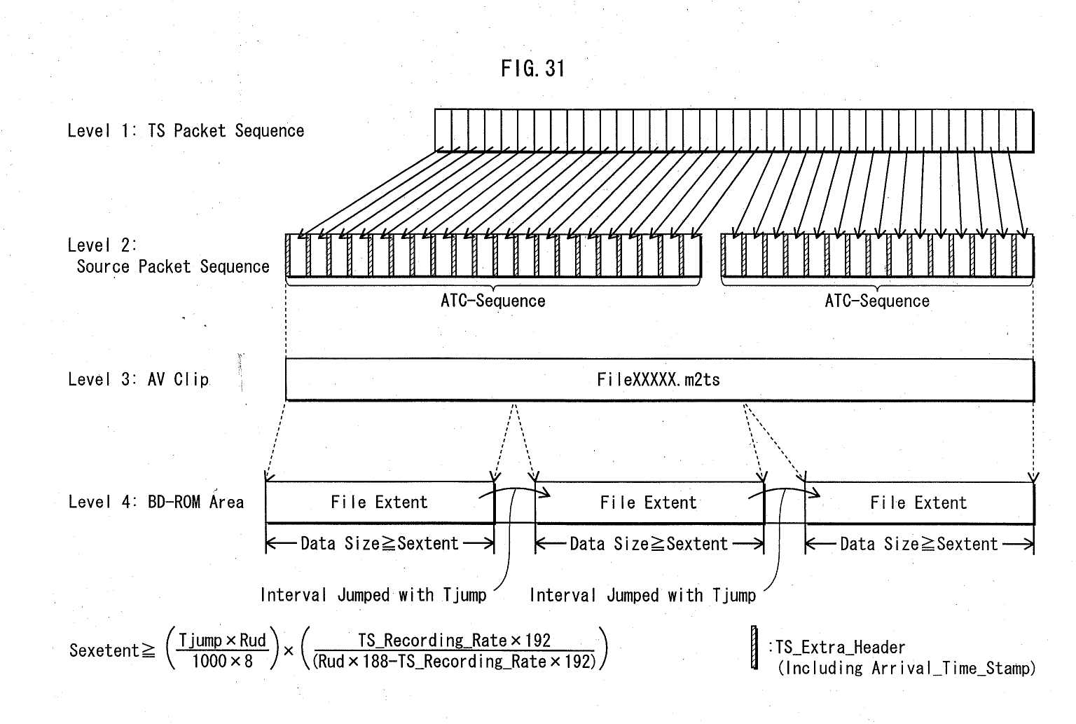

Next, how the AV Clip having the above-described structure is written to the BD-ROM is explained. FIG. 31 shows the processes through which the TS packets constituting the AV Clip are written to the BD-ROM. Level 1 of the figure shows the TS packets constituting the AV Clip.

As shown in Level 2 of FIG. 31, each of a plurality of 188-byte TS packets constituting the AV Clip is attached with a 4-byte TS_extra_header (shaded portions in the figure) to generate a 192-byte Source packet. The TS_extra_header includes an Arrival_Time_Stamp that is information indicating the time for supplying the TS packet to the decoder.

The AV Clip shown in Level 3 includes one or more “ATC_Sequences” each of which is a sequence of Source packets each having an Arrival_Time_Stamp. The “ATC_Sequence” is a sequence of Source packets, where Arrival_Time_Clocks referred to by the respective Arrival_Time_Stamps do not include “arrival time-base discontinuity”. In other words, the “ATC_Sequence” is a sequence of Source packets having Arrival_Time_Stamps referring to continuous Arrival_Time_Clocks.

Such ATC_Sequences constitute the AV Clip and are recorded on the BD-ROM in the file called “xxxxx.m2ts”.

Similarly to any normal computer file, the AV Clip is divided into one or more file extents, which are then recorded in areas on the BD-ROM. Level 4 schematically shows how the AV Clip is recorded on the BD-ROM. In Level 4, each file extent of the file has a data length that is equal to or larger than a predetermined length called Sextent (see the equation shown in the figure).

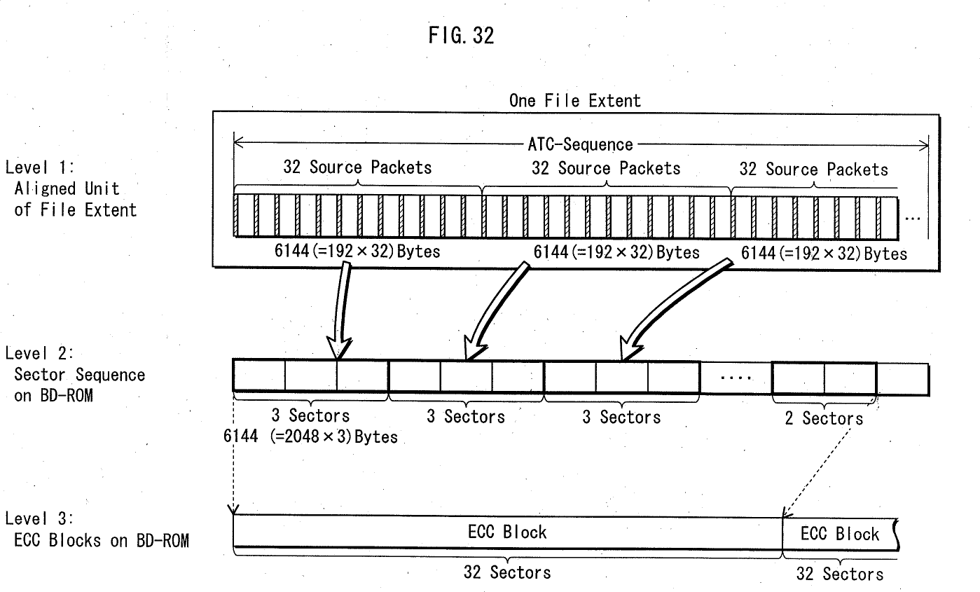

FIG. 32 is a view showing the relationship between the physical unit of the BD-ROM and the source packets constituting one file extent. As shown in Level 2, a plurality of sectors are formed on the BD-ROM. The Source packets constituting the file extent are, as shown in Level 1, divided into groups each of which is composed of 32 Source packets. Each group of Source packets is then written into a set of three consecutive sectors. The group of 32 Source packets is 6144 bytes (=32×192), which is equivalent to the size of three sectors (=2048×3). The 32 Source packets stored in the three sectors is called an “Aligned Unit”. Writing to the BD-ROM is performed in units of Aligned Units.

In Level 3, an error correction code is attached to each block of 32 sectors. The block with the error correction code is referred to as an ECC block. As long as accessing the BD-ROM in units of Aligned Units, the playback device can acquire 32 complete Source packets. Thus concludes the description of the writing process of the AV Clip to the BD-ROM.

The following describes the elementary streams multiplexed in the MainClip in more detail.

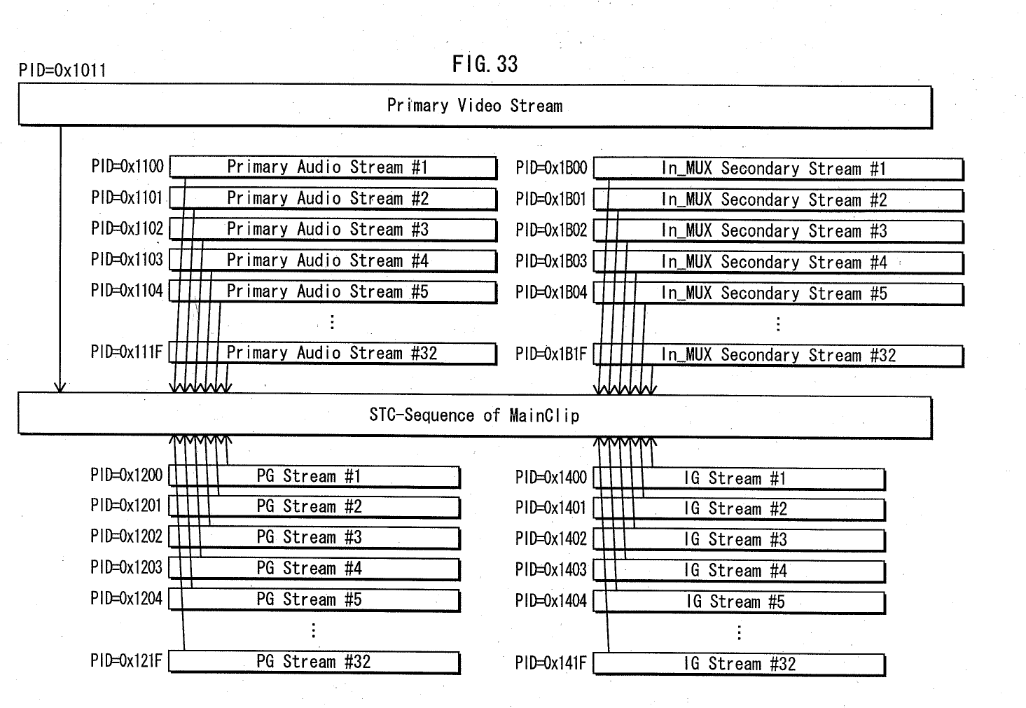

FIG. 33 is a view showing the elementary streams that are multiplexed into the MainClip. The elementary streams multiplexed into STC-Sequence of the MainClip are: a primary video stream having PID of 0x1011; a primary audio streams having PIDs of 0x1100 to 0x111F; 32 PG streams having PIDs of 0x1200 to 0x121F; 32 IG streams having PIDs of 0x1400 to 0x141F; and 32 secondary video streams having PIDs of 0x1B00 to 0x1B1F.

The following describes each of the video stream, audio stream, PG stream, and IG stream.

### <Primary Video Stream>

The primary video stream is a stream constituting the main movie, and is composed of picture data of SDTV and HDTV. The video stream is in the VC-1, MPEG4-AVC, or MPEG2-Video format. When the primary video stream is a video-stream in MPEG4-AVC format, timestamps such as PTS and DTS are attached to IDR, I, P and B pictures, and playback control is performed in units of a picture. A unit of a video stream, which is a unit for playback control with PTS and DTS attached thereto, is called “Video Presentation Unit”.

### <Secondary Video Stream>

The secondary video stream is a stream presenting a commentary or the like of the motion picture, and picture-in-picture playback is implemented by overlaying the playback video of the secondary video stream with the primary video stream. The secondary video stream is in the VC-1, MPEG4-AVC or MPEG2-Video video stream format, and includes “Video Presentation Units”. The possible formats of the secondary video stream include the 525/60, 625/50, 1920×1080 or 1280×720 video format.

### <Primary Audio Stream>

The primary audio streams are streams presenting main audio of the motion picture, and the formats of the primary audio streams include LPCM audio stream format, DTS-HD audio stream format, DD/DD+audio stream format, and DD/MLP audio stream format. Timestamps are attached to audio frames in the audio streams, and playback control is performed in units of an audio frame. A unit of an audio stream, which is a unit for playback control with a time stamp attached thereto, is called “Audio Presentation Unit”. Note that, although being not recorded on the BD-ROM here, audio streams presenting sub-audio of a motion picture are called secondary audio streams.

### <PG Stream>

The PG stream is a graphics stream constituting subtitles written in a language. There are a plurality of streams that respectively correspond to a plurality of languages such as English, Japanese, and French.

### <IG Stream>

The IG streams are graphics streams for achieving interactive control. The interactive control defined by an IG stream is an interactive control that is compatible with an interactive control on a DVD playback device.

As shown in the figure, an elementary stream that is multiplexed into the same AV Clip where the primary video stream is multiplexed is called “In_MUX stream”.

This concludes the description of the MainClip. The following describes the internal structure of SubClip.

In the SubClip, the following four types of elementary streams are multiplexed: video streams, audio streams, PG streams and IG streams. The following gives a detailed description of the types of elementary streams which are multiplexed into an AV Clip.

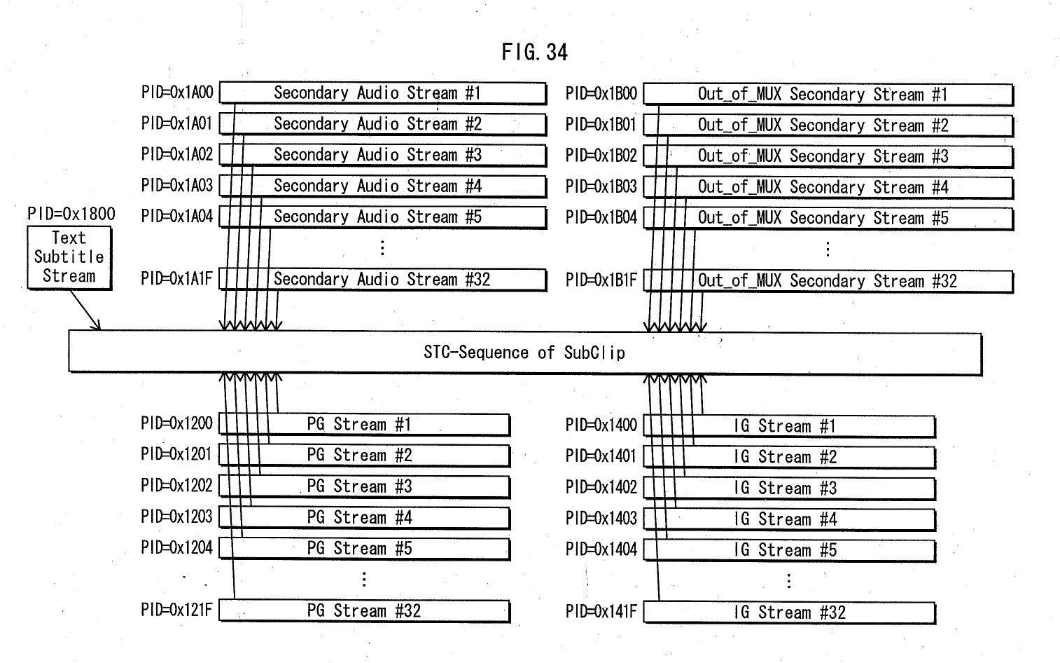

FIG. 34 is a view showing the elementary streams multiplexed into the SubClip. The elementary streams to be multiplexed into the SubClip are: textST stream having PID of 0x1800; primary audio streams having PIDs of 0x1A00 to 0x1A1F; 32 Out_of_MUX_Secondary video streams having PIDs of 0x1B00 to 0x1B1F; 32 PG streams having PIDs of 0x1200 to 0x1121F; and 32 IG streams having PIDs of 0x1400 to 0x141F. As the secondary video streams shown in FIG. 34, secondary video streams to be multiplexed into an AV Clip, which is a different AV Clip where the primary video stream is multiplexed, are called “Out_of_MUX_Secondary video streams”. General elementary streams to be multiplexed into a different AV Clip from the primary video stream, besides the secondary video streams, are called “Out_of_MUX streams”.

### <BD-ROM Structure 2: Clip Information>

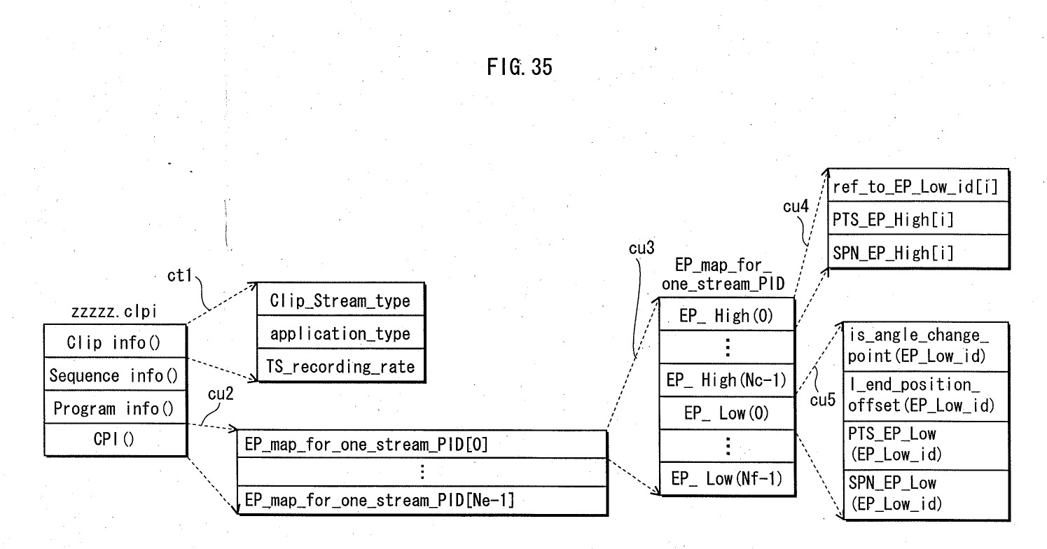

Next are described files having the extension “clpi”. Files with the extension “clpi” (00001.clpi and 00002.clpi) store Clip information. The Clip information is management information on each AV Clip. FIG. 35 is a view showing the internal structure of Clip information. As shown on the left-hand side of the figure, the Clip information includes:

i) “ClipInfo( )” storing therein information regarding the AV Clip;

ii) “Sequence Info( )” storing therein information regarding the ATC Sequence and the STC Sequence;

iii) “Program Info( )” storing therein information regarding the Program Sequence; and

iv) “Characteristic Point Info (CPI( ))”.

The “ClipInfo” includes “application_type” indicating the application type of the AV Clip referred to by the Clip information. Referring to the ClipInfo allows identification of whether the application type is the MainClip or SubClip, whether video is contained, or whether still pictures (slide show) are contained. In addition, the above-mentioned TS_recording_rate is described in the ClipInfo.

The Sequence Info is information regarding one or more STC-Sequences and ATC-Sequences contained in the AV Clip. The reason that these information are provided is to preliminarily notify the playback device of the system time-base discontinuity and the arrival time-base discontinuity. That is to say, if such discontinuity is present, there is a possibility that a PTS and an ATS that have the same value appear in the AV Clip. This might be a cause of defective playback. The Sequence Info is provided to indicate from where to where in the transport stream the STCs or the ATCs are sequential.

The Program Info is information that indicates a section (called “Program Sequence”) of the program where the contents are constant. Here, “Program” is a group of elementary streams that share the common timeline for synchronous playback. The reason that the Program Info is provided is to preliminarily notify the playback device of a point at which the Program contents change. It should be noted here that the point at which the Program contents change is, for example, a point at which the PID of the video stream changes, or a point at which the type of the video stream changes from SDTV to HDTV.

Next is described the Characteristic Point Info. The lead line cu2 in FIG. 35 indicates a close-up of the structure of CPI. As indicated by the lead line cu2, the CPI is composed of Ne pieces of EP_map_for_one stream_PIDs (EP_map_for_one_stream_PID[0] to EP_map_for_one_stream_PID[Ne−1]). These EP_map_for_one_stream_PIDs are EP_maps of the elementary streams that belong to the AV Clip. The EP_map is information that indicates, in association with an entry time (PTS_EP_start), a packet number (SPN_EP_start) at an entry point where the Access Unit is present in one elementary stream. The lead line cu3 in the figure indicates a close-up of the internal structure of EP_map_for_one_stream_PID.

It is understood from the close-up that the EP_map_for_one_stream_PID is composed of Ne pieces of EP_Highs (EP_High(0) to EP_High(Nc−1)) and Nf pieces of EP_Lows (EP_Low(0) to EP_Low(Nf−1)). Here, the EP_High plays a role of indicating upper bits of the SPN_EP_start and the PTS_EP_start of the Access Unit (Non-IDR I-Picture, IDR-Picture), and the EP_Low plays a role of indicating lower bits of the SPN_EP_start and the PTS_EP_start of the Access Unit (Non-IDR I-Picture and IDR-Picture).

The lead line cu4 in the figure indicates a close-up of the internal structure of EP_High. As indicated by the lead line cu4, the EP_High(i) is composed of: “ref_to_EP_Low_id[i]” that is a reference value to EP_Low; “PTS_EP_High[i]” that indicates upper bits of the PTS of the Access Unit (Non-IDR I-Picture, IDR-Picture); and “SPN_EP_High[i]” that indicates upper bits of the SPN of the Access Unit (Non-IDR I-Picture, IDR-Picture). Here, “i” is an identifier of a given EP_High.

The lead line cu5 in the figure indicates a close-up of the structure of EP_Low. As indicated by the lead line cu5, the EP_Low(i) is composed of: “is_angle_change_point(EP_Low_id)” that indicates whether the corresponding Access Unit is an IDR picture; “I_end_position_offset(EP_Low_id)” that indicates the size of the corresponding Access Unit; “PTS_EP_Low(EP_Low_id)” that indicates lower bits of the PTS of the Access Unit (Non-IDR I-Picture, IDR-Picture); and “SPN_EP_Low(EP_Low_id)” that indicates lower bits of the SPN of the Access Unit (Non-IDRI-Picture, IDR-Picture).

Here, “EP_Low_id” is an identifier for identifying a given EP_Low.

### <Clip Information Explanation 2: EP_Map>

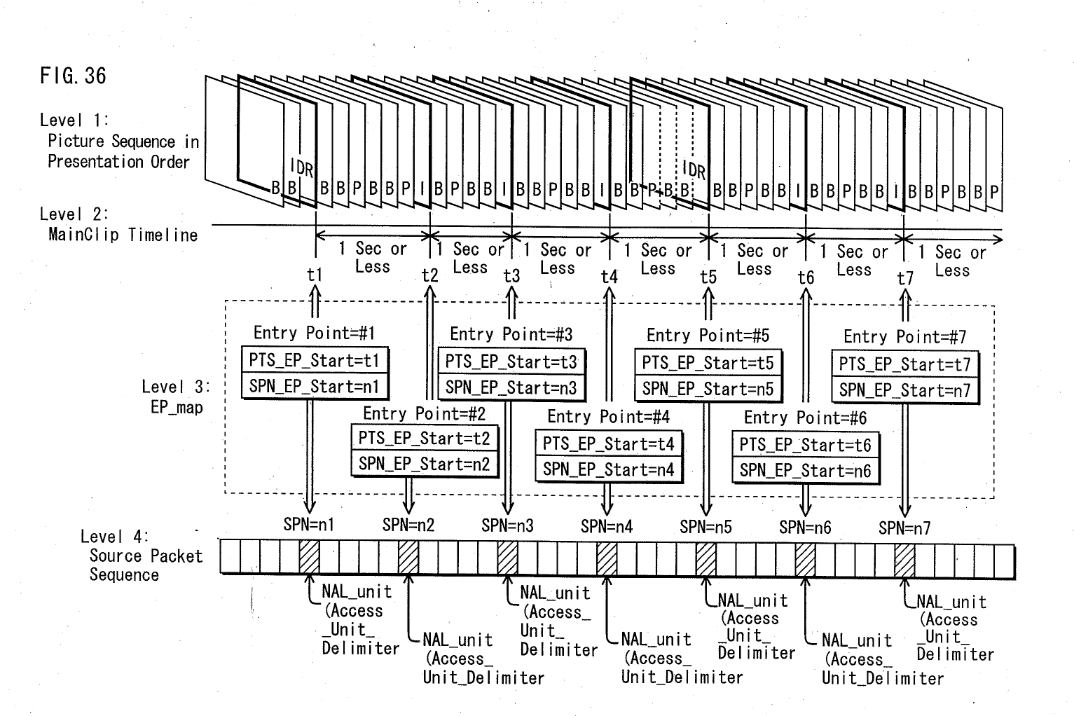

Here, the EP_map is explained using a specific example. FIG. 36 shows the EP_map settings for a video stream of a motion picture. Level 1 shows a plurality of pictures (IDR picture, I-Picture, B-Picture, and P-Picture defined in MPEG4-AVC) arranged in the order of display. Level 2 shows the timeline for the pictures. Level 4 indicates a TS packet sequence on the BD-ROM, and Level 3 indicates settings of the EP_map.

Assume here that, in the timeline of Level 2, an IDR picture or an I picture is present at each time point t1 to t7. The interval between adjacent ones of the time points t1 to t7 is approximately one second. The EP_map used for the motion picture is set to indicate t1 to t7 with the entry times (PTS_EP_start), and indicate entry points (SPN_EP_start) in association with the entry times.

### <PlayList Information>

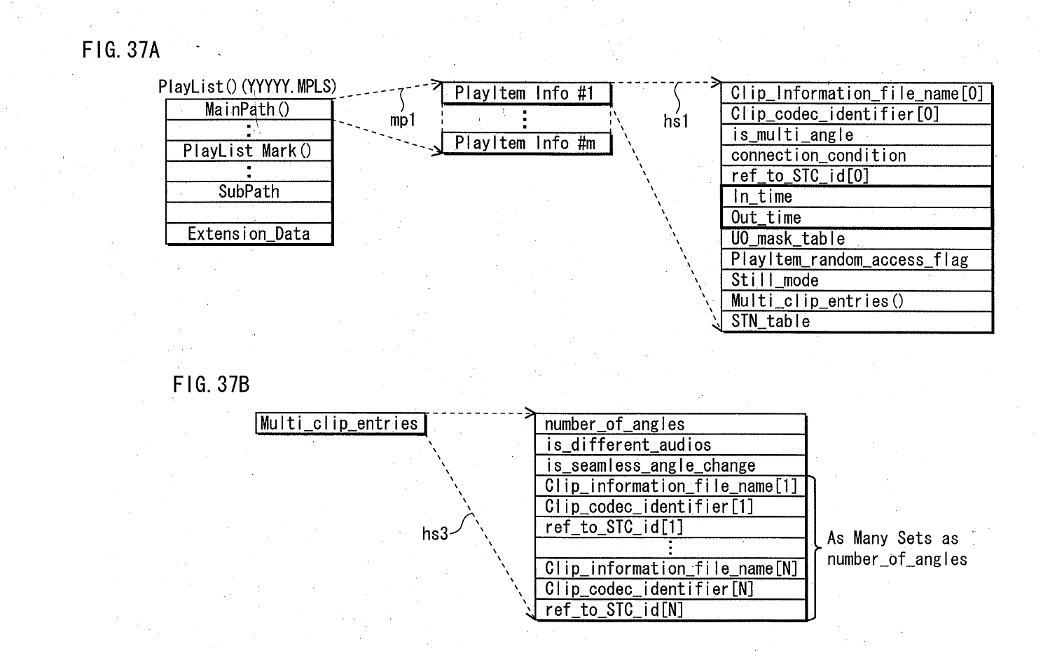

The following describes a file with the extension “mpls” (00002.mpls). This file stores information defining a group made by binding up two types of playback paths called MainPath and Subpath as Playlist (PL). FIG. 37A shows the data structure of the PlayList information. As shown in the figure, the PlayList information includes: MainPath information (MainPath( )) that defines MainPath; PlayListMark information (PlayListMark( )) that defines chapter; Subpath information that defines Subpath; and other extension data (Extension Data).

### <PlayList Information Explanation 1: MainPath Information>

First, the MainPath is described. The MainPath is a playback path defined for the video stream carrying a primary video and for a audio stream.

As indicated by the arrow mp1, the MainPath is defined by a plurality of pieces of PlayItem information: PlayItem information #1 to PlayItem information #m. The PlayItem information defines one or more logical playback sections that constitute the MainPath. The lead line hs1 in the figure indicates a close-up of the structure of the PlayItem information.

As indicated by the lead line hs1, the PlayItem information is composed of: “Clip_Information file_name[0]” that indicates the file name of the playback section information of the AV Clip to which the IN point and the OUT point of the playback section belong; “Clip_codec_identifier[0]” that indicates the AV Clip codec method; “is_multi_angle” that indicates whether or not the PlayItem is multi angle; “connection_condition” that indicates whether or not to seamlessly connect the current PlayItem and the preceding PlayItem; “ref_to_STC_id[0]” that indicates uniquely the STC_Sequence targeted by the PlayItem; “In_time” that is time information indicating the start point of the playback section; “Out_time” that is time information indicating the endpoint of the playback section; “UO_mask_table” that indicates which user operation should be masked in the PlayItem; “PlayItem_random_access_flag” that indicates whether to permit a random access to a mid-point in the PlayItem; “Still_mode” that indicates whether to continue a still display of the last picture after the playback of the PlayItem ends; “Multi_Clip_entries” that indicates a plurality of AV clips in the case were the PlayItem is multi angle, and “STN_table”.

FIG. 37B shows the internal structure of the Multi_Clip_entries. As shown in the figure, the Multi_Clip_entries is composed of: “number_of_angles” that indicates the total number of angles provided in the multi-angle section; and “is_different_audio” that indicates whether or not different audio is played for each angle image; and sets of “Clip_codec_identifier[1]”, Clip_Information_file_name[1]”, and “ref_to_STC_id[1]” to “Clip_codec_identifier[N]”, “Clip_Information_file_name [N] ”, and “ref_to_STC_id[N]”.

Each set of “Clip_codec_identifier”, “Clip_Information_file_name”, and “ref_to_STC_id[0]” contained in the Multi_Clip_entries corresponds to one of the AV Clips containing video of an individual angle of the multi-angle section.

The following describes the PlayListMark information.

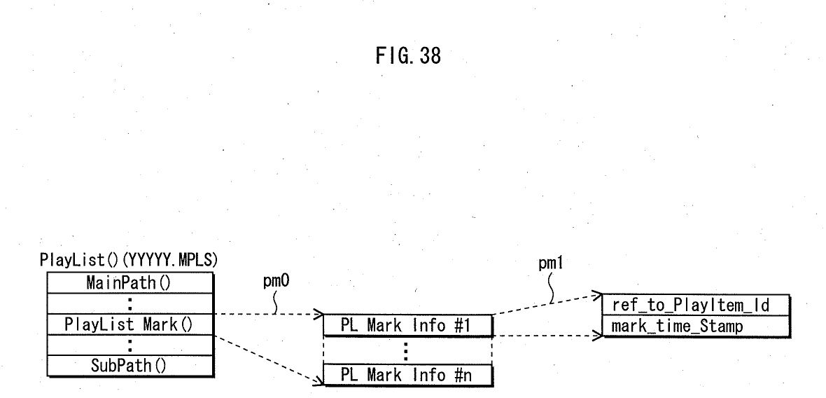

FIG. 38 shows the internal structure of the PlayListMark information contained in the PlayList information. As indicated by leader lines pm0, the PlayListMark information is composed of a plurality of pieces of PLMark information (PLMark #1 to PLMark #n). Each piece of PLMark information (PLMark( )) specifies an arbitrary point on the PL timeline as a chapter point. As indicated by leader lines pm1, the PLMark information is composed of the following fields. “ref_to_PlayItem_id” indicating a PlayItem in which a chapter is to be designated; and “mark_time_stamp” specifying the position of a chapter in the PlayItem using time notation.

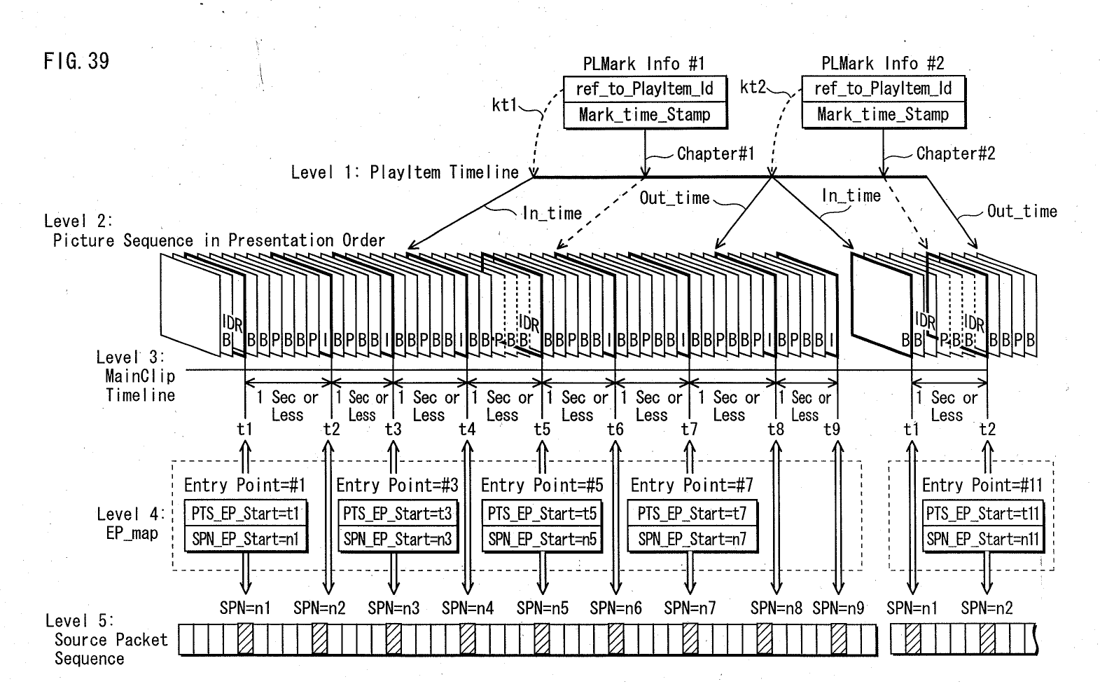

FIG. 39 illustrates the relationship between the AV Clip and the PlayList information. Levels 2-5 indicate the video stream referenced to by EP_map.

The PlayList information includes two pieces of PlayItem information, which are PlayItem Info #1 and PlayItem Info #2. The pairs of In_time and Out_time in the respective pieces of PlayItem Info #1 and #2 define two playback sections. When the two playback sections are aligned, a different timeline from the AV clip timeline is defined. This timeline is the PlayItem timeline illustrated on Level 1. As described herein, by defining PlayItem information, a different playback path from the AV clip timeline is defined.

Level 1 in the figure illustrates the PlayListMark information and the PL timeline. On Level 1, two pieces of PLMark information #1 and #2 are present. Arrows kt1 and kt2 in the figure represent the designation by the ref_to_PlayItem_id. As shown by the arrows, the ref_to_PlayItem_id in the respective pieces of PLMark information designate the respective pieces of PlayItem information. In addition, each Mark_time_stamp indicates a point on the PlayItem timeline to be designated as Chapter #1 and Chapter #2. As described herein, PLMark information defines chapter points on the PlayItem timeline.

### <PlayList Information Explanation 1: SubPath Information>

While the MainPath defines a playback path of the MainClip, which is the primary video, the SubPath defines a playback path of the SubClip that is supposed to be played in synchronization with the MainPath.

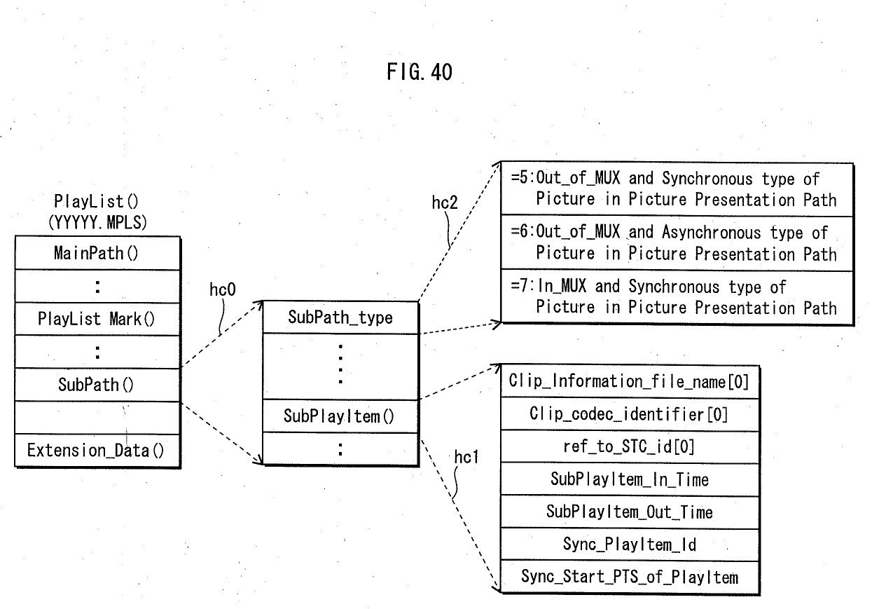

FIG. 40 shows a close-up of the internal structure of the SubPath information. As indicated by arrows hc0 in the figure, each SubPath includes: SubPath_type indicating the type of SubClip; and at least one piece of SubPlayItem information ( . . . SubPlayItem( ) . . . ).

The lead line hc1 in the figure indicates a close-up of the structure of SubPathItem information.

The SubPlayItem defines one or more playback paths of elementary streams separately from the MainPath, and is used to express the type of synchronous playback with the MainPath. In the case where the SubPlayItems uses SubPaths of the primary audio, PG, IG, secondary audio and secondary video, the SubPlayItems with MainPath is synchronized with the MainPath that uses a PlayItem in the PlayList. The elementary streams used by the SubPaths for the elementary stream playback are multiplexed into a SubClip, i.e. a Clip separated from the MainClip used by the PlayItem of the MainPath.

Next is described the internal structure of the SubPlayItem. As indicated by arrow hc1 in the figure, the SubPlayItem information includes:

| “Clip_information_file_name[0]”; | |
|---|---|
| “Clip_codec_identifier[0]”; | “ref_to_STC_id[0]”; |

| | |
|---|---|
| “SubPlayItem_In_time”; | “SubPlayItem_Out_time”; |

“sync_PlayItem_id”; and “sync_start_PTS_of_PlayItem”.

The “Clip_information file_name” is information that uniquely specifies a SubClip corresponding to the SubPlayItem by describing a file name of the Clip information.

The “Clip_codec_identifier” indicates an codec method of the AV Clip.

The “ref_to_STC_id[0]” uniquely indicates an STC_Sequence corresponding to the SubPlayItem.

“The “SubPlayItem_In_time” is information indicating a start point of the SubPlayItem on the playback timeline of the SubClip.

The “SubPlayItem_Out_time” is information indicating an end point of the SubPlayItem on the Playback timeline of the SubClip.

The “sync_PlayItem_id” is information uniquely specifying, from among PlayItems making up the MainPath, a PlayItem with which the SubPlayItem synchronizes. The “SubPlayItem_In_time” is present on the playback timeline of the PlayItem specified with the sync_PlayItem_id.

The “sync_start_PTS_of_PlayItem” indicates, with a time accuracy of 45 KHz, where the start point of the SubPlayItem specified by the SubPlayItem_In_time is present on the playback timeline of the PlayItem specified with the sync_PlayItem_id. In the case where the SubPlayItem defines a playback section on a secondary video stream and the sync_start_PTS_of_PlayItem of the SubPlayItem indicates a time point on the PlayItem timeline, the SubPlayItem realizes “synchronous picture-in-picture” playback.

### <Details of SubPath Information 2: Relationship Among Three Objects>

The three objects used herein refer to the SubClip, the PlayList information, and the MainClip. The SubClip and the PlayList information are both stored on the local storage 202, whereas the MainClip is stored on the BD-ROM.

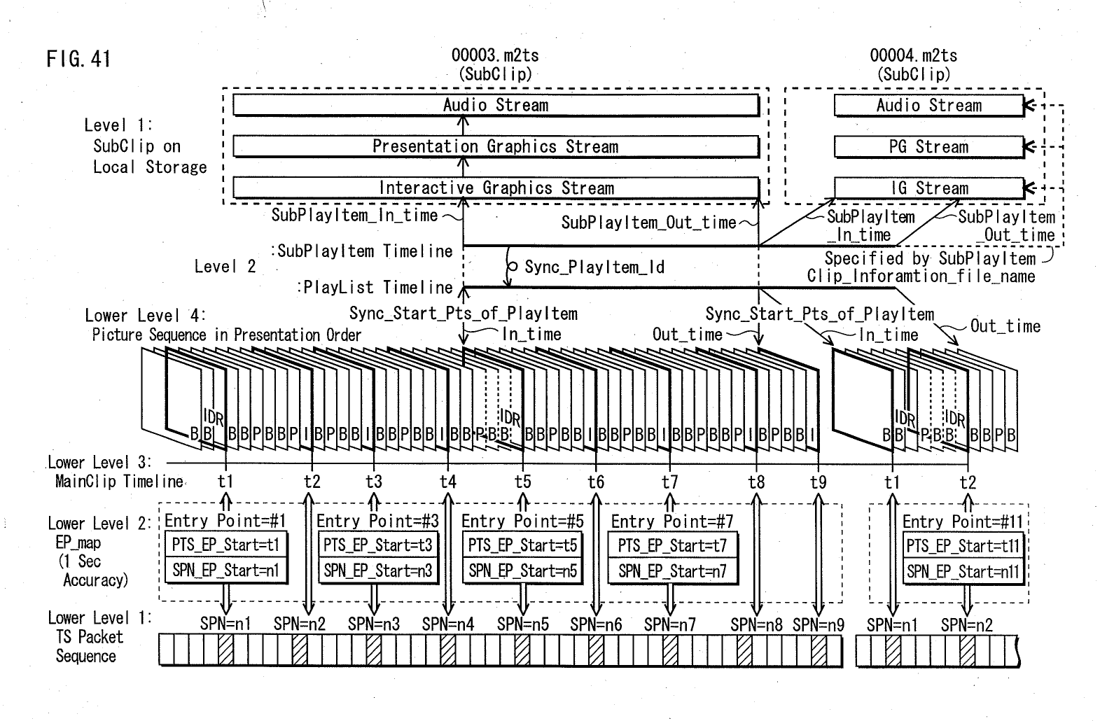

FIG. 41 illustrates the relationship among the SubClip and the PlayList information stored on the local storage 202 and the MainClip stored on the BD-ROM. In the figure, Level 1 illustrates the SubClips stored on the local storage 202. As illustrated, the SubClips stored on the local storage 202 include the secondary video stream, secondary audio stream, PG stream, and IG stream. One of the streams specified as the SubPath is supplied for synchronous playback with the MainClip.

Level 2 illustrates the two timelines defined by the PlayList information. The lower one is the PlayList timeline defined by the PlayItem information and the upper one is the SubPlayItem timeline defined by the SubPlayItem.

As illustrated in the figure, the SubPlayItem_Clip_information_file_name selects a SubClip as a playback section, by specifying one of the Out-of-MUX streams multiplexed in a file with the extension “m2ts” contained in the STREAM directory.

In addition, the SubPlayItem_In_time and the SubPlayItem_Out_time define the start and end points of the playback section of the specified SubClip.

The sync_PlayItem_id represented by an arrow in the figure specifies a PlayItem to be synchronized with the SubClip. The sync_start_PTS_of_PlayItem indicates a point corresponding to the SubPlayItem_In_time on the PlayItem timeline.

Thus concludes the description of the SubPath information.

### <STN_table>

One characterizing feature of the PlayList information on the BD-ROM and the local storage 202 is found in a STN_Table. The following describes PlayList information stored on the local storage 202.

The STN_table shows streams that are available for playback, out of In_MUX streams multiplexed in the AV Clip specified by the Clip_Information_file_name of the PlayItem information and Out_of_MUX streams specified by the Clip_Information_file_name of the SubPlayItem information. To be more specific, the STN_table contains stream_entry of each of the In_MUX streams multiplexed in the MainClip and of Out_of_MUX streams multiplexed in the SubClips and each stream_entry is associated with a corresponding Stream_attribute.

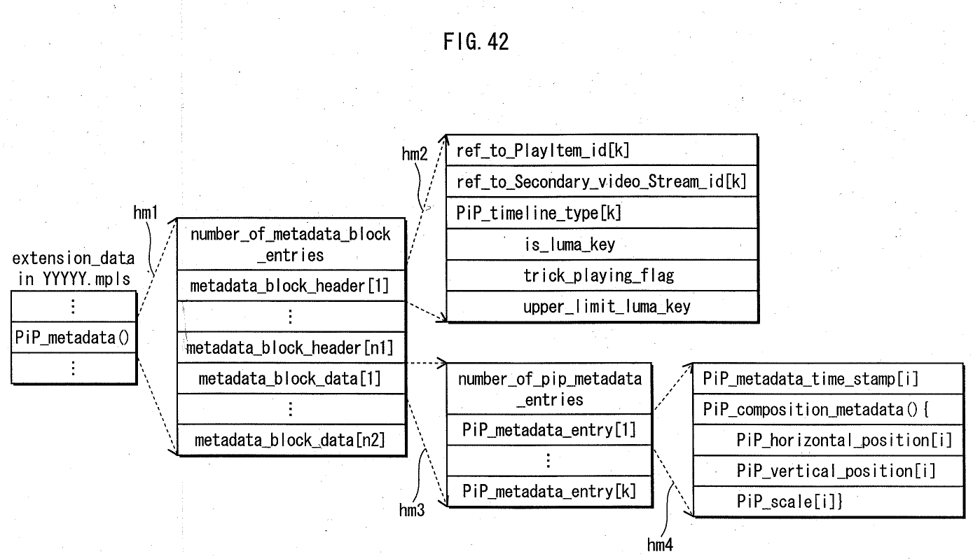

The following describes the internal structure of extension_data. The extension_data stores PiP_metadata that is metadata for picture-in-picture playback. FIG. 42 is a view showing the internal structure of PiP_metadata. The lead lines hm1 indicate a close-up of the internal structure of the PiP_metadata. As shown by the lead lines hm1, the PiP_metadata is composed of number_of_metadata_block_entries, n1 pieces of metadata_block_headers, and n2 pieces of PiP_metadata_blocks.

The lead lines hm2 indicate a close-up of the internal structure of the metadata_block header. That is, the metadata_block_headers are multiple instances created from the same class structure, and each has the identical internal structure as indicated by the lead lines hm2. The following describes each field of the metadata_block_header.

—ref_to_PlayItem_id[k]:

This is a field for indicating a PlayItem_id of PlayItem[k] to be a target of picture-in-picture playback.

—ref_to_secondary_video_stream_id[k]:

This is a field for showing, from among secondary_video_stream_ids defined in the STN_table of the PlayItem referred to by the ref_to_PlayItem_id[k], one identifying a secondary video stream to be supplied for the picture-in-picture playback.

—pip_timeline_type[k]:

This indicates whether picture-in-picture playback is executed using, as the reference point the mapping point of the Sync_Start_PTS_of_PlayItem on the PlayItem timeline or using the origin point of the SubPlayItem_In_time.

As above, the picture-in-picture playback is ideally executed by virtue of the pip_timeline_type [k] that allows the suitable one of the PlayItem and SubPlayItem timelines to be used as the reference.

—is_luma_key:

When this “is_luma_key” flag is set to “1”, luma-keying is applied for a corresponding secondary video stream in accordance with the value held by the upper_limit_luma_key. The luma-keying is a process of, when each picture constituting the secondary video includes a subject and a background, extracting the subject from the picture and providing this for the composition with the primary video.

—trick_playing_flag:

This is a flag showing an intention of the content provider on whether the window for picture-in-picture playback is left open or closed during trick playback of the primary video. This flag is valid only for the synchronous picture-in-picture playback.

—upper_limit_luma_key:

This is a field for specifying the upper limit of the luminance (Y) of a corresponding secondary video for the luma-keying.

The following describes the internal structure of the PiP_metadata_block. The lead lines hm3 indicate a close-up of the structure of PiP_metadata_block. As indicated by the lead lines, the PiP_metadata_block[1] is composed of k pieces of PiP_metadata_entries[1] to [k] and number_of_pipmetadata_entries.

The lead lines hm4 indicate a close-up of the internal structure of a PiP_metadata_entry. That is, the PiP_metadata_entries are multiple instances created from the same class structure, and each has the identical internal structure and is composed of pip_metadata_time_stamp[i] and pip_composition metadata( ).

—pip_metadata_time_stamp[i]:

This is a field for indicating a start point of the time interval during which the pip_composition_metadata( ) is valid.

Except for the last pip_composition metadata( ), the i-th pip_composition_metadata( ) in the k-th PiP_metadata_block[k] is valid during the time interval no less than pip_metadata_time_stamp[i] but no more than pip_metadata_time_stamp[i+1]. The last pip_composition_metadata( ) of the last pip_metadata_time_stamp in the PiP_metadata_block[k]( ) is valid during the time interval no less than the last pip_metadata_time_stamp but no more than display end time of a SubPath specified by the ref_to_secondary_video_stream_id[k]. In addition, the minimal time interval between two successive pip_metadata_time_stamps is one second inclusive.

The pip_composition_metadata( ) is composed of the following fields.

—pip_horizontal_position[i]:

This field indicates the horizontal position of the top-left pixel of the secondary video on the primary video plane. The video_width represents the horizontal width of the video plane. Thus, the horizontal position specified by the PiP_horizontal_position ranges from 0 to video_width-1.

—pip_vertical_postion[i]:

This field indicates the vertical position of the top-left pixel of the secondary video on the primary video plane. The video_height represents the vertical width of the video plane. Thus, the vertical position specified by the PiP_vertical_position ranges from 0 to video_height-1.

—pip_scale[i]:

This is a field for indicating a scaling type of the secondary video. Scaling types are as follows:

0: Preset

1: No Scaling (×1)

2: ½ Scaling (×½)

3: ¼ Scaling (×¼)

4: 1.5× Scaling (×1.5)

5: Full Screen Scaling

This concludes the description of the internal structure of the PlayList information. The PlayList information refers to the AV Clip and Clip information with the above-described internal structure. Thus, when the playPlaylist API is called, whether or not playback of the AV Clip is correctly executed in accordance with the PlayList information is checked. If execution of the playPlaylist is verified, the PlayList information allows various In_MUX streams and Out-of-MUX streams to be played.

This concludes the description of the PlayList information. Note that the SubClip, Clip information, and PlayList information may reside on the local storage in addition to the BD-ROM. In the case where the PlayList information, SubClip, and Clip information reside on the local storage, the PlayList information may define synchronous playback of the Primary Video stream multiplexed in the MainClip recorded on the BD-ROM and the Out-of-MUX stream multiplexed in the SubClip recorded on the local storage. In this way, the stored contents of the BD-ROM and of the local storage are combined to present AV content playback.

The following describes a Movie Object.

### <Movie Object>

A Movie Object is stored in a file “MovieObject.bdmv”. The MovieObject.bdmv contains as many “Movie Objects” as the number indicated by the number_of_mobjs. Each Movie Object is composed of the following fields: “resume_intention_flag” indicating whether playback of the Movie Object is to be resumed after a MenuCall; “menu_call_mask” indicating whether or not to mask the MenuCall; “title_search_flag” indicating whether or not to mask the title search function “number_of_navigation_command” indicating the number of navigation commands; and as many “number_of_navigation_commands” as the number indicated by the number_of_navigation_command.

The navigation command sequence includes commands for setting a conditional branch and setting modification and acquisition of the values held in the status registers of the playback device. The following are examples of the commands that can be described in a Movie Object.

### —PlayPL Command

Format: PlayPL (First Argument, Second Argument)

The first argument specifies the playlist number identifying the PL requested to be played. The second argument specifies the playback start point by indicating a PlayItem, a playback time, a Chapter, or a Mark included in the PL specified by the first argument.

PlayPLatPlayItem( ) is a PlayPL method that specifies, using a PlayItem, a playback point on the PL timeline.

PlayPLatChapter( ) is a PlayPL method that specifies, using a Chapter, a playback point on the PL timeline.

PlayPLatSpecified Time( ) is a PlayPL method that specifies, using time information, a playback point on the PL timeline.

### —JMP Command

Format: JMP Argument

A JMP command causes the device to discard the dynamic scenario currently processed and to branch to a dynamic scenario specified with the argument. The JMP command may contain a direct reference or an indirect reference to a dynamic scenario being a branch target.

A Movie Object contains a navigation command and the description of the navigation command is similar to that of DVD. Thus, the contents of the DVD are transported to the BD-ROM effectively.

<Sound.bdmv>

The following describes the “sound.bdmv” file. The sound.bdmv is a file containing audio data used to output a click sound in response to an operation made on a GUI framework of the Java application (such audio data is referred to as sound data). In order to ensure seamless playback of AV Clip, the sound.bdmv file needs to be preloaded to a buffer during the time the AV Clip is not played. In other words, the sound data contained in the sound.bdmv file needs to be loaded prior to the AV Clip playback. This concludes the description of the sound.bdmv file.

<Index.bdmv>

The Index.bdmv file contains a plurality of Index Table entries and defines for each Title requested to be played, a MovieObject and a BD-J Object being components constituting the Title. Each Index Table entry includes the following data fields: Title_bdjo_file_name and Title_object_type. The Title_bdjo_file_name specifies the name of the BD-J Object file associated with the title. The BD-J Object in turn contains ApplicationManagementTable( ) that specifies the application_id identifying the application to be executed. That is to say, the BD-J Object file specified by the Title_bdjo_file_name instructs the BD-J Terminal to execute the BD-J application to be executed in the title being the branch target.

When set to “10”, the Title_object_type indicates that the title identified by the title_id is associated with the BD-J Object. When set to “01”, the Title_object_type indicates that the title identified by the title_id is associated with a Movie Object. In short, the Title_object_type indicates whether the corresponding title is associated with the BD-J Object or not.

This concludes the description of the BD-ROM 100.

In order to perform a simulation in the IDE environment, a content may be dummy data but the dummy data needs to be adequately similar to an actual BD-ROM content. For this reason, it is preferable that the abstract content is composed of an AV Clip, Clip information, and PlayList information as described above. Yet, it is sufficient to be describe abstract identifiers in the respective fields.

Debugging in the ADK environment is carried out by mounting the file system information residing of the network drive within the PC 100 to the file system information of the BD-ROM to create a virtual package and causing the playback control engine to execute playback. That is, by providing the AV clip, Clip information, and in PlayList information as shown in figure on the hard disk of the debugging device, the BD-J application, although being under development, is duly checked as to whether the BD-J application correctly executes playback the an AV Clip, Clip information, PlayList information.

It is naturally appreciated that an AV content handled by the present invention may be any AV content that is a generalization of the above-described data structure. In other words, the AV content may be any content that enable mixed playback of audio, picture-in-picture playback, a composition display of the subtitles or a menu overlaid on video display, by specifying an In-MUX stream and an Out-of-MUX stream with the use of information defining a logical segment or path such as PlayList information. Examples of such contents naturally include a DVD-Video content and a HD-DVD content.

The following describes the internal structure of the playback engine 205 provided for playback of such an AV content as described above.

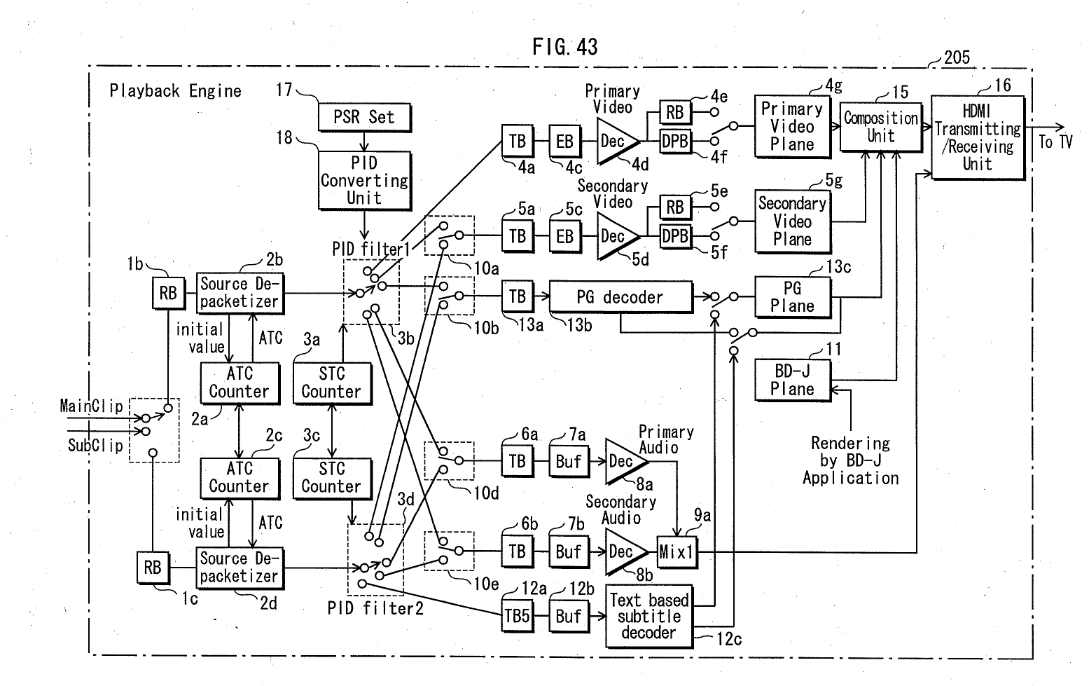

FIG. 43 shows the internal structure of the playback engine 205. As shown in the figure, the playback engine 205 is composed of: read buffers 1b and 1c; an ATC counters 2a and 2c; source depacketizers 2b and 2d; STC counters 3a and 3c; PID filters 3b and 3d; a transport buffer (TB) 4a; an elementary buffer (EB) 4c; a video decoder 4d; a re-order buffer 4e; a decoded picture buffer 4f; a video plane 4g; a transport buffer (TB) 5a; an elementary buffer (EB) 5c; a video decoder 5d; a re-order buffer 5e; a decoded picture buffer 5f; a video plane 5g; transport buffers (TB) 6a and 6b; buffers 7a and 7b; audio decoders 8a and 8b; a mixer 9a; switches 10a, 10b, 10c, 10d and 10e; a BD-J plane 11, a transport buffer (TB) 12a; a buffer 12b; text-based subtitle decoder 12c; a transport buffer (TB) 13a; a presentation graphics decoder 13b; a presentation graphics plane 13c; a composition unit 15, an HDMI transmitting/receiving unit 16, a PSR set 17; and a PID conversion unit 18.

The read buffer (RB) 1b accumulates Source packet sequences read from the BD-ROM.

The read buffer (RB) 1c accumulates Source packet sequences read from the local storage 202.

The ATC counter 2a is reset upon receipt of an ATS of the Source packet located at the beginning of the playback section within Source packets constituting the MainClip, and subsequently outputs ATCs to the source depacketizer 2b.

The source depacketizer 2b extracts TS packets from source packets constituting the MainClip and sends out the TS packets. At the sending, the source depacketizer 2b adjusts the input timing to the decoder according to an ATS of each TS packet. To be more specific, the source depacketizer 2b sequentially transfers the respective Source packets to the PID filter 3b at TS_Recording_Rate, each at the moment when the value of the ATC generated by the ATC counter 2a reaches the ATS value of that specific TS packet.

The ATC counter 2C is reset upon receipt of an ATS of the Source packet located at the beginning of the playback section within Source packets constituting the SubClip, and subsequently outputs ATCs to the source depacketizer 2d.

The source depacketizer 2d extracts TS packets from source packets constituting the SubClip and sends out the TS packets. At the sending, the source depacketizer 2d adjusts the input timing to the decoder according to an ATS of each TS packet. To be more specific, the source depacketizer 2d sequentially transfers the respective TS packets to the PID filter 3d at TS_Recording_Rate, each at the moment when the value of the ATC generated by the ATC counter 2c reaches the ATS value of that specific a Source packet.

The STC counter 3a is reset upon receipt of a PCR of the MainClip and outputs an STC.

The PID filter 3b is a demultiplexer for the MainClip and outputs, among Source packets output from the source depacketizer 2b, ones having PID reference values informed by the PID conversion unit 18 to the video decoders 4d and 5d, the audio decoder 8a, the audio decoder 8a, and the presentation graphics decoder 13b. Each of the decoders receives elementary streams passed through the PID filter 3b and performs from decoding processing to playback processing according to the PCR of the MainClip. That is, the elementary streams input to each decoder after being passed through the PID filter 3b are subjected to decoding and playback based on the PCR of the MainClip.

The STC counter 3c is reset upon receipt of a PCR of the SubClip and outputs an STC. The PID filter 3d performs demultiplexing with reference to this STC.

The PID filter 3d is a demultiplexer for the SubClip and outputs, among Source packets output from the source depacketizer 2d, ones having PID reference values informed by the PID conversion unit 24 to the audio decoder 8b and the presentation graphics decoder 13b. Thus, the elementary streams input to each decoder after being passed through the PID filter 3d are subjected to decoding and playback based on the PCR of the SubClip.

The transport buffer (TB) 4a is a buffer for temporarily storing TS packets carrying the primary video stream output from the PID filter 3b.

The Elementary Buffer (EB) 4c is a buffer for temporarily storing coded pictures (I pictures, B pictures, and P pictures).

The decoder (Dec) 4d acquires multiple frame images by decoding individual pictures constituting the primary video at every predetermined decoding time period (DTS) and writes the frame images to the video plane 4.

The re-order buffer 4e is a buffer for changing the order of decoded pictures from the decoded order to the order for display.

The decoded picture buffer 4e is a buffer for storing uncompressed pictures acquired through the decoding process by the decoder 4d.

The primary video plane 4g is a memory area for storing pixel data for one picture of the primary video. The pixel data is represented by a 16-bit YUV value, and the video plane 4g stores therein pixel data for a resolution of 1920×1080.

The transport buffer (TB) 5a is a buffer for temporarily storing TS packets carrying the secondary video stream output from the PID filter 3b.

The Elementary Buffer (EB) 5c is a buffer for temporarily storing coded pictures (I pictures, B pictures, and P pictures).

The decoder (Dec) 5d acquires multiple frame images by decoding individual pictures constituting the secondary video at every predetermined decoding time period (DTS) and writes the frame images to the Secondary video plane 5g.

The re-order buffer 5e is a buffer for changing the order of decoded pictures from the decoded order to the order for display.

The decoded picture buffer 5f is a buffer for storing uncompressed pictures acquired through the decoding process by the decoder 5d.

The secondary video plane 5g is a memory area for storing pixel data for one picture of the secondary video.

The transport buffer (TB) 6a is a buffer for temporarily storing TS packets carrying the primary audio stream output from the PID filter 3b and for supplying the TS packets to the audio decoder 8a in the in a first-in first-out manner.

The transport buffer (TB) 6b is a buffer for temporarily storing TS packets carrying the secondary audio stream output from the PID filter 3b and for supplying the TS packets to the audio decoder 8b in the in a first-in first-out manner.

The audio decoder 8a converts TS packets stored in the transport buffer (TB) 6a into PES packets, decodes the PES packets to acquire uncompressed LPCM audio data, and outputs the acquired audio data. This achieves a digital output of the primary audio stream.

The audio decoder 8b converts TS packets stored in the transport buffer (TB) 6b into PES packets, decodes the PES packets to acquire uncompressed LPCM audio data, and outputs the acquired audio data. This achieves a digital output of the secondary audio stream.

The mixer 9a performs a mixing of the LPCM digital audio output from the audio decoder 8a with the LPCM digital audio output from the audio decoder 8b.

The switch 10a is used to selectively supply TS packets read from the BD-ROM or from the local storage 202 to the secondary video decoder 5d.

The switch 10b is used to selectively supply TS packets read from the BD-ROM or from the local storage 202 to the presentation graphics decoder 13b.

The switch 10d is used to selectively supply, to the audio decoder 8a, either TS packets carrying the primary audio stream demultiplexed by the PID filter 3b or TS packets carrying the primary audio stream demultiplexed by the PID filter 3d.

The switch 10e is used to selectively supply, to the audio decoder 8b, either TS packets carrying the secondary audio stream demultiplexed by the PID filter 3b or TS packets of the secondary audio stream demultiplexed by the PID filter 3d.

The BD-J plane 11 is a plane memory used by the BD-J application for rendering GUI.

The transport buffer (TB) 12a is a buffer for temporarily storing TS packets carrying a textST stream.

The buffer (TB) 12b is a buffer for temporarily storing PES packets carrying a textST stream.

The text-based subtitle decoder 12c expands the subtitles expressed with character code in the textST stream read from the BD-ROM or the local storage 202 into bitmap data and writes the resulting bitmap data to the presentation graphics plane 13c. This expansion process is carried out using the font data stored on the BD-ROM 100 or the local storage 202. Thus, it is required to read the font data in advance of the textST stream decoding.

The transport buffer (TB) 13a is a buffer for temporarily storing TS packets carrying a PG stream.

The presentation graphics (PG) decoder 13b decodes a PG stream read from the BD-ROM or the local storage 202 and writes the uncompressed graphics to the presentation graphics plane 13c. Through the decoding by the PG decoder 13b, the subtitles appear on the screen.

The presentation graphics (PG) plane 13c is a memory having an area of one screen, and stores one screen of uncompressed graphics.

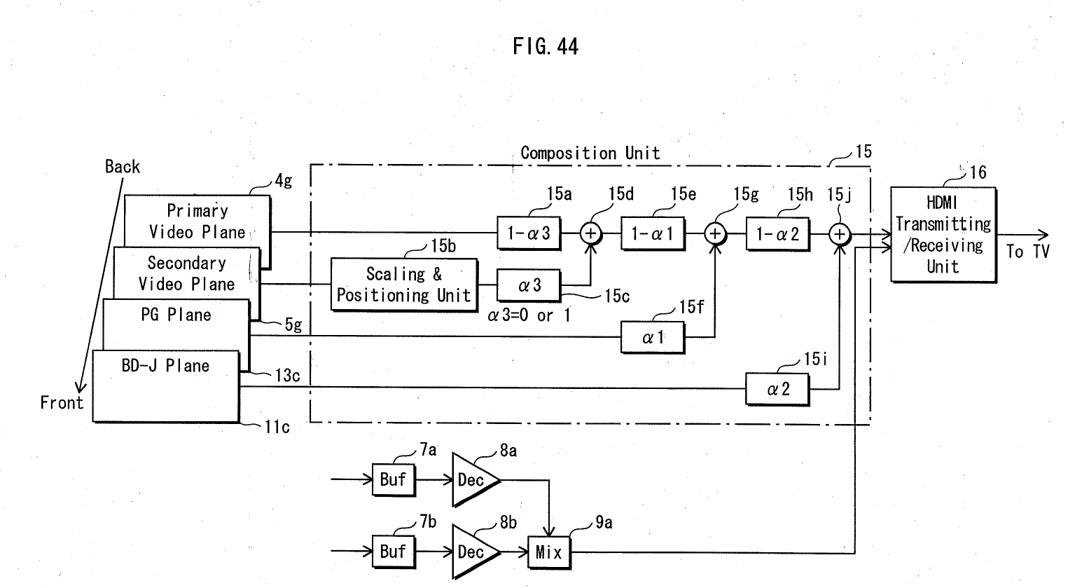

The composition unit 15 overlays the data presented on the primary video plane 4g, the secondary video plane 5g, the BD-J plane 11, and the presentation graphics plane 13c to produce a composite output. The composition unit 15 has the internal structure as shown in FIG. 44. FIG. 44 is a view showing the internal structure of the composition unit 15. As shown in the figure, the composition unit 15 is composed of: a 1-α3 multiplication unit 15a; a scaling and positioning unit 15b; an α3 multiplication unit 15c; an addition unit 15d; a 1-α1 multiplication unit 15e; an α1 multiplication unit 15f; an addition unit 15g; a 1-α2 multiplication unit 15h; an α2 multiplication unit 15i; and an addition unit 15j.

The 1-α3 multiplication unit 15a multiplies the luminance of pixels constituting an uncompressed digital picture stored in the video decoder 4g by a transmittance of 1-α3.

The scaling and positioning unit 15b enlarges or minimizes (i.e. scaling) an uncompressed digital picture stored on the video plane 5g, and changes the display position (i.e. positioning). The enlargement and minimization are performed based on PiP_scale of the metadata and the change of the position is performed based on PiP_horizontal_position and PiP_vertical_position.

The α3 multiplication, unit 15c multiplies, by a transmittance of α3, the luminance of pixels constituting the uncompressed picture on which scaling and positioning have been performed by the scaling and positioning unit 15b.

The addition unit 15d combines the uncompressed digital picture created by the α3 multiplication unit 15c multiplying the luminance of each pixel by a transmittance of α3 and the uncompressed digital picture created by the 1-α3 multiplication unit 15a multiplying the luminance of each pixel by a transmittance of 1-α3, to thereby acquire a composite picture.

The 1-α1 multiplication unit 15e multiplies, by a transmittance of 1-α1, the luminance of pixels constituting the composite digital picture created by the addition unit 15d.

The α1 multiplication unit 15f multiplies, by a transmittance of α1, the luminance of pixels constituting compressed graphics stored in the presentation graphics decoder 13c.

The addition unit 15g combines the uncompressed digital picture created by the 1-α1 multiplication unit 15e multiplying the luminance of each pixel by a transmittance of 1-α1 and the uncompressed graphics created by the α1 multiplication unit 15f multiplying the luminance of each pixel by a transmittance of α1, to thereby acquire a composite picture.

The 1-α2 multiplication unit 15h multiplies, by a transmittance of 1-α2, the luminance of pixels constituting the digital picture created by the addition unit 15g.

The α2 multiplication unit 15i multiplies, by a transmittance of α2, the luminance of pixels constituting uncompressed graphics stored in the interactive graphics decoder 13c.

The addition unit 15j combines the uncompressed digital picture created by the 1-α2 multiplication unit 15h multiplying the luminance of each pixel by a transmittance of 1-α2 and the uncompressed graphics created by the α2 multiplication unit 15i multiplying the luminance of each pixel by a transmittance of α2, thereby to acquire a composite picture.

As described above, the composition unit 15 is provided with a plurality of addition units. Thus, the data rendered by the BD-J application is overlaid with the playback of the video stream. That is to say, in the ADK environment, the user is allowed to check how the playback video of the AV Clip is overlaid with the data rendered by the BD-J application under development.

The HDMI transmitting and receiving unit 16 receives, from another device connected via an HDMI (High Definition Multimedia Interface), information regarding the device, and transmits, to the device connected via the HDMI, digital uncompressed video acquired by the composition of the addition unit 15j together with audio data combined by the mixer 9a.

The PSR set 17 is a set of registers provided within the playback device. The set of registers include 64 BD-ROM player setting/status registers (PSRs) and 4,096 general-purpose registers (GPRs). Among the Player Setting/Status Registers, the values (PSR) set in PSR4 to PSR8 are used to represent the current playback point. The detailed explanation of the 64 BD-ROM player setting/status registers (PSRs) are as follows:

PSR 1: Stores a vale indicating the stream number identifying the currently selected primary audio stream.

PSR 3: Stores a value indicating the angle number identifying the currently selected angle.

PSR 4: Stores the current title number.

PSR 5: Stores the current chapter number.

PSR 6: Stores the current playlist number.

PSR 7: Stores the current PlayItem number.

PSR 8: Stores the current PTM (Presentation Time).

PSR 13: Stores the value indicating parental lock.

PSR 14: Stores the stream number of the secondary audio stream and the stream number of the secondary video stream.

PSR 15: Stores the value indicating the audio playback capability.

PSR 16: Stores the value indicating the language setting of audio playback.

PSR 19: Stores the country code.

PSR 20: Stores the region code.

PSR 29: Stores the value indicating the video playback capability.

PSR 31: Stores the profile/version number.

The PID conversion unit 18 converts the stream numbers stored in the PSR set 17 into PID reference values based on the STN_table, and passes the PID reference values acquired through the conversion to the PID filters 3b and 3d.

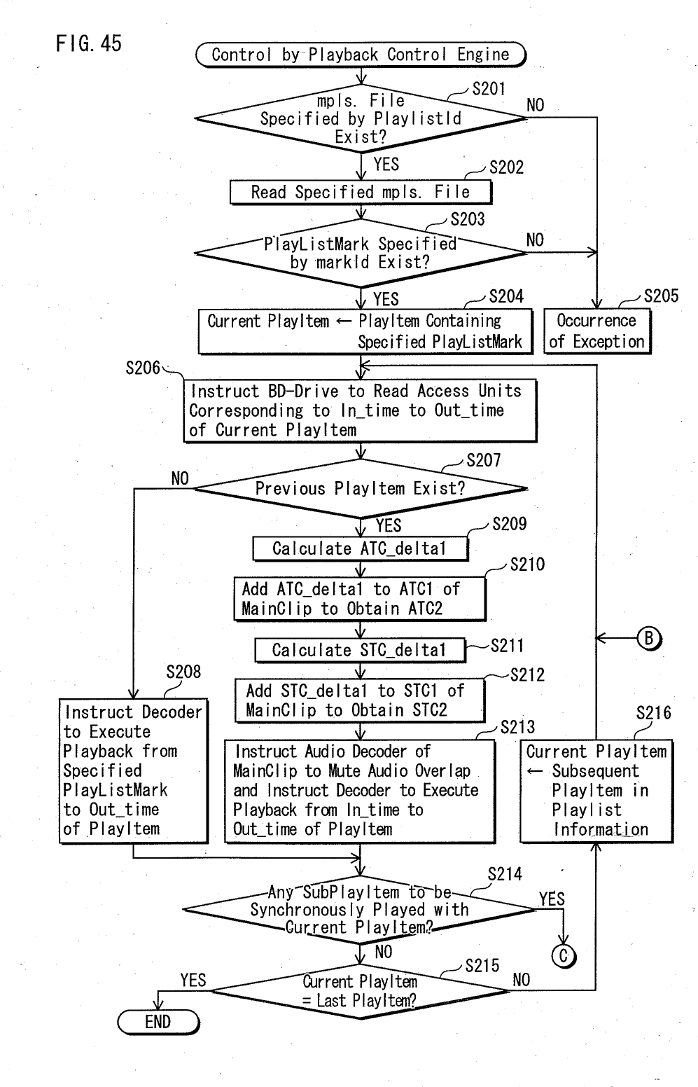

This concludes the description of the internal structure of the playback engine 205. Next is described the internal structure of the playback control engine 206. The playback control engine 206 executes playback of an AV Clip in accordance with the PlayList information. FIG. 45 is a flowchart of the processing steps of the playback control engine 206. The processing steps shown in the flowchart are executed when the method playPlaylist is called. The playback engine 205 judges whether or not an mpls file identified by the argument “PlaylistId” of the playPlaylist exists (Step S201). If such a file exists, the playback engine 205 reads the .mpls file (Step S202) and then judges whether or not a PlayListMark identified by the argument “markId” exists (Step S203).

If such a PlayListMark exists, out of a plurality of pieces of PlayItem information included in the PlayList information, one that contains the identified PlayListMark is designated as the current PlayItem (Step S204).

Steps S206-S216 form a loop that repeats a sequence of processing steps on each PlayItem included in the PlayList information. The loop ends when the condition in Step S215 is satisfied. In the loop, first, the playback control engine 206 instructs the BD-ROM drive to read Access Units corresponding to In_Time to Out_Time of the current PlayItem (Step S206), judges whether a previous PlayItem is present in the current PlayItem (Step S207), and selectively executes Step S208 or Steps S209-S213 according to the judgment result. To be more specific, if the current PlayItem does not have a previous PlayItem (Step S207: No), the playback control engine 206 instructs the decoder to execute playback from the PlayListMark specified by the markId to the PlayItem_Out_Time (Step S208).

If the current PlayItem has the previous PlayItem (Step S207: Yes), the playback control engine 206 calculates an offset value called “ATC_delta1”, which is an offset of the MainClip (step S209) and then adds the ATC_delta1 to an ATC value (ATC1) of the original ATC_Sequence to calculate an ATC value (ATC2) for a new ATC_Sequence (Step S210).

When the previous PlayItem is present as above, an STC_Sequence in the MainClip is switched. For the switching of the STC_Sequence, the playback control engine 206 calculates an offset value called “STC_deltal” (Step S211), and then adds the STC_deltal to an STC value (STC1) of the original STC_Sequence to calculate an STC value (STC2) for a new STC_Sequence (Step S212).

The playback control engine 206 instructs the audio decoder 9 to mute the Audio Overlap, and then instructs the decoder to execute playback of the PlayItem_In_Time to the PlayItem_Out_Time (Step S213).

Subsequently to either Step S208 or Steps S209-S213, Step S214 is executed.

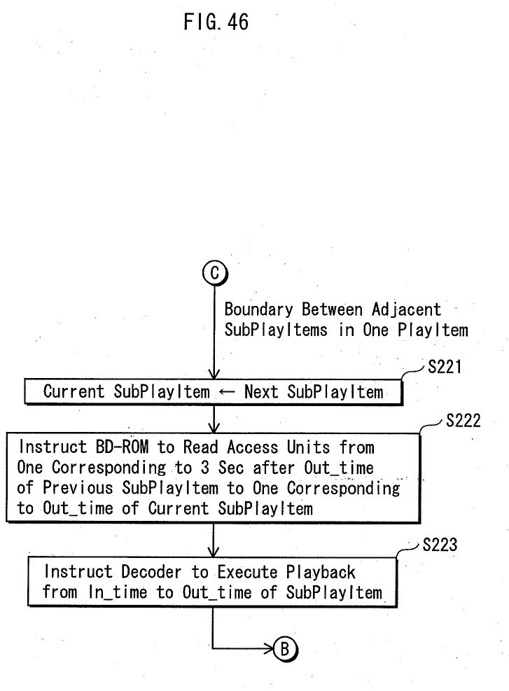

In Step S214, it is judged whether there is a SubPlayItem being played synchronously with the current PlayItem and whether the current playback point (current PTM (Presentation Time)) has reached a boundary between the current SubPlayItem and the next SubPlayItem. If Step S214 results in Yes, the playback control engine 206 executes the processing steps of the flowchart in FIG. 46.

In Step S215, it is judged whether the current PlayItem is the last PlayItem of the PlayList information. If the current PlayItem is not the last PlayItem, the next PlayItem in the PlayList information is designated as the current PlayItem (Step S216) and the processing moves onto Step S206. Through the above processing, Steps S206-S215 are repeated on all the PlayItems of the PlayList information.

FIG. 46 is a flowchart of the processing steps for executing playback in accordance with the SubPlayItem information in the PlayList information.

In Steps S221-S223, the playback is switched between two consecutive SubPlayItems in one PlayItem, and the playback control engine 206 designates the latter one of the SubPlayItems as the current SubPlayItem (Step S221).

The playback control engine 206 then instructs the local storage 202 to read Access Units corresponding to the In_Time to the Out_Time of the current SubPlayItem (Step S222), and instructs the decoder to execute playback of the current SubPlayItem_In_Time to the current SubPlayItem_Out_Time (Step S223). This concludes the description of the playback control engine.

The following describes the description of the BD-J application in relation to the playback control engine.

Since the PSRs are set in a manner described above, the BD-J application executes the following processes.

1) Selecting a primary audio stream in accordance with the audio playback capability indicated by the value of PSR 15 and also with the language setting indicated by the value of the PSR 16 and writing the stream number indicating the thus selected primary audio stream to the PSR 1.

2) Selecting of a secondary audio stream in accordance with the audio playback capability indicated by the value of PSR 15 and also with the language setting indicated by the value of the PSR 16 and writing the stream number indicating the thus selected secondary audio stream to the PSR 14.

3) Selecting of a secondary video stream in accordance with the video playback capability indicated by the value of PSR 29 and writing the stream number indicating the thus selected secondary video stream to the PSR 14.

4) Determining the angle number in accordance with a user operation and executing playback of one of a plurality of AV Clips indicated by the multi_clip_entry that is contained in the PlayItem information.

5) Executing playback a playlist selected in accordance with the parental lock setting indicated by the value of PSR 13.

Thus, during debugging with ECLIPSE, those PSR values are read and written via the serial port. Through an integration test in accordance with detailed configuration of the BD-ROM content and the respective PSR values, the BD-J application is debugged at the concrete level.

The following describes the API specifications for debugging of the BD-J application in a unit test or integration test in the case where the AV content and the playback engine have the above-described configuration. In general, a Java application is debugged with a debugging tool provided in ECLIPSE, for example. ECLIPSE enables debugging of a Java™ application running on “Windows™”, which is a versatile operating system created by Microsoft Corp.

An API for the BD-J application includes a package called “org.bluray.media” defining an extended portion unique to the BD-J and pertains to GEM for media control. The org.bluray.media defines EventListeners including the following.

AngleChangeListener is an interface for handling an angle change event. An angle change event is generated upon switching between multiple angle videos in accordance with Multi_clip_entries in the PlayList information and used to inform the angle number newly selected for playback.

PanningChangeListener is implemented on the application in order to receive a change in panning control.

PiPStatusListener is an interface for handling a PiP status event that occurs in relation to the playlist being played. The PiP status event is an event indicating the change in the coordinates and size of the secondary video upon execution of picture-in-picture playback in accordance with an PiP_meta_block_entry included in the PlayList information.

PlaybackListener is an interface implemented on the application to receive an event indicating the playback state change. The state changes notified to the PlaybackListener includes MarkReached and PlayItemReached. MarkReached is an event indicating that the current point indicated by the PSR value has reached the PlayListMark. PlayItemReached is an event indicating that the current point has reached the boundary between PlayItems.

UOMaskTableListener is an interface implemented to receive an event that is generated when a change is made to a UOMaskTable set for each piece of PlayItem information.

Since these events are not defined in ECLIPSE, debugging with ECLIPSE is not applicable to operations performed in response to these events.

For this reason, when the playback control engine is called by the BD-J application in a unit test, the playback control engine stub 126 included in the debugging device generates an event in response to EventListeners described above to ensure that the EventListener in the BD-J application duly receives appropriate events.

In an integration test, when the playback control engine is called by the BD-J application and the playback control engine outputs such an event described above to the EventListener, the event is used as an argument to call the standard output function. As a result, the playback device transmits the event to the log server terminal. In this way, the event name and the detailed parameters at the time when the event is received is stored as the execution log to the log server terminal.

As described above, according to the present embodiment, an operation test is suitably performed to check whether or not the BD-J application duly executes rendering, stream selection, and picture-in-picture playback in accordance with the specific description of the AV Clip, Clip information, and PlayList information.

According to the present embodiment, in addition, a portion specific to the BD-J application is debugged, which is not feasible with a general-purpose Java application debugging tool. Thus, the present embodiment helps to expedite the BD-J application development.

### Embodiment 7

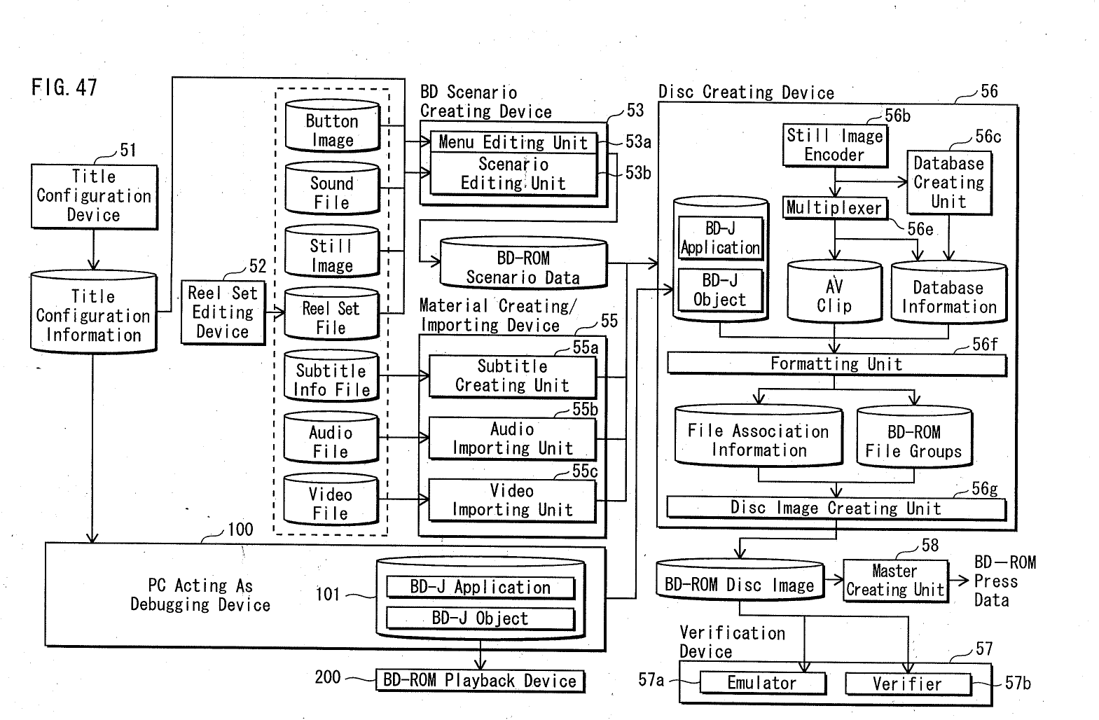

Embodiment 7 of the present invention relates to how to create such an AV content as shown in the previous embodiment. Creation of such an AV content is carried out using a dedicated system called a “authoring system”. The authoring system is established in a production studio and made available for the users. FIG. 47 is a view showing the internal structure of the authoring system according to the present embodiment and also the position of the debugging device in the authoring system. The following describes the authoring system with reference to FIG. 47.

As shown in the figure, the authoring system is configured by connecting the following devices to one another via an internal network: a title configuration creating device 51; a reel set editing device 52; a BD scenario generating device 53; a material creating/importing device 55; a disk creating device 56; a verification device 57; and a master creating unit 58.

### 1) Title Configuration Creating Device 51

The title configuration creating device 51 determines the contents that make up each title to be recorded on the BD-ROM. The determination by the title configuration creating device 51 is made by creating title configuration information.

### 2) Reel Set Editing Device 52

The reel set editing device 52 determines the relationship among multiple elementary streams constituting one complete movie, such as streams carrying video, audio, subtitles and animated buttons. For example, when a single movie is composed of one video stream, two audio streams, three subtitle streams and one button animation stream, the reel set editing device 52 specifies that these elementary streams together constitute one movie, and have functions to assign, to the main movie, a director's cut having partially different images and to arrange multi-angle scenes having multiple angles.

### 3) BD Scenario Generating Device 53

The BD scenario generating device 53 is composed of a menu editing unit 53a and a scenario editing unit 53b.

(Menu Editing Unit 53a)

The menu editing unit 53a positions buttons in a menu and creates a command to be associated with a button, and a button animation function, according to user operations received via GUI.

(Scenario Editing Unit 53b)

The scenario editing unit 53b edits the title configuration information created by the title configuration creating device 51, in accordance with the user operations received via GUI to create a scenario and outputs the scenario. The scenario refers to information that causes the playback device to execute playback in a unit of title. On the BD-ROM, information defined as the IndexTable, MovieObject and PlayList corresponds to scenario. The BD-ROM scenario data includes material information constituting streams, playback path information, menu screen layout, and transition information from the menu. The user continues scenario editing operations until all of these pieces of information are verified. In the scenario editing operations, the scenario editing unit 53b sets the contents of the PlayLists of the title configuration information.

### 4) Material Creating/Importing Device 55

The material creating/importing device 55 is composed of a subtitle creating unit 55a, an audio importing unit 55b, and a video importing unit 55c. The material creating/importing device 55 converts input video materials, audio materials, subtitle materials, Java™ program source codes and the like into format compliant with the BD-ROM standard, and sends the converted data to the disk creating device 56.

(Subtitle Creating Unit 55a)

The subtitle creating unit 55a creates and outputs a presentation graphics stream in a format compliant with the BD-ROM standard based on a subtitle information file including data for implementing subtitles, display timing, and subtitle effects such as fade-in/fade-out.

(Audio Importing Unit 55b)

Upon receipt of audio data already compressed into the AC-3 format, the audio importing unit 55b adds timing information for a corresponding video and/or deletes unnecessary data to/from the audio data and outputs the resulting data. Upon receipt of uncompressed audio data, the audio importing unit 55b converts the audio data into a format specified by the user and outputs the resulting data.

(Video Importing Unit 55c)

Upon receipt of a video stream already compressed into the MPEG2, MPEG4-AVC, or the VC-1 format, the video importing unit 55c deletes unnecessary information as necessary. Upon receipt of an uncompressed video stream, the video importing unit 55c compresses the video stream according to parameters specified by the user, and outputs the thus compressed video stream.

### 6) Disk Creating Device 56

The disk creating device 56 is composed of a still image encoder 56b, a database generating unit 56c, a multiplexer 56e, a formatting unit 56f and a disk image treating unit 56g.

(Still Image Encoder 56b)

The still image encoder 56b in the case when input BD-ROM scenario data includes still images or the storage location of still images, selects an appropriate still image from among the input still images, and converts the selected still image into one of the MPEG2, MPEG4-AVC, and VC1 formats compliant with the BD-ROM standard.

(DataBase Generating Unit 56c)

The database generating unit 56c generates a database of scenario data compliant with the BD-ROM standard, based on the input BD-ROM scenario data. Here, the term “database” is a collective term for Index.bdmv, Movie objects, PlayLists and BD-J objects defined in the above-mentioned BD-ROM.

(Multiplexer 56e)

The multiplexer 56e multiplexes multiple elementary streams carrying video, audio, subtitles and menus described in the BD-ROM scenario data into an MPEG2-TS digital stream called an AV Clip. Additionally, the multiplexer 56e outputs the AV Clip together with Clip information which has information related to the AV Clip.

In particular, the multiplexer 56e detects which of the TS packets of the AV clip includes the first I picture and the first IDR picture and associates the detection results with relevant data to generate an EP_map. The multiplexer 56e then creates Clip information by pairing the thus generated EP_map and the attribute information indicating audio and video attributes of each stream.

(Formatting Unit 56f)

The formatting unit 56f receives the database described above, the AV clip, and the BD-J application created by the PC 100 and performs a file allocation process into a data structure compliant with the BD-ROM format. To be more specific, the formatting unit 56f creates a directory structure specifying the application layer of the BD-ROM, and appropriately allocates each file. At this point, the formatting unit 56f associates the BD-J application with the AV Clips. The formatting unit 56f manipulates the above-described directory structure in accordance with interactions by the user to complete the association of the files.

(Disk Image Creating Unit 56g)

The disk image creating unit 56g receives the above-mentioned database and AV Clips and allocates these to addresses appropriate for the BD-ROM format to acquire a volume image.

### 6) Verification Device 57

The verification device 57 is composed of an emulator unit 57a and a verifier unit 57b.

The emulator unit 57a receives the above-described volume image and plays actual movie contents to check, for example, whether operations intended by the producer, such as transition from a menu to the main movie, are properly conducted, whether subtitle and audio switching operates as intended, and whether videos and audios have intended qualities.

(Verifier Unit 57b)

The verifier unit 57b verifies whether the data produced using the above-mentioned volume image complies with the BD-ROM standard.

In order to realize picture-in-picture playback of Out_of_MUX streams, the total bit rate of TS packets in multiple elementary streams which are permitted, in the STN_table, to be played simultaneously must be limited to 48 M bits/second or less. In order to check whether the limitation is met, the verifier unit 57b determines if the bit amount in a discretional period of one second on the ATC timeline is at or less than the limitation. The unit time of one second is called “Window”, and can be set at any point on the ATC timeline. That is to say, the bit amount of the decoded elementary streams during any period of one second must be 48M bits or less.

At authoring time, the verifier unit 57b checks whether the bit amount of a TS packet over the period of one second is 48M bits or less while keeping the window shifting on the Source packet sequence by one packet each time. When the limitation is satisfied, the verifier unit 57b shifts the Window to the next TS packet. If the limitation is not satisfied, the verifier unit 57b determines that it violates the BD-ROM standard. When the Out_Time of the Window reaches the last source packet as a result of the repetition of such shifts, the verifier unit 57b determines that the source packets conform to the BD-ROM standard.

As described above, the volume images are verified by the emulator unit 57a and verifier unit 57b. If any error is detected, an appropriate one of the previous processes are performed again to redo the operation. After these two verification processes, the volume image is supplied to the master creation unit 58 that completes creation of data for BD-ROM press. In turn, the data for BD-ROM press is subjected to a pressing process for disk production.

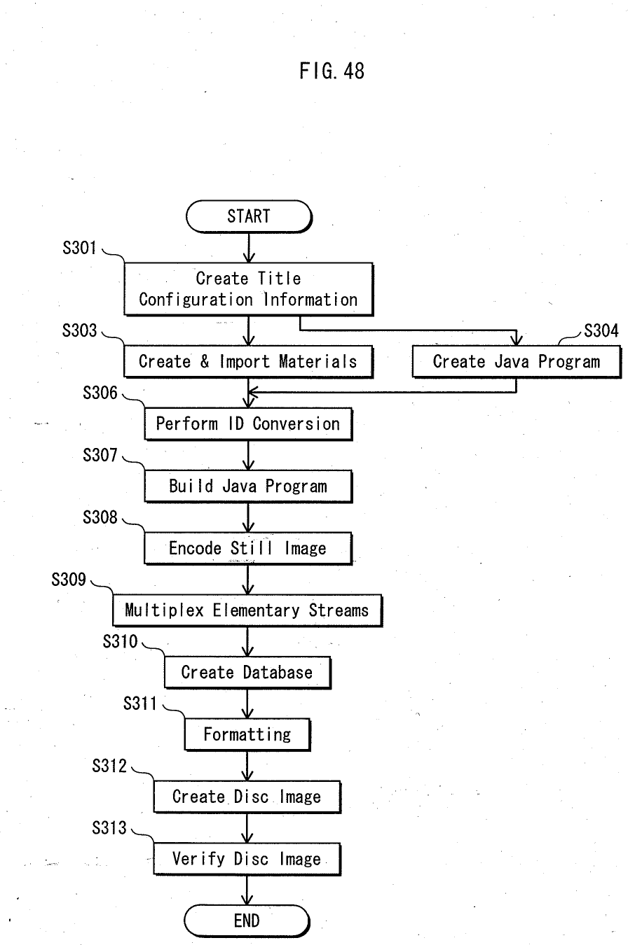

Next, processing steps of the formatting process are described with reference to FIG. 48.

In Step S301, the user sets a title configuration of the BD-ROM using the title configuration creating device 51. As a result, the title configuration information is created.

In Step S303, the user prepares video, audio, still images and subtitle information used for a title, and subsequently imports the prepared data and information into the disk creating device 56 using the material creating/importing device 55.

In Step S304, the user creates Java™ program source code, program ancillary information, and ID class source code for a Java™ title, using the ID class creating unit 111 and the Java™ programming device 112.

In Step S305, the user imports, into the disk creating device 56, the Java™ program source code and the ID class source code created in Step S4, using the Java™ importing unit 114.

In Step S306, the ID converting unit 115 converts the ID class source code and the description of the BD-J object creation information into corresponding title numbers and PlayList numbers on the actual disk.

In Step S307, the Java™ program building unit 116 complies the source code output in Step S306 into a Java™ program. Note that Steps S306 and S307 may be skipped if the title configuration information does not include a Java™ title.

In Step S308, the still image encoder 56b, in the case when the BD-ROM scenario data includes still images or the storage location of still images, converts an appropriate still images into one of the MPEG2, MPEG4-AVC and VC1 formats compliant with the BD-ROM standard.

In Step S309, the multiplexer 56e multiplexes multiple elementary streams based on the BD-ROM scenario data and creates an AV Clip in the MPEG2-TS format.

In Step S310, the database generating unit 56c creates database information compliant with the BD-ROM standard based on the BD-ROM scenario data.

In Step S311, the formatting unit 56f receives the Java™ programs created in Step S307, the AV Clip created in Step S309 and the database created in Step S310 and performs file allocation compliant with the BD-ROM standard. At this point, the formatting unit 56f associates the Java™ programs with the AV Clip to create file association information.

In Step S312, the disk image creating unit 56g creates a volume image appropriate for the BD-ROM format using the files created in Step S311 with reference to the file association information.

In Step S313, the verification device 57 verifies the disk image created in Step S312. If any error is detected, an appropriate one of the previous steps is repeated again to redo the required processing.

With the authoring system described above, the debugging device creates a BD-J application from Java™ program source code prior to conversion by the formatting unit 56f and conducts operation tests on the BD-J application in the IDE environment as well in the ADK environment. This leads to reduce the overall number of the processing steps that needs to be redone.

### Embodiment 8

Embodiment 8 of the present invention discloses the detailed structure of a JAR archive file.

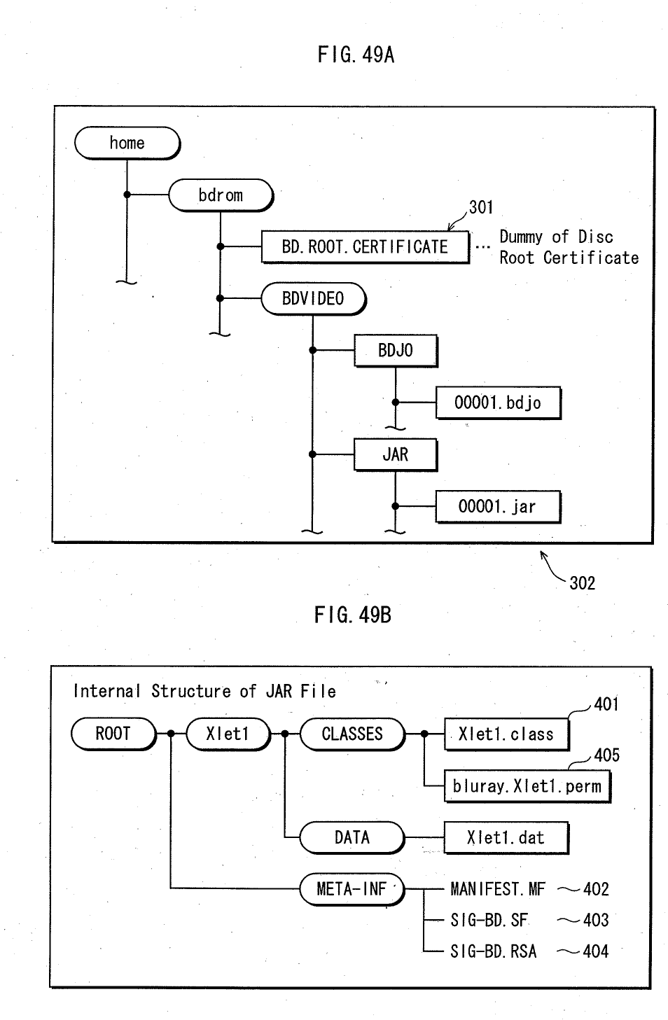

FIG. 49A shows the file directory structure of the network drive. The network drive has a ROOT directory, and a bdrom directory immediately below the ROOT directory, and BDVIDEO directory immediately below the bdrom directory. The BDVIDEO directory stores files of the following two types.

### (A) BD.ROOT.CERTIFICATE: Disc Root Certificate 301

The BD.ROOT.CERTIFICATE directory stores dummy of a disc root certificate. The disc root certificate is issued by a root certificate authority at a request of the BD-ROM creator and assigned to the disc medium. The disc root certificate is coded in the X.509 format, for example. The specifications of the X.509 format are issued by ITU-T (International Telecommunications Union—Telecommunication) and described in CCITT Recommendation X.509, “The Directory—Authentication Framework, CCITT” (1988). The BD.ROOT.CERTIFICATE directory stores dummy of the disc root certificate.

### (B) 0001.JAR Archive File: Java™ Archive File 302

The Java™ archive file 302 stores a plurality of files in a file and directory structure as shown in FIG. 49B. FIG. 49B is a view showing the internal structure of the Java™ archive file 302.

The JAR archive file has a hierarchal directory structure that the Root directly has an Xlet1 directory and a META-INF directory. The Xlet1 directory has a CLASSES directory storing class files and a DATA directory storing data files.

The file (Xlet1.class) contained in the CLASSES directory and the file (Xlet1.dat) contained in the DATA directory are loaded by a class loader to the heap area of the virtual machine to create a BD-J application.

(i) Xlet1.class: Class File 401

The class file 401 contains a data structure defining a Java™ application that is executable on a virtual machine.

### (ii) MANIFEST.MF: Manifest File 402

The manifest file 402 is provided in correspondence with a digital certificate. The manifest file 402 contains the attributes of the Java™ archive file 302 and the hash values of the class files 401 and data files contained in the Java™ archive file 302. The attributes of the Java™ archive file 302 include an application ID assigned to a Java™ application, which is an instance of the class files 401, and the name of a class file 401 to be executed first for execution of the Java™ archive file 302. In the case where the manifest file 402 does not contain the two attributes of the Java™ archive file 302 described above, the Java™ application, which is an instance of the class files 401 contained in the Java™ archive file 302, is not executed.

(iii) SIG-BD.SF: Signature File 403

The signature file 403 contains the hash value of the manifest file 402.

### (iv) SIG-BD.RSA: Digital Signature File 404

The digital signature file 404 contains one or more “digital certificate chain” and “signature data” of the signature file 403.

The “signature data” contained in the signature file 403 is created by applying a signature process to the signature file 403. The signature process is carried out using a secret key that corresponds to a public key in the digital certificate chain contained in the digital signature file 404.

The “digital certificate chain” refers to a sequence of digital certificates. The first certificate (root certificate) in the sequence signs the second certificate. Similarly, the n-th certificate in the sequence signs the n+1-th certificate. The last certificate in the digital certificate sequence is referred to as a “leaf certificate”. With the digital certificate chain, each certificate verifies the next certificate in the root-to-leaf order. Thus, all the certificates in the chain are verified.

The “root certificate” is identical to the disc root certificate 301 contained in the BD.ROOT.CERTIFICATE file.

The “leaf certificate” includes an organization ID. The signature file 403 is stored in the format called PKCS#7, which is a file format used to store one or more signatures and digital certificates. The PKCS#7 format is described in RFC2315 published by IETF (Internet Engineering Task Force). RFC2315 is available for reference at: http://www.ietf.org/rfc/rfc2315.txt.

Normally, the digital signature file 404 contains one digital certificate chain. Yet, in the case where authorization is provided as in a later-described example, two digital certificate chains are generated. The two digital certificate chains are referred to as first and second digital certificate chains. Regarding the first digital certificate chain, the root certificate is the disc root certificate of the organization that receives the authorization (“recipient organization”), whereas the leaf certificate includes the organization ID of the recipient organization. Regarding the second digital certificate chain, the root certificate is the disc root certificate of the organization that gives the authorization (“provider organization”), whereas the leaf certificate includes the organization ID of the provider organization. In the case where no authorization is provided, the digital signature file 404 contains a single digital certificate chain (first digital certificate chain).

The detailed description of the manifest file 402, signature file 403, and digital signature file 404 is found in the specifications of Java™ archive files. The manifest file 402, signature file 403, and digital signature file 404 are used for the signature process and signature verification. Ultimately, the Java™ application, which is an instance of the class files contained in the Java™ archive file 302, and a permission request file 405 can be signed using digital certificates. Hereinafter, the manifest file 402, signature file 403, and digital signature file 404 are collectively referred to as “signatures using digital certificates”.

(v) bd.Xlet1.perm: Permission Request File 405

The permission request file 405 contains information indicating what permission is given to the Java™ application to be executed. More specifically, the permission request file 405 stores the following information:

(a) Credential (Digital Credential Certificate); and

(b) Permission for Inter-Application Communication.

Hereinafter, a description of (a) Credential is given. The “Credential” is information used for sharing files in a specific directory belonging to a specific organization. The file sharing is enabled by giving authorization to access the files used by an application belonging to a specific organization to an application belonging to another organization. For this purpose, Credential includes a provider ID identifying the organization that gives authorization to use their applications' files and a receiver ID identifying the organization that receives the authorization.

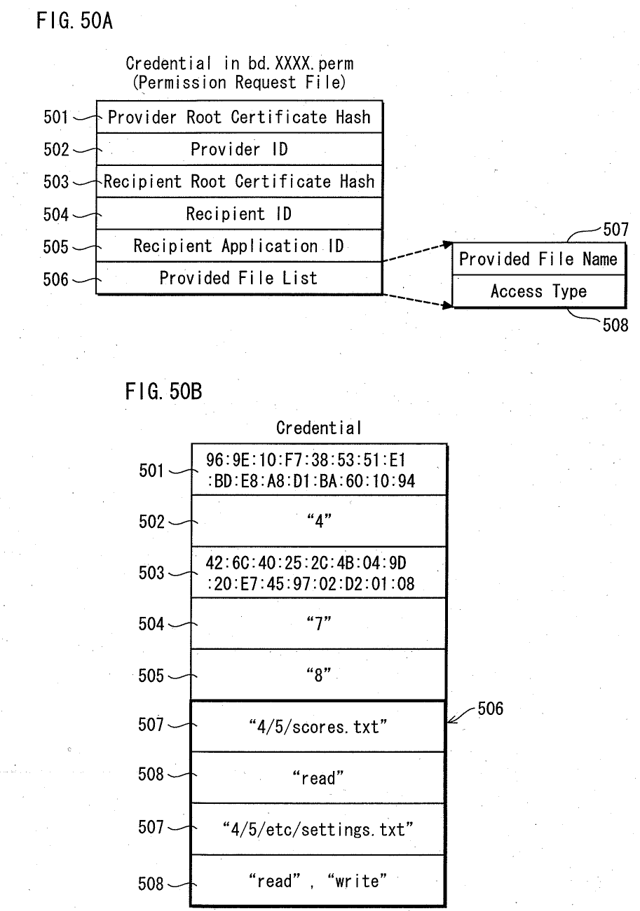

FIG. 50A shows an example data structure of Credential. The Credential is composed of a hash value 501 of a root certificate issued by a root certificate authority to the provider organization, a provider ID 502 assigned to the provider organization, a hash value 503 of a recipient root certificate issued by the root certificate authority to the recipient organization, a recipient ID 504 assigned to the recipient organization, a recipient application ID 505, and a provided file list 506. The provided file list 506 includes information indicating at least one provided file name 507 and a permitted access type 508 (read access permission or write access permission). The Credential needs to be signed to be valid. Similarly to the digital signature file 404, the Credential may be signed in the PKCS#7 format.

FIG. 50B shows a specific example of the Credential. It is shown that the Credential permits read access to the file “4/5/scores.txt” and write access to the file “4/5/etc/settings.txt”.

Next, (b) Inter-Application Communication will be described. Normally, a Java™ application included in one Java™ archive file 302 is not permitted to communicate with any other Java™ applications included in other Java™ archive files 302 (i.e., inter-application communication is not permitted). Yet, inter-application communication is possible if the permission request file 405 indicates that such permission is given.

This concludes the description of the permission request file 405. Now, root certificates are described in greater detail.

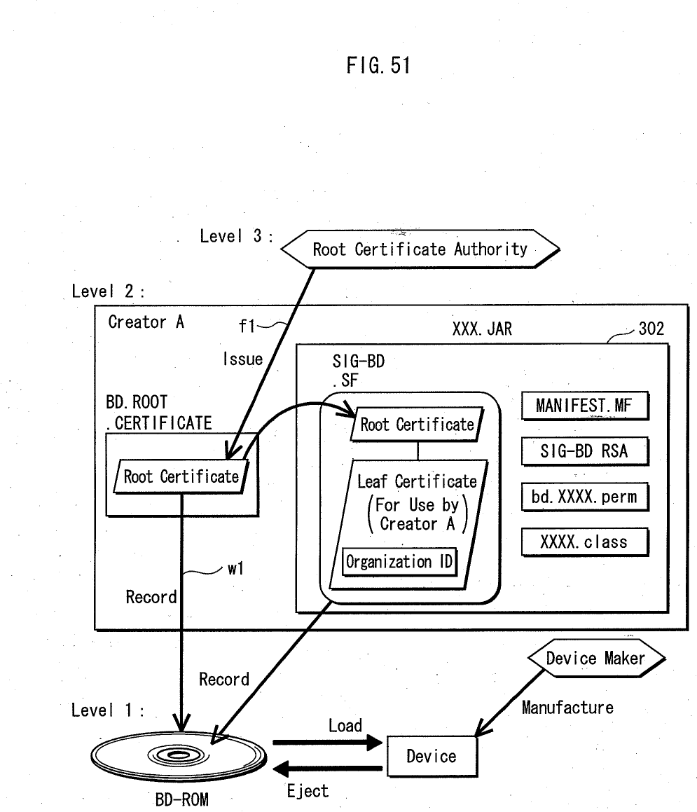

FIG. 51 is a schematic view showing how a root certificate is assigned to the BD-ROM. Level 1 in the figure shows a device (playback device) and the BD-ROM loaded to the device. Level 2 shows the BD-ROM creator and the device maker. Level 3 shows the root certificate authority that manages root certificates.

In the figure, the BD-ROM creator receives a root certificate issued by the root certificate authority (arrow f1), assigns the received root certificate as a disc root certificate 301 to the BD-ROM, and stores the root certificate into the BD.ROOT.CERTIFICATE file on the BD-ROM (arrow w1). At the time of creating the Java™ archive file 302, the BD-ROM creator stores the root certificate and a leaf certificate that indicates the organization ID into the SIG-BD.SF directory. As a result, the certificates are contained in the Java™ archive file 302.

The same holds in the case where the Java™ archive file 302 is downloaded from a www server into the storage device of the playback device, rather than being read from a BD-ROM. The download is a way to update the BD-ROM contents. At the time of downloading, a root certificate that is identical to the root certificate contained as the disc root certificate 301 in the BD.ROOT.CERTIFICATE file is stored into the SIG-BD.SF file in the Java™ archive file. With this arrangement, the playback device is allowed to verify, using the disc root certificate 301 assigned to the BD-ROM, the authenticity of the Java™ archive file 302 downloaded for the purpose of updating the BD-ROM contents.

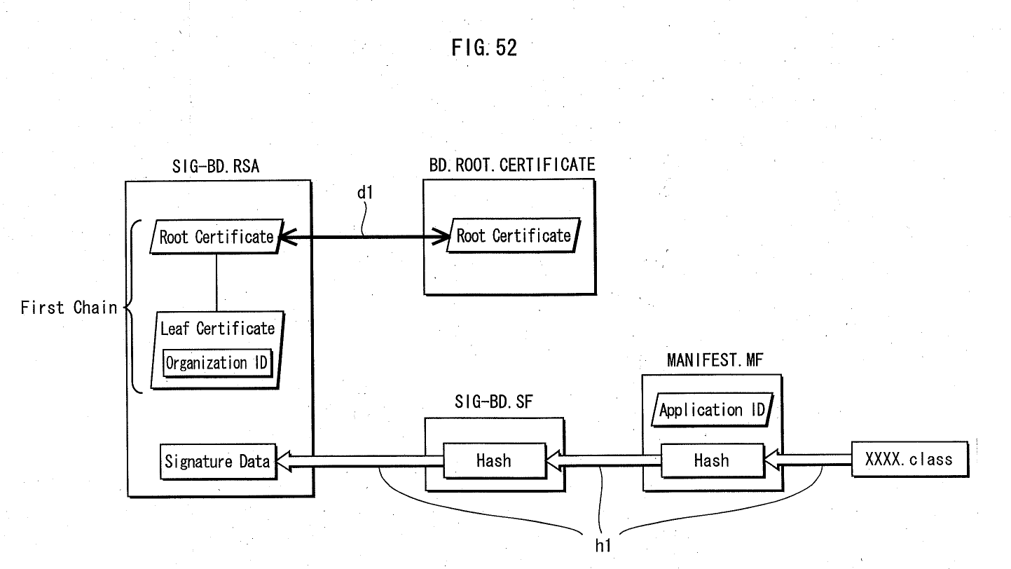

FIG. 52 shows the relationship among the SIG-BD.RSA, SIG-BD.SF, BD.ROOT.CERTIFICATE, and MANIFEST.MF files, in the case where no authorization is provided. An arrow d1 in the figure shows that the information elements contained in the respective files are identical. In the case where no authorization is provided, the root certificate (disc root certificate 301) of the BD.ROOT.CERTIFICATE file is identical to the root certificate contained in the first digital certificate chain stored in the SIG-BD.RSA file.

The MANIFEST.MF file signs the class file called XXXX.class, the SIG-BD.SF file contains the hash value calculated from the MANIFEST.MF file, and the SIG-BD.RSA file contains the hash value calculated from the SIG-BD.SF file (arrows h1). Thus, by verifying those signatures and checking if the respective pairs of information elements shown in the figure are identical, the playback device is enabled to judge whether the Java™ archive file 302 is valid or has been tampered with. Since no authenticity is provided in this specific example, the bd.XXXX.perm file is not illustrated in the figure.

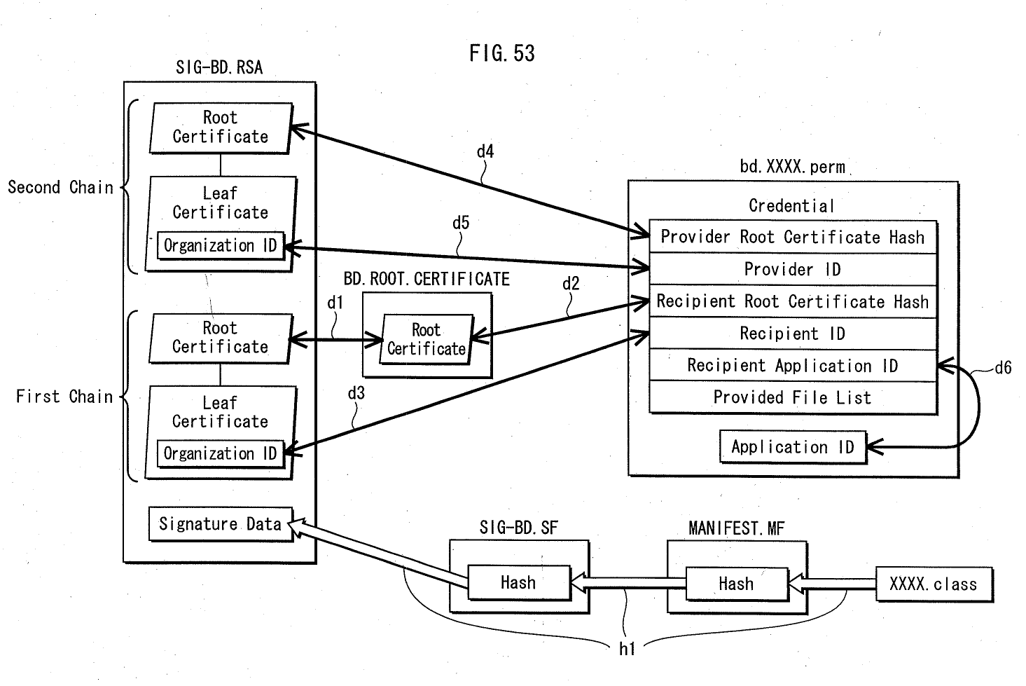

FIG. 53 shows the relationship among the SIG-BD.RSA, SIG-BD. SF, BD.ROOT.CERTIFICATE, MANIFEST.MF, and bd.XXXX.perm files, in the case where authorization is provided. Arrows d1-d6 in the figure connect mutually identical information elements contained in those files. Similarly to the above example, the root certificate (disc root certificate) contained in the BD.ROOT.CERTIFICATE file is identical to the root certificate of the first digital certificate chain contained in the SIG-BD.RSA file (arrow d1). Different from the above example, however, in the case where authorization is provided, the disc root certificate 301 contained in the BD.ROOT.CERTIFICATE file is of the recipient. Thus, the root certificate contained in the BD.ROOT.CERTIFICATE is identical to the recipient root certificate in Credential contained in the bd.XXXX.perm file (arrow d2). In addition, the recipient ID in the Credential is identical to the leaf organization ID of in the first digital certificate chain (arrow d3).

The root certificate of the provider organization included in the Credential that is contained in the bd.XXXX.perm file is identical to the root certificate in the second digital certificate chain contained in the SIG-BD.RSA file (arrow d4). Further, the provider ID included in the Credential is identical to the organization ID indicated in the leaf certificate of the second digital certificate chain (arrow d5). The recipient application ID included in the Credential is identical to an application ID that is contained in the bd.XXXX.perm file but not in the Credential (arrow d6).

The MANIFEST.MF file contains a hash value calculated from the XXXX.class file. The SIG-BD.SF file contains the hash value calculated from the MANIFEST.M file. The SIG-BD.RSA file contains a hash value calculated from the SIG-BD.SF file (arrow h1). Thus, by verifying the signatures and checking whether the respective pairs of information elements shown in the figure are identical, the playback device is enabled to judge whether the Java™ archive file 302 is valid or has been tampered with. It should be noted that the present embodiment judges whether the two root certificates are identical by comparing hash values calculated from the respective root certificates to see if the two hash values match. In addition, it is a common practice that once calculated, the hash values are stored in memory or the like and supplied for further use without another calculation. The calculation of a hash value and fetching of a hash value from memory are both referred to as “acquisition” of a hash value.

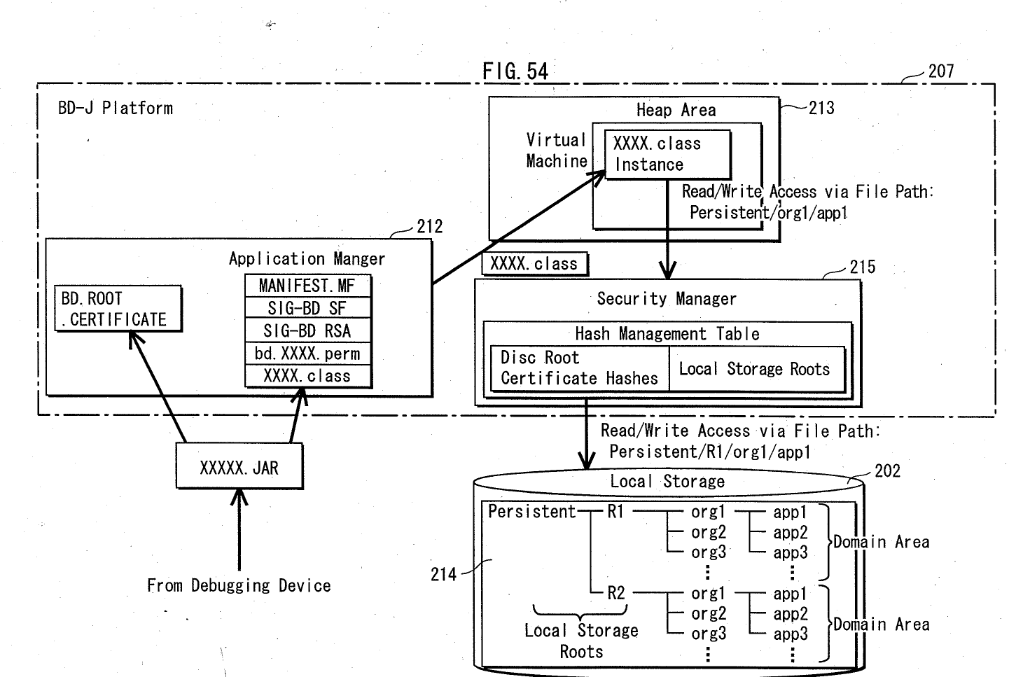

This concludes the description of the disc certificate and the JAR archive file. The following now describes the internal structure of the local storage 202 and the BD-J platform unit 207 according to the present embodiment. FIG. 54 is a view showing the internal structure of the platform unit 207 and the local storage 202. As shown in the figure, the platform unit 207 is composed of an application manager 212, a virtual machine 213, a security manager 215. The local storage 202 has a persistent area 214.

### (Application Manager 212)

The application manager 212 is a system application that runs in the heap area of the virtual machine 213 and executes application signaling. Generally, the “application signaling” refers to control on MHP (Multimedia Home Platform), which is defined by the GEM1.0.2 specifications, to activate and execute an application during a lifecycle of a “service”. The application manager 212 according to the present embodiment carries out such control that an application is activated and executed during a lifecycle of a “BD-ROM title” rather than a “service”. The term “title” refers to a logical playback unit of video and audio data stored on the BD-ROM. An application management table (ApplicationManagementTable( )) is uniquely assigned to each title.

Before activating an application, the application manager 212 verifies the authenticity of the application. The authenticity verification is made through the following steps. In response to loading of the BD-ROM, the application manager 2 checks whether the file called /BDDATA/BD.ROOT.CERTIFICATE is stored on the BD-ROM. If the file is stored, the application manager 212 reads the disc root certificate 301 from the BD-ROM into memory. Then, the application manager 212 reads the Java™ archive file 302 and verifies the authenticity of signatures contained in the Java™ archive file 302. If the signatures are successfully verified, the application manager 212 reads the class files 401 from the Java™ archive file 302 stored on the BD-ROM into the virtual machine 213. Then, the application manager 212 generates an instance of the class files 401 in the heap area. As a result, the Java™ application is activated.

### (Virtual Machine 213)

The virtual machine 213 is an execution entity of Java™ applications and composed of: a user class loader that reads a class file from the BD-ROM; a heap memory that stores a Java™ application, which is an instance corresponding to the class file; a thread; and a Java™ stack. The thread is a logical execution entity of a method of a Java™ application. The thread-performs operations using local variables and arguments that are stored on the operand stack and stores the results of operations to local variables or the operand stack. The thread executes a method by converting the method written in bytecode into native code of the CPU and issuing the native code to the CPU. The conversion into native code is not particularly relevant to the gist of the present invention. Thus, no further description thereof is given. If the Java™ archive file 302 contains the permission request file 405, the manifest file 402 must contain a correct hash value. Otherwise, the Java™ application cannot be executed. In order to make the judgment on the correctness of the hash value, the virtual machine 213 stores, in the memory, information indicating which of the Java™ archive files 302 contains the Java™ application targeted for execution. With reference to the permission request file 405, the virtual machine 213 can check whether the application held by the application manager 212 is permitted to perform inter-application communication and accordingly provides the inter-application communication functionality to the Java™ application.

### (Persistent Area 214)

A persistent area 214 is an area of the local storage accessible with a method provided in the Java™ IO package. The persistent are 214 has a plurality of domain areas. The domain areas refer to directories (R1 and R2 in the figure) assigned to each disc root certificate 301. The domain areas are directories provided correspondingly to different disc root certificates (R1 and R2 in the figure). Below one of the domain area directories corresponding to the root certificate 301, separate directories (org1/org2, and org3 in the figure) are provided for respective organizations. The organization directories (org1/app1, org2/app2, and org3/app3 in the figure) are similar to the organization directories provided according to MHP. In other words, the local storage has separate directories for respective applications supplied from respective organizations just as those defined by MHP (org1/app1, org1/app2, org1/app3 . . . in the figure). Yet, those directories are provided below different directories corresponding to different root certificates (R1 and R2 in the figure). With this directory structure, the compatibility with the MHP storage scheme is ensured. Here, part of a file path specifying as far as a local storage directory corresponding a root certificate (Root/R1 and Root/R2 in the figure) is referred to as a “local storage root”.

### (Security Manager 215)

The security manager 215 holds a hash management table showing pairs each composed of a hash value calculated from a root certificate and a corresponding local storage root. On receiving a file read/write access request from an application, the security manager 5 calculates a hash value from a root certificate corresponding to the application issued the access request, and selects the local storage root corresponding to the hash value from the hash management table. The thus selected local storage root is incorporated into the file path. In addition, the security manager 215 replaces, in accordance with the Credential, part of the file path specifying the directory corresponding to the organization ID. With this arrangement, the file path used by the application ensures compatibility with a file path defined in the format according to MHP.

This concludes the description of the structure of the platform unit. As described above, a disc root certificate is used for authentication of a Java™ application, authority check of the Java™ application, and for accessing a domain area of the local storage. It should be noted, however, that disc root certificates are assigned in one-to-one relationship to BD-ROMs. Thus, at the stage where a BD-ROM manufacturing is yet-to-be-completed, authentication of the Java™ application, authority check of the Java™ application, tests of the domain areas are not possible yet.

In order to address the above inconvenience, the network drive according to the present embodiment stores, in addition to the JAR archive file, dummy data of a disc root certificate as described above. With this arrangement, when loading the JAR archive file, the playback device creates a domain area corresponding to the disc root certificate and stores a differential content corresponding to the BD-ROM content to the thus created domain area.

Eventually, the Java™ virtual machine accesses the domain area with reference to the disc root certificate.

As described above, as long as the JAR archive file contains dummy data of the disc root certificate, the following is ensured. That is, in response to a mount command, the authentication process and authority check is carried out based on the dummy data. At this time, a new domain area is created on the local storage for the dummy data and data for use by the Java™ application is stored into this newly created domain area.

As described above, according to the present embodiment, the JAR archive file contains dummy data in advance. This arrangement makes it possible to test whether or not authentication of the Java™ application is dully carried out as well as whether or not the authorization provided to the application is dully checked. As a consequence, the efficiency of tests improve.

### Embodiment 9

Embodiment 9 of the present invention relates to an improvement made to provide an integration of the PC 100 described in Embodiment 1 and the playback device described in Embodiment 2. To be more specific, the PC 100 according to the present embodiment includes a BD-ROM drive, hardware and software configuration for decoding an AV content, and a platform unit. The log server terminal receives and accumulates execution logs output from the platform unit residing on the PC 100.

The above arrangement is suitable for authoring of a BD-ROM storing two AV contents. In the case where authoring of one of the AV contents have been completed but the other is not, the PC according to the present embodiment is capable of effectively perform an operation test, analysis, and correction of the application.

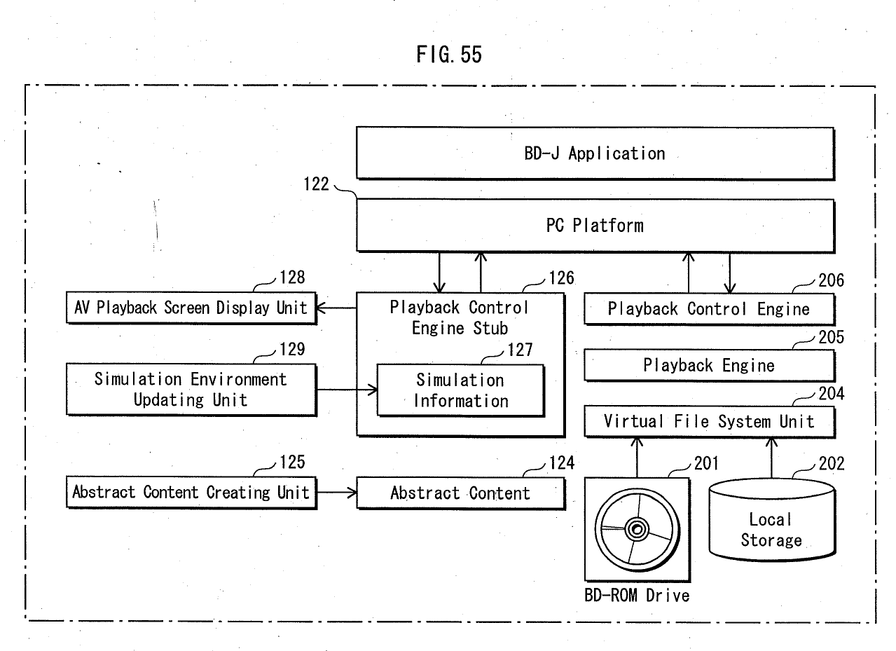

FIG. 55 is a block diagram showing the structure of the PC 100 having the BD-ROM drive, the hardware and software configurations for decoding AV contents, and the platform unit. The debugging device shown in the figure has the same components as the hardware and software configurations of the PC 100 shown in FIGS. 17 and 18 (namely, the PC platform unit 122, the abstract content 124, the abstract content creating unit 125, the playback control engine stub 126, the AV playback screen display unit 128, and the simulation environment updating unit 129). The difference with the PC 100 shown in FIGS. 17 and 18 are found in that the PC platform unit 122 includes the components of the BD-ROM playback device 200 (namely, the BD-ROM drive 201, the local storage 202, the virtual file system unit 204, the playback engine 205, and the playback control engine 206).

The PC platform unit 122 judges whether or not the authoring of an AV content requested to be played by the BD-J application has been completed. Upon receipt of a playback request from the BD-J application and authoring of the AV content specified by the playback request is incomplete, the PC platform unit 122 executes a simulation as described in Embodiment 4. However, if the received playback request is for the AV content having gone through the authoring process, the PC platform unit 122 executes a mouthing process similar to that described in Embodiment 1. Yet, the mount destination in this case is not the network drive but the HDD equipped in the PC 100.

As described above, the PC according to the present embodiment performs an operation test, analysis, and correction of an actual AV content stored on the BD-ROM, if the authoring of the AV content has been completed. If the authoring has not yet been completed, the PC performs an operation test, analysis, and correction of an abstract content based on an AV playback emulation, rather than those of the actual AV content.

The above arrangement allows the PC to conduct an operation test, analysis, and correction in an optimal way depending on the progress of the AV content authoring. Note that although the number of AV contents stored on the BD-ROM is two in this embodiment, it is possible that the BD-ROM stores three or more AV contents.

### (Supplemental Note)

Up to this point, the present invention has been described based on the above embodiments. It should be appreciated, however, that those embodiments are mere examples of systems expected to exhibit the best effect at the present time. Many other variations may be made without departing from the gist of the present invention. Representative variations include the following.

### (Variations of Recording Medium)

According to the above embodiments, a BD-ROM is described as the recording medium for storing an AV content and an application and the authoring process is conducted on the BD-ROM. It should be noted that the physical properties of the BD-ROM do not contribute much to the action and effect of the present invention. Any recording medium other than a BD-ROM is applicable to the present invention as long as the recording medium has a capacity to store an AV content. Examples of such a recording medium include optical discs, such as a CD-ROM other than the BD-ROM, CD-R, CD-RW, DVD-ROM, DVD-R, DVD-RW, DVD-RAM, DVD+R and DVD+RW. Examples of such a recording medium also include: a magnet-optical disc, such as PD and MO; a semiconductor memory card such as an SD memory card, CompactFlash™ card, SmartMedia, memory stick, multimedia card, and PCM-CIA card; a magnet recording disk, such as HDD, flexible disk, SuperBD-ROM, Zip, and Click!; and a removable hard disk drive such as ORB, Jaz, SparQ, SyJetm and EZFley. Naturally, the local storage may be any of the above-mentioned recording mediums as long as it is equipped in the playback device and protected under copyright protection.

### (Storage Location of BD-J Application)

According to the above embodiments, the BD-J application is stored on the HDD. Yet, the BD-J application may be stored at any other location, such as on a memory connectable via USB.

### (End Judgment in Step S104)

In the flowchart shown in FIG. 25, the end judgment in Step S104 is performed only when both the judgments in Steps S101 and S102 result in “No”. Alternatively, however, it is applicable to perform the end judgment of Step S104 irrespective of the judgment results of Steps S101 and S102. Further, although the simulation information is updated in Step S114 after a playback control API call is received in Step S101 according to the above embodiments, these steps may be performed in a reversed order. Still further, although the processing returns to Step S101 after Step S113 according to the above embodiments, the judgment in Step S102 may be made after Step S110.

### (Use of GUI(s))

As shown FIG. 22, display of the playback information and the update of the playback state are both presented on the same GUI. Alternatively, however, they may be presented on separate GUIs.

### (Use of Screen(s))

As shown in FIG. 22, the abstract content and the simulation information are displayed on two or more screens. Alternatively, however, both the abstract content and the simulation information may be displayed on a single screen.

### (Use of Rectangle)

As shown in FIG. 22, an AV playback screen is represented by a rectangular-shaped area. However, the AV playback screen may be represented solely by text information or the rectangle may be overlaid with the current point information of the corresponding video. In addition, instead of solidly filling the rectangle with one color, an arbitrary chosen background image may be displayed in the rectangle. In addition, any other shape other than the rectangle may be used. Examples of such a shape includes a circular and a polygon.

In addition, the playback state is changed in response to a user input of a numeral or a character string according to the above embodiments. Alternatively, however, predetermined information items may be presented to the user and the playback state is changed in response to a user input of selecting one of the information items.

### (Implementation)

The software components of the PC 100 may be implemented by an arithmetic device, such as a CPU, provided within the PC 100. Alternatively, the software components may be implemented by a signal processing circuit or an LSI executing the above-described processes.

Further, the software components of the PC 100 may be stored in advance on the memory of the PC 100. Alternatively, the software components of the PC 100 may be stored on a readable recording medium and read and supplied for execution.

The abstract content is created by making appropriate setting on a plurality of display screens according to the above embodiments. Alternatively, however, the PC 100 may be configured to allow all the settings to be made on a single screen.

### (Error Display)

The PC 100 may be configured to display an error message if the AV content and the abstract content disagrees with each other and allow the user to select which of the AV content and the abstract content to be corrected. Further, in the case where two or more AV contents exist, the AV contents may be recorded onto the BD-ROM one by one upon completion of each AV content.

### (Number of BD-J Applications)

The above embodiments relate to an example where a single application executes playback control of AV content(s). Alternatively, however, two or more applications may execute the playback control.

### (Change of Current Point)

According to Embodiment 4, the user is allowed to change the current point by changing the timecode. Alternatively, however, the user may change the current playback point by specifying a specific playlist or chapter number. In stead of a change by the user, the playback point may be made to automatically change upon expiration of a predetermined time period counted with the use of a timer.

### (Storage Locations of AV Content and BD-J Application)

According to the above embodiments, the AV content is stored on the BD-ROM, whereas the BD-J application is stored on the HDD. Yet, this is merely one example and the BD-J application may be stored on the BD-ROM, whereas the AV content may be stored on the HDD. Alternatively, the AV content and/or the BD-J application may be stored on the local storage.

In the IDE environment, it is desirable to set a compile switch so that the Log output API or a debugging routine using the Log output API is complied only at the time of debugging.

It is desirable that the output of an execution log by the standard output function is executed as a “serviceman function” in response to a specific operation only.

### (Creation Process of Differential Content)

In the case where one movie title is composed of a BD-ROM content in combination with a differential content, the planning process through the formatting process are carried out to create the differential content. Once the AV Clip, Clip information, and PlayList information constituting one piece of volume data are acquired as a result of the above processes, those data to be supplied via the BD-ROM is excluded and the residual data is stored into one file as a differential content using, for example, an archival program. Once the differential content is acquired as a result of the above processing, the differential content is supplied to the WWW server and sent to the playback device in response to a request from the playback device.

(Fabrication into System LSI)

The playback device according to Embodiment 1 may be fabricated as one system LSI.

Generally, a system LSI is composed of a bare chip packaged on a high-density substrate. Alternatively, a system LSI may be composed of a plurality of bare chips that is packaged on a high-density substrate and has an external structure just as a single LSI (this type system LSI may be referred to also as a multi-chip module).

In terms of the types of packaging, there are different types of system LSIs called QFP (quad flat package) and PGA (Pin Grid Array). QFP is a type of system LSI with pins extending from all four sides of the package. PGA is a type of system LSI package with an array of pins that are arranged on entire surface of the base of the package.

The pins act as an I/O interface with other circuits. Since the pins of the system LSI act as interface, by connecting other circuits to the pins, the system LSI plays a roll as the core of the playback device.

Such a system LSI is suitably embedded not only in the playback device but also in various devices handling video playback, including a TV set, a game device, a personal computer, a mobile phone with the one-segment broadcasting function. This helps to greatly expand applications of the present invention.

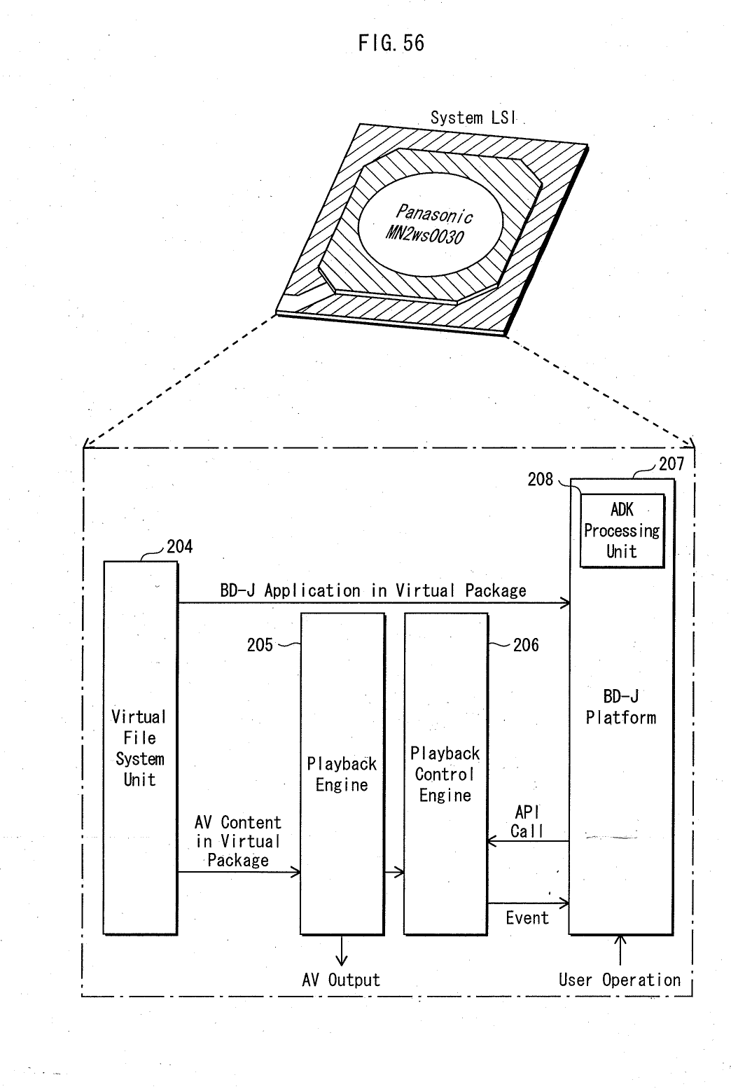

FIG. 56 is a schematic view of a system LSI into which major components of the playback device is packaged.

The details of the production procedure are as follows. First process is to make a circuit diagram of a portion to be incorporated into a system LSI, based on the figures showing the internal structures according to the above embodiments.

The next process is to design, in order to implement each component, a bus connecting circuit elements, IC, and LSI, the peripheral circuitry, and interfaces with external devices. In addition, connecting lines, power lines, ground lines, clock signal lines are designed. In this process, operation timing of each component is adjusted in consideration of the LSI spec. In addition, some adjustment is made to ensure the bandwidth of each component. In this way, the circuit diagram is completed.

Regarding a generally-known portion of the internal structure shown in each embodiment, it is preferable to design a circuit pattern by combining Intellectual Properties defining existing circuit patterns. Regarding a characteristic portion of the internal structure shown in each embodiment, it is desirable to carry out a top-down design with the use of description of a highly abstract operation in HDL or description at a transfer level.

Once the circuit diagram is ready, the packaging design is made. The packaging design is a process of designing a layout on a substrate, involving the process of determining the physical arrangement of the elements (circuit elements, IC, and LSI) shown in the circuit diagram and also determining the wiring on the substrate.

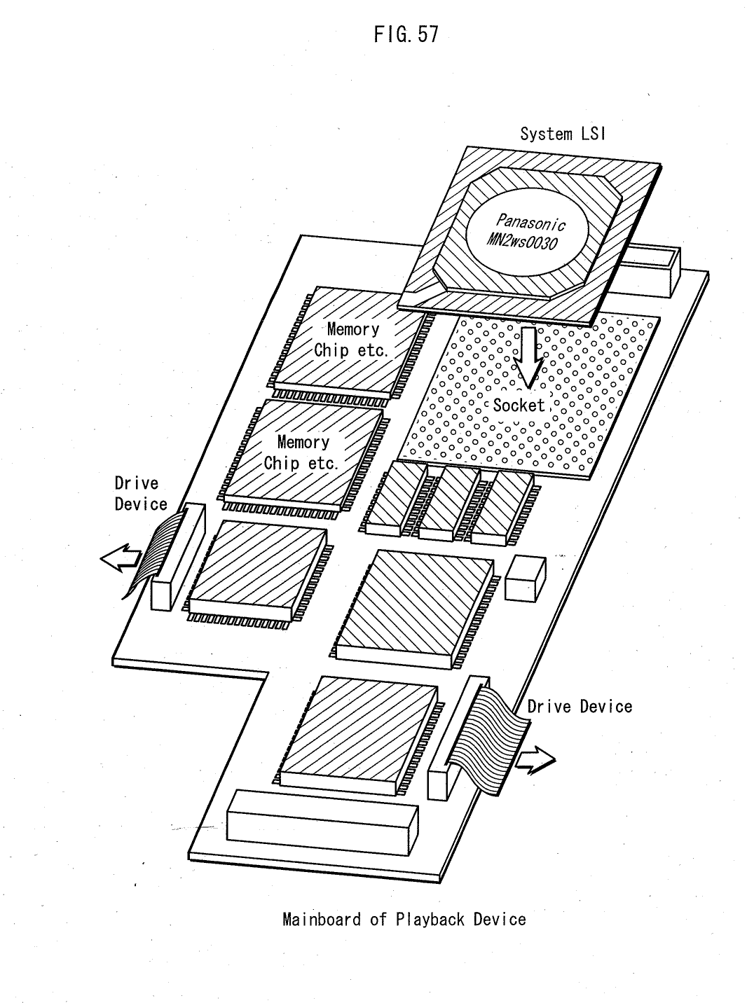

After the packaging design is completed and the layout on the substrate is determined, the related data is converted into CAM data and supplied to appropriate devices such as an NC machine tool. The NC machine tool incorporates the elements using System on Chip (SoC) or System in Package (SiP) implementations. According to the SoC implementation, multiple circuits are baked on a single chip. According to the Sip implementation, multiple chips are joined into a single package with resin, for example. Through the above processes, a system LSI according to the present invention can be produced, based on the figures showing the internal structure of the playback device cited in the above embodiments. FIG. 57 is a view showing the system LSI manufactured in the above manner and disposed on the playback device.

Note that integrated circuits produced in the above manner may be referred to as IC, LSI, super LSI, or ultra LSI, depending on the packaging density.

In the case where FPGA is employed, the resulting system LSI includes a number of logic elements arranged in a grid pattern. By connecting the respective logic elements in the combinations of the input and output ends shown in the LUT (Look Up Table), the hardware configuration of each embodiment is realized. The LUT is stored on the SRAM and the contents of the SPAM are erased when power is turned off. Accordingly, when FPGA is employed, it is necessary to define config information to cause the LUT showing the hardware configuration of each embodiment to be written into SRAM. In addition, it is preferable to realize a video decoder circuit having a built-in decoder with a DSP product-sum operation function.

### (Architecture)

The system LSI according to the present invention is to realize the functions of the playback device. In view of this, it is desirable that the system LSI is designed in compliance with the Uniphier architecture.

The system LSI in compliance with the Uniphier architecture is composed of the following circuit blocks.

### —Data Parallel Processor DPP

A DPP is a SIMD processor in which a plurality of processing elements perform identical operations in parallel. A plurality of arithmetic units each included in a processing element execute one instruction in parallel, so that a plurality of pixels are decoded in parallel.

Instruction Parallel Processor IPP

An IPP is composed of: a “Local Memory Controller” that includes an instruction RAM, an instruction cache, a data RAM, and a data cache; a “Processing Unit” that includes an instruction fetcher, a decoder, an execution unit, and a register file; and a “Virtual Multi Processor Unit” that causes the processing unit to execute a plurality of applications in parallel.

### —CPU Block

A CPU block is composed of: peripheral circuits such as an ARM core, an external bus interface (Bus Control Unit: BCU), a DMA controller, a timer, and a vectored interrupt controller; and peripheral interfaces such as UART, GPIO (General Purpose Input Output), and a synchronous serial interface. The controller described above is packaged on the system LSI as a CPU block.

### —Stream I/O Block

A stream I/O block communicates, via a USB interface and an ATA Packet interface, input/output data to/from a drive device, a hard disk drive device, an SD memory card drive device connected with the external bus.

### —AV I/O Block

An AV I/O block is composed of an audio I/O, a video I/O, and an OSD controller and communicates input/output data to/from a TV set and an AV amplifier.

### —Memory Control Block

The memory control block realizes the reading/writing of data to/from the SD-RAM connected via the external bus. The memory control block is composed of: an internal bus connection unit that controls the internal connection between the blocks; an access control unit that transfers data to/from the SD-RAM connected externally to the system LSI; and an access scheduling unit that arbitrates an access to the SD-RAM among the plurality of blocks.

### (Program Creation According to the Present Invention)

A program according to the present invention is a program in a format executable by a computer (i.e. object program). The program is composed of one or more coded instructions for causing a computer to execute the steps of the flowcharts or to implement the functional components according to the embodiments described above. Examples of the program code employed includes various codes, such as a native code of a particular processor and Java ByteCode.

A program according to the present invention may be created in the following manner. First, a software developer writes, in a programming language, a source program for implementing the flowcharts or the functional components described above. When writing the source program for implementing the flowcharts or the functional components, the software developer may use class structures, variables, array variables, and calls for external functions, in accordance with the syntax of that programming language.

The resulting source program is supplied as a file to a compiler. The compiler translates the source program into an object program.

Once the object program is generated, the programmer activates a linker. The linker allocates memory areas for the object program and related library programs, and binds them together to generate a load module. The thus generated load module is to be read by a computer thereby to cause the computer to perform the processing steps shown in the above flowcharts or the processing steps performed by the functional components according to the embodiments described above. Through the above processes, a program embodying the present invention is created.

### INDUSTRIAL APPLICABILITY

The internal structure of the playback device and debugging device according to the present invention is disclosed above in the respective embodiments. Apparently, the playback device and debugging device can be manufactured in volume in accordance with the internal structures and is worth industrial use. The playback device and debugging device are applicable to analyze and correct an application, without an environment for executing playback of an AV content associated with the application.

1-11. (canceled)

12. A playback device having a function of supporting development of an application stored on a first recording medium that is accessible by the playback device via a network, the playback device comprising:
a mount unit operable to combine network file system information of the first recording medium with file system information of a second recording medium equipped in the playback device to obtain a virtual file system;
a platform unit operable to execute the application that is set to an enable status of being recognizable in the virtual file system; and
a playback control engine operable to execute, in accordance with an instruction given by the application, playback of an AV content that is set to an enable status of being recognizable in the virtual file system, wherein
the development supporting function is a function of the platform unit to receive and transmit, via the network, execution information related to the execution of the application that is set to an enable status of being recognizable in the virtual file system.

13. The playback device according to claim 12, wherein
the playback control engine includes a status register,
the execution information includes a value read from or to be written to the status register, and
the status register value indicates one of:
a current playback point of the AV content;
a stream number indicating a currently selected one of elementary streams constituting the AV content;
a playback capability of the playback device; and
a language or age setting of the playback device.

14. The playback device according to claim 12, wherein
the transmission of the execution information by the platform unit is performed when the platform unit receives a predetermined event,
the predetermined event is one of:
an event indicating occurrence of an angle switching during a multi-angle section;
an event indicating occurrence of a change in panning control;
an event indicating occurrence of a status change during picture-in-picture playback;
an event indicating that a current playback point reaches a playlist mark; and
an event indicating that the current playback point reaches a boundary between playitems constituting a playlist, and
the execution information transmitted from the platform unit includes a name and detailed parameter of the event received by the platform unit.

15. The playback device according to claim 12, wherein
the recording medium equipped in the playback device comprises an optical disc and a local storage,
the AV content includes playlist information and an elementary stream both stored on one of the optical disc and the local storage,
the platform unit includes a programming interface operable to cause the playback control engine to execute playback of the elementary stream in accordance with the playlist information,
the transmission of the execution information by the platform unit is performed when the programming interface is called by the platform unit, and
the execution information includes a value that is returned from the playback control engine at a time of the calling.

16. The playback device according to claim 12, wherein
the application is a title-boundary application bound to a title, and
the transmission of the execution information by the platform unit is performed when a user selects the title or when playback of the title ends.

17. The playback device according to claim 12, wherein
the application is an application signed with use of a disc root certificate that is unique to an optical disc,
the mount unit is operable to acquire a dummy disc root certificate at a time of the mounting, and
the platform unit is operable to perform an authentication process using the dummy disc root certificate acquired by the mount unit, and the execution of the application is performed only if the application is authenticated through the authentication process.

18. The playback device according to claim 17, further comprising:
a local storage, wherein
the local storage has a plurality of domain areas, and
the application accesses one of the domain areas corresponding to the disc root certificate associated with the application.

19. A debugging device comprising:
a debugging unit operable to analyze and/or correct an application in accordance with a user operation; and
a transmission/reception unit operable to transmit and receive data to and from a playback device via a network, wherein
for the analysis and/or correction of the application, the data transmitted to the playback device is the application stored on a first recording medium and network file system information of the first recording medium, and the data transmitted to and received from the playback device is execution information of the application being executed by a platform unit of the playback device.

20. The debugging device according to claim 19, wherein
the debugging of the application includes:
debugging in a cross development stage; and
debugging in an integration test stage,
the debugging device is operable to perform the debugging of the application in the integration test stage, by causing a stub to execute the application program, and
the stub is a substitute for a playback control engine, has a status register indicating a status setting of the playback control engine, and issues a dummy event of an event issued by the playback control engine.

21. A system LSI embedded in a playback device and having a function of supporting development of an application stored on a first recoding medium that is accessible by the playback device via a network, the system LSI comprising:
a mount unit operable to combine network file system information of the first recording medium with file system information of a second recording medium equipped in the playback device to obtain a virtual file system;
a platform unit operable to execute the application that is set to an enable status of being recognizable in the virtual file system; and
a playback control engine operable to execute, in accordance with an instruction given by the application, playback of an AV content that is set to an enable status of being recognizable in the virtual file system, wherein
the development supporting function is a function of the platform unit to receive and transmit, via the network, execution information related to the execution of the application that is set to an enable status of being recognizable in the virtual file system.

22. A program for causing a computer to perform a function of supporting development of an application stored on a first recoding medium that is accessible via a network, the program comprising code operable to cause the computer to perform the steps of:
combining network file system information of the first recording medium with file system information of a second recording medium equipped in the computer to obtain a virtual file system;
executing the application that is set to an enable status of being recognizable in the virtual file system; and
executing playback of an AV content that is set to an enable status of being recognizable in the virtual file system, wherein
the development supporting function is a function of the computer to receive and transmit, via the network, execution information related to the execution of the application that is set to an enable status of being recognizable in the virtual file system.
